(19) United States
(12) Patent Application Publication
(10) Pub. No.: US 2026/0162373 A1
(43) Pub. Date: Jun. 11, 2026

(54) SESSION PROCESSING METHOD, RELATED APPARATUS, AND MEDIUM

(71) Applicant: TENCENT TECHNOLOGY (SHENZHEN) COMPANY LIMITED, Shenzhen (CN)

(72) Inventors: Yaohua YUE, Shenzhen (CN); Chenguang YANG, Shenzhen (CN); Ye LIU, Shenzhen (CN); Ziyun LIU, Shenzhen (CN); Song HE, Shenzhen (CN); Yukun ZHANG, Shenzhen (CN); Wenlong RAN, Shenzhen (CN)

(21) Appl. No.: 19/255,197

(22) Filed: Jun. 30, 2025

Related U.S. Application Data
(63) Continuation of application No. PCT/CN2024/086552, filed on Apr. 8, 2024.

(30) Foreign Application Priority Data
Jun. 15, 2023 (CN) 202310713048.6

(51) Int. Cl. G06T 19/00; H04L 51/046

(52) U.S. Cl. CPC G06T 19/00; H04L 51/046

(57) ABSTRACT

A session processing method, a related apparatus, and a medium are provided. The session processing method includes: displaying an entry control of a target virtual scene; displaying the target virtual scene in response to the entry control being triggered by a first object, the target virtual scene comprising a first virtual object representing the first object and a second virtual object representing a second object, and the second object being not associated with the first object; displaying a first session start control for the second virtual object; displaying a first session region in response to the first session start control being triggered, the first session region being configured for supporting a session hold by the first virtual object and the second virtual object; and establishing an association relationship between the first object and the second object.

### RELATED APPLICATIONS

This application is a continuation of PCT Application No. PCT/CN2024/086552, filed on Apr. 8, 2024, which claims priority to Chinese Patent Application No. 2023107130486, entitled “SESSION PROCESSING METHOD, RELATED APPARATUS, AND MEDIUM” filed with the China National Intellectual Property Administration on Jun. 15, 2023, which are both incorporated by reference in their entirety.

### FIELD OF THE TECHNOLOGY

This application relates to the field of data processing, and in particular, to session processing technologies.

### BACKGROUND OF THE DISCLOSURE

A conventional messaging application (for example, instant messaging software) can only be configured for conducting communication between objects that are friends. An object interworking rate of the messaging application is poor. The object interworking rate is a proportion of objects pairs that have communicated with each other in all objects pairs of all objects of the messaging application, and the object interworking rate is an important indicator for evaluating coverage performance of the messaging application. In addition, session efficiency between the objects of the messaging application is low. When a session needs to be performed with an unfamiliar object, recommendation and forwarding need to be performed between objects for a plurality of times.

### SUMMARY

Embodiments of this application provide a session processing method, a related apparatus, and a medium, so that an object interworking rate of a messaging application and session efficiency between objects of the messaging application can be improved.

One aspect of this application provides a session processing method, the method includes displaying an entry control of a target virtual scene; displaying the target virtual scene in response to the entry control being triggered by a first object, the target virtual scene comprising a first virtual object representing the first object and a second virtual object representing a second object, and the second object being not associated with the first object; displaying a first session start control for the second virtual object; displaying a first session region in response to the first session start control being triggered, the first session region being configured for supporting a session hold by the first virtual object and the second virtual object; and establishing an association relationship between the first object and the second object.

According to an aspect of this application, an electronic device is provided, including a memory and a processor, the memory having a computer program stored therein, and the processor, when executing the computer program, implementing the foregoing session processing method.

According to an aspect of this application, a non-transitory computer-readable storage medium is provided, the storage medium having a computer program stored therein, and the computer program, when being executed by a processor, implementing the foregoing session processing method.

Different from a messaging application that supports only establishing a session between objects having a friend relationship, an embodiment of this application provides a virtual scene. In one embodiment, meeting of objects having no association relationship as virtual objects in the virtual scene is supported. In addition, each virtual object can start a session with any other virtual object met in the virtual scene. In addition, after the session ends, establishing an association relationship between the virtual objects that have performed the session is supported. Each virtual object can perform a session with another virtual object in the virtual scene, so that the virtual objects change from having no association relationship to establishing the association relationship. Therefore, an object interworking rate of the messaging application is greatly improved. Meanwhile, the virtual objects in the virtual scene can densely have conversations in the virtual scene, so that session efficiency between objects of the messaging application is improved.

### BRIEF DESCRIPTION OF THE DRAWINGS

FIG. 1 is a diagram of a system architecture of a session processing method according to an embodiment of this application.

FIG. 2A to FIG. 2E are schematic diagrams of an interface applied to a messaging application and on which an association relationship is established with an unfamiliar object.

FIG. 3 is a flowchart of a session processing method according to an embodiment of this application.

FIG. 4 is a flowchart of displaying an entry control of a target virtual scene in operation 310 in FIG. 3.

FIG. 5 is a schematic diagram of an interface on which an entry reservation control of the target virtual scene is displayed in a first state in operation 410 in FIG. 4.

FIG. 6 is a schematic diagram of an interface on which the entry reservation control of the target virtual scene is displayed in the first state and the first remaining duration is displayed.

FIG. 7 is a flowchart of operation 410 in FIG. 4.

FIG. 8 is a flowchart of adding the display of a waiting virtual scene before operation 410 in FIG. 4.

FIG. 9 is a schematic diagram of an interface of the waiting virtual scene in FIG. 8.

FIG. 10 is a flowchart of adding a process of displaying detailed information and statuses of contacts after operation 840 in FIG. 8.

FIG. 11 is a schematic diagram of an interface on which detailed information and statuses of contacts are displayed.

FIG. 12 is a flowchart of adding a process of allocating a first virtual object and a sixth virtual object to the same duplicated scene after operation 1020 in FIG. 10.

FIG. 13 is a schematic diagram of an interface on which a same-scene invitation control is displayed in FIG. 12.

FIG. 14 is a flowchart of operation 1230 in FIG. 12.

FIG. 15 is a flowchart of adding the display of a seventh virtual object in an electronic map before operation 410 in FIG. 4.

FIG. 16A and FIG. 16B are schematic diagrams of an interface on which a seventh virtual object is displayed in an electronic map.

FIG. 17 is a schematic diagram of an interface on which an entry reservation control is displayed in an electronic map.

FIG. 18 is a flowchart of operation 410 in FIG. 4.

FIG. 19 is a schematic diagram of an interface on which display of an electronic map is hid in FIG. 18.

FIG. 20 is a flowchart of adding the display of detailed information and a status of a contact corresponding to the seventh virtual object in the electronic map after operation 1560 in FIG. 15.

FIG. 21 is a schematic diagram of an interface on which an entry reservation control is displayed in a second state in operation 420 in FIG. 4.

FIG. 22 is a schematic diagram of an interface on which an entry reservation control is displayed in a second state and prompt information of a station-arriving reminder is displayed.

FIG. 23 is a flowchart of operation 420 in FIG. 4.

FIG. 24 is a schematic diagram of allocating objects to duplicated scenes based on first sorting of first triggering time.

FIG. 25 is a flowchart of operation 2330 in FIG. 23.

FIG. 26 is a flowchart of operation 420 in FIG. 4.

FIG. 27 is a schematic diagram of an interface on which an entry control is displayed after arriving at a station in a target virtual scene.

FIG. 28 is a schematic diagram of an interface on which an entry control and second remaining duration are displayed after arriving at a station in a target virtual scene.

FIG. 29 is a flowchart of operation 310 in FIG. 3.

FIG. 30 is a flowchart of operation 320 in FIG. 3.

FIG. 31 is a schematic diagram of an interface on which a preparation scene is displayed before a target virtual scene is entered.

FIG. 32 is a flowchart of adding a process of displaying a function guidance after operation 3010 in FIG. 30.

FIG. 33 is a schematic diagram of an interface on which a function guidance is displayed in a preparation scene.

FIG. 34 is a flowchart of operation 320 in FIG. 3.

FIG. 35 is a flowchart of operation 3450 in FIG. 34.

FIG. 36 is a flowchart of operation 320 in FIG. 3.

FIG. 37 is a flowchart of operation 320 in FIG. 3.

FIG. 38 is a flowchart of adding a process of a session with an artificial intelligence body object after operation 320 in FIG. 3.

FIG. 39A and FIG. 39B are schematic diagrams of an interface for a session with an artificial intelligence body object.

FIG. 40 is a flowchart of establishing an association relationship between a first virtual object and a fourth virtual object by using a message information body after operation 320 in FIG. 3.

FIG. 41A to FIG. 41C are schematic diagrams of an interface on which a message information body is viewed and replied.

FIG. 42 is a flowchart of operation 4010 in FIG. 40.

FIG. 43 is a flowchart of operation 4230 in FIG. 42.

FIG. 44 is a flowchart of operation 4340 in FIG. 43.

FIG. 45 is a flowchart of operation 4350 in FIG. 43.

FIG. 46A and FIG. 46B are schematic diagrams of an interface on which a second quantity of message information bodies are viewed through sliding.

FIG. 47 is a flowchart of adding a process of viewing more message information bodies after operation 4520 in FIG. 45.

FIG. 48A and FIG. 48B are schematic diagrams of an interface on which more message information bodies are viewed.

FIG. 49 is a flowchart of operation 4730 in FIG. 47.

FIG. 50 is a flowchart of adding a process of inputting a message information body after operation 4730 in FIG. 47.

FIG. 51A and FIG. 51B are schematic diagrams of an interface on which a control for writing a message information body is triggered to input a message information body.

FIG. 52 is a flowchart of adding display of a first viewing control and a second viewing control after operation 4733 in FIG. 50.

FIG. 53A and FIG. 53B are schematic diagrams of an interface on which a first viewing control and a second viewing control are triggered.

FIG. 54 is a flowchart of operation 4735 in FIG. 52.

FIG. 55A and FIG. 55B are schematic diagrams of an interface on which a reply is viewed based on a displayed reply mark.

FIG. 56 is a flowchart of operation 4010 in FIG. 40.

FIG. 57 is a schematic diagram of an interface on which a control for viewing a message information body is displayed in a target virtual scene.

FIG. 58 is a flowchart of adding a process of displaying session invitation information from a second virtual object after operation 320 in FIG. 3.

FIG. 59 is a flowchart of adding a roaming control being triggered after operation 320 in FIG. 3.

FIG. 60A and FIG. 60B are schematic diagrams of a terminal interface of a second object after a roaming control is triggered.

FIG. 61 is a flowchart of adding display of a session invitation prompt in a roaming state after operation 5920 in FIG. 59.

FIG. 62A to FIG. 62C are schematic diagrams of an interface on which a target virtual scene is returned and a third session region is displayed in a roaming state.

FIG. 63 is a flowchart of displaying a picture body after operation 320 in FIG. 3.

FIG. 64A and FIG. 64B are schematic diagrams of an interface on which a picture body is displayed after a second condition is triggered.

FIG. 65 is a flowchart of operation 6310 in FIG. 63.

FIG. 66 is a flowchart of inputting a comment for the picture body after operation 6310 in FIG. 63.

FIG. 67A to FIG. 67C are schematic diagrams of an interface on which a comment is inputted for a picture body.

FIG. 68 is a flowchart of triggering a control for viewing a picture body in a target virtual scene after operation 320 in FIG. 3.

FIG. 69A to FIG. 69D are schematic diagrams of an interface on which a picture body is viewed after a control for viewing a picture body is triggered.

FIG. 70 is a schematic diagram of an interface on which a first virtual object and a second virtual object are seated next to each other and a first session region is displayed.

FIG. 71 is a schematic diagram of a structure in which controls and scenes in a messaging application are rendered.

FIG. 72 is a flowchart of operation 350 in FIG. 3.

FIG. 73A to FIG. 73G are schematic diagrams of an interface on which an association relationship is established with a second virtual object after exiting from a target virtual scene.

FIG. 74 is a diagram of implementation details of a session processing method according to an embodiment of this application.

FIG. 75 is a diagram of modules of a session processing apparatus according to an embodiment of this application.

FIG. 76 is a diagram of a structure of a terminal for the session processing method shown in FIG. 3 according to an embodiment of this application.

FIG. 77 is a diagram of a structure of a server for the session processing method shown in FIG. 3 according to an embodiment of this application.

### DESCRIPTION OF EMBODIMENTS

To make the objectives, technical solutions, and advantages of this application clearer, the following further describes this application in detail with reference to the accompanying drawings and the embodiments. The specific embodiments described herein are only used to describe this application, instead of limiting this application.

Descriptions of System Architecture and Scenes in the Embodiments of this Application

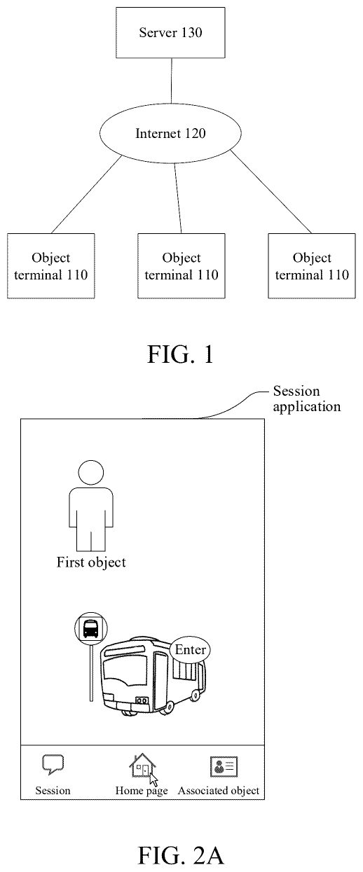

FIG. 1 is a diagram of a system architecture applied to a session processing method according to an embodiment of this application. The system architecture includes an object terminal 110, the Internet 120, a server 130, and the like.

The object terminal 110 is a terminal device that presents a virtual scene to an object and supports the object in establishing an association relationship with another object as a virtual character. The object terminal 110 may include, but is not limited to, a plurality of forms such as a desktop computer, a laptop computer, a personal digital assistant (PDA), a mobile phone, a vehicle-mounted terminal, a home theater terminal, or a dedicated terminal. In addition, the object terminal 110 may be a single device, or may be a set including a plurality of devices. For example, the plurality of devices are connected via a local area network, and share one display device to jointly work, so as to form one terminal. The terminal may further communicate and exchange data with the server 130 via the Internet 120. The Internet 120 may be specifically a wired network or a wireless network.

The server 130 is a computer system that provides a session service for the object terminal 110. In comparison with the object terminal 110, the server 130 performs better in aspects such as stability, security, and performance. The server 130 may be a high-performance computer, a cluster of a plurality of high-performance computers, a part (for example, a virtual machine) of a high-performance computer, a combination of a part (for example, virtual machines) of a plurality of high-performance computers, or the like in a network platform.

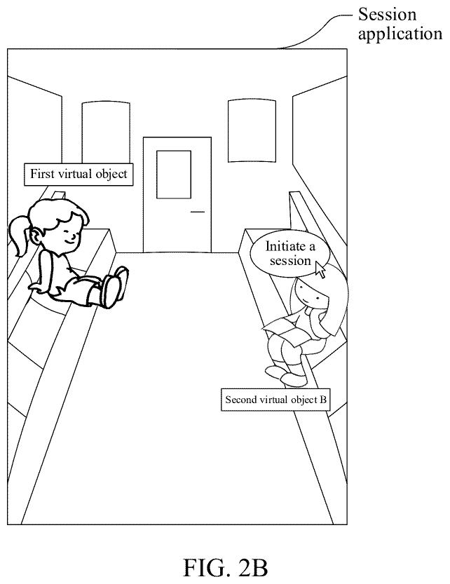

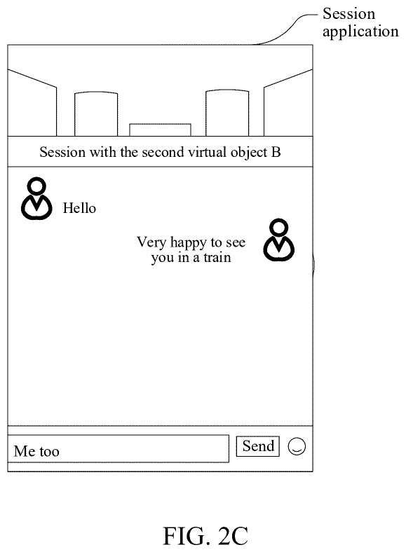

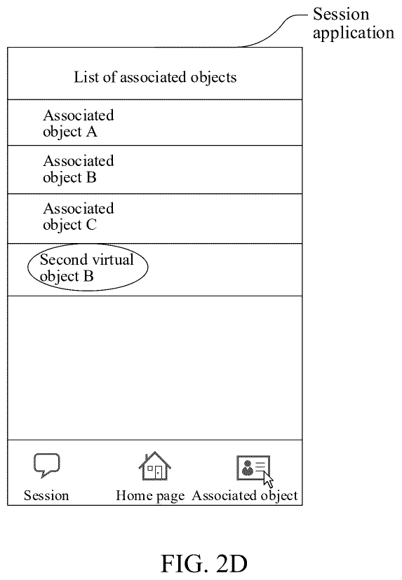

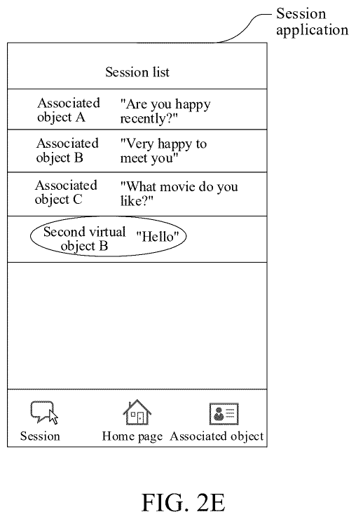

The embodiments of this application are applicable to a plurality of scenarios, for example, a scenario in which an association relationship is established with an unfamiliar object in a messaging application shown in FIG. 2A to FIG. 2E.

On an interface of the messaging application shown in FIG. 2A, the messaging application can support a first object in performing instant messaging and establishing an association relationship with an unfamiliar object. After the first object triggers an option “Home page” in a function bar, a virtual character corresponding to the first object and a target virtual scene are displayed. After an entry control for the target virtual scene is triggered, the interface of the messaging application is shown in FIG. 2B.

FIG. 2B shows the target virtual scene. In the target virtual scene, the first virtual object corresponding to the first object and a second virtual object B corresponding to the unfamiliar object are presented. A session start control configured for triggering to initiate a temporary session request to the second virtual object B is displayed near the second virtual object B, and is displayed as “Initiate a session”. After “Initiate a session” is tapped, the interface of the messaging application is shown in FIG. 2C.

In FIG. 2C, a session window between the first virtual object and the second virtual object B is popped up on the interface. In the session window, the first object may perform an instant session with the unfamiliar object.

After performing the instant session with the unfamiliar object, the first object may establish an association relationship with the unfamiliar object. As shown in FIG. 2D, after performing the session with the unfamiliar object corresponding to the second virtual object B, the first object may establish the association relationship with the unfamiliar object. For example, display of a list of associated objects corresponding to the first object may be triggered by triggering an option “Associated object” in the function bar. In addition to objects with which association relationships have been previously established, the unfamiliar object corresponding to the second virtual object B is further added to the listed, and is represented by using the second virtual object B in FIG. 2D.

After the unfamiliar object corresponding to the second virtual object B is added as the associated object, an instant session may be directly performed with the associated object by using the messaging application outside the target virtual scene. As shown in FIG. 2E, after the association relationship is established between the first object and the unfamiliar object corresponding to the second virtual object B, a session record with the unfamiliar object corresponding to the second virtual object B may be viewed by triggering an option “Session” in the function bar, or a session box may be entered to perform an instant session with the unfamiliar object corresponding to the second virtual object B.

### Overall Descriptions of the Embodiments of this Application

According to an embodiment of this application, a session processing method is provided.

The session processing method is configured for supporting an object in quickly establishing an association relationship with another unassociated object. Two objects having an association relationship can quickly start an instant session in a messaging application, thereby improving an object interworking rate of the messaging application. The object interworking rate is a proportion of objects pairs that have communicated with each other in all objects pairs of all objects of the messaging application. For example, a total of 100 objects are registered in the messaging application, and 4950 object pairs may be formed by combining the objects in pairs. If objects in 1000 object pairs thereof have communicated with each other, the object interworking rate of the messaging application is 1000/4950≈0.2. A higher object interworking rate of a messaging application indicates more objects performing instant sessions with other objects by using the messaging application and a higher coverage rate of the application. This embodiment of this application can enable objects with no association relationship to perform an instant session, and quickly establish the association relationship between the objects after the session ends.

In the session processing method in this embodiment of this application, the object terminal 110 requests the server 130 for data in response to triggering by an object. After receiving the data, the object terminal 110 renders the data, and presents corresponding content to the object by using the object terminal 110.

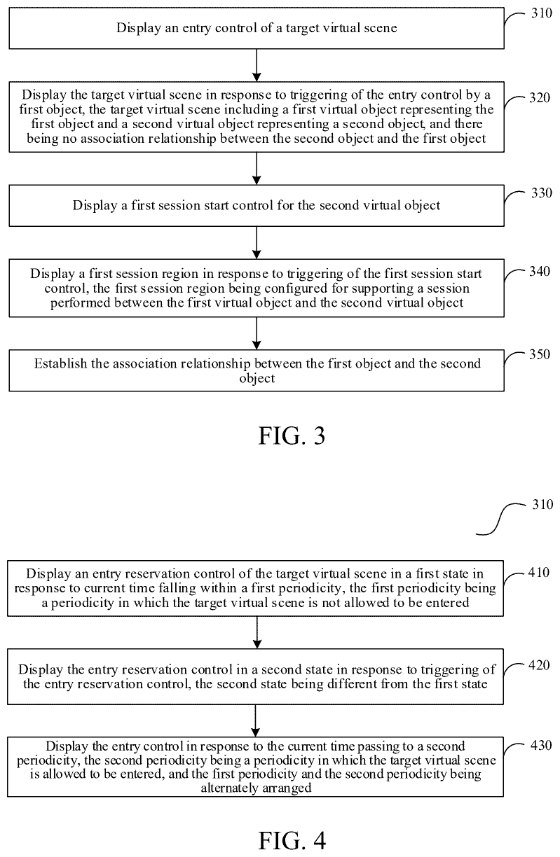

As shown in FIG. 3, according to an embodiment of this application, the session processing method includes the following operations.

Operation 310: Display an entry control of a target virtual scene.

Operation 320: Display the target virtual scene in response to the entry control being triggered by a first object, the target virtual scene including a first virtual object representing the first object and a second virtual object representing a second object, and there being no association relationship between the second object and the first object.

Operation 330: Display a first session start control for the second virtual object.

Operation 340: Display a first session region in response to the first session start control being triggered, the first session region being configured for supporting a session performed between the first virtual object and the second virtual object.

Operation 350: Establish the association relationship between the first object and the second object.

Operations 310 to 350 are described in detail below.

### Detailed Descriptions of Operation 310

In operation 310, the target virtual scene is a virtual scene that the first virtual object corresponding to the first object is to enter. A display form of the target virtual scene may be any scene form, for example, may be any indoor or outdoor scene, and more specifically, may be a movable form such as a train. The first object is an object using a messaging application. The entry control is a control configured for triggering to enter the target virtual scene. The entry control may be presented in the messaging application in a plurality of forms, for example, in a button form (where a triggering manner is tapping a button of entering the scene) or a sliding form (where a triggering manner is sliding the control to a specified position).

In one embodiment, as shown in FIG. 4, the display an entry control of a target virtual scene includes the following operations.

Operation 410: Display an entry reservation control of the target virtual scene in a first state in response to current time falling within a first cycle, the first cycle being a cycle in which the target virtual scene is not allowed to be entered.

Operation 420: Display the entry reservation control in a second state in response to the entry reservation control being triggered, the second state being different from the first state.

Operation 430: Display the entry control in response to the current time passing to a second cycle, the second cycle being a cycle in which the target virtual scene is allowed to be entered, and the first cycle and the second cycle being alternately arranged.

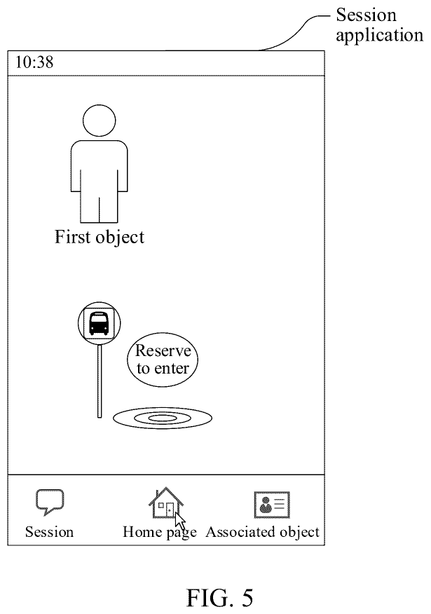

In this embodiment, the first cycle is preset. The first cycle is the cycle in which the target virtual scene is not allowed to be entered, or may be understood as a cycle in which the target virtual scene is waited to arrive. In other words, when the time at which the first object enters the messaging application is within the first cycle, the target virtual scene is not allowed to be entered. For example, when the target virtual scene is a train, and the train has not arrived at a station, the entry reservation control needs to be presented to the first object. For example, the first cycle is 40 seconds, and a time range within which the first cycle falls may be from 10:00:00 to 10:00:40. If the first object enters the messaging application at 10:00:10, the entry reservation control is presented. When preparing to enter the scene, the first object may trigger the entry reservation control. The first state of the entry reservation control may be a plurality of forms. For example, as shown in FIG. 5, when the target virtual scene is not presented in the messaging application, indicating that the train serving as the target virtual scene has not arrived at the station, the entry reservation control is presented to the first object in a form of a button.

In one embodiment, the display an entry reservation control of the target virtual scene in a first state in response to current time falling within a first cycle includes: displaying the entry reservation control of the target virtual scene in the first state in response to the current time falling within the first cycle, and displaying first remaining duration to an end of the first cycle.

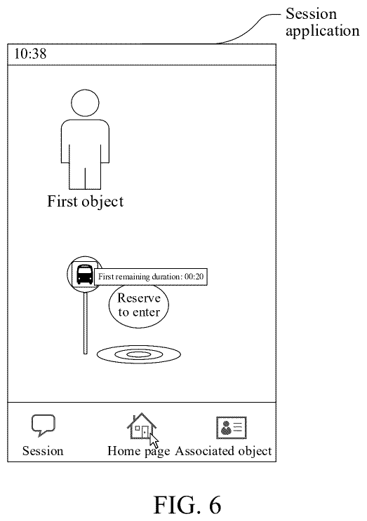

In this embodiment, the first remaining duration to the end of the first cycle is further displayed in the messaging application. The end of the first cycle indicates that the target virtual scene is allowed to be entered. For example, the first remaining duration is duration to time at which the train serving as the target virtual scene arrives at the station. For example, as shown in FIG. 6, the first remaining duration is 20 seconds, in other words, the train serving as the target virtual scene arrives at the station after 20 seconds. The first remaining duration is dynamically displayed in the messaging application, in other words, as time changes, the displayed first remaining duration gradually decreases.

An objective of displaying the first remaining duration is to enable the first object to intuitively see current remaining duration before the target virtual scene is allowed to be entered, and select, based on the first remaining duration, whether to reserve to enter the scene. After entering the messaging application, the first object may directly perform a session with an associated object with which an association relationship has been established. As a result, if the first object does not know the remaining duration and blindly triggers reservation to enter the target virtual scene, a case in which the first object is performing the session with the associated object when the target virtual scene is allowed to be entered may occur. To enter the target virtual scene, the target object has to interrupt the session with the associated object, affecting session efficiency. Therefore, an advantage of displaying the first remaining duration is that the first object can conveniently determine, based on a session condition with the associated object, whether to reserve to enter the target virtual scene, thereby improving the session efficiency with the associated object and ensuring integrity of the session.

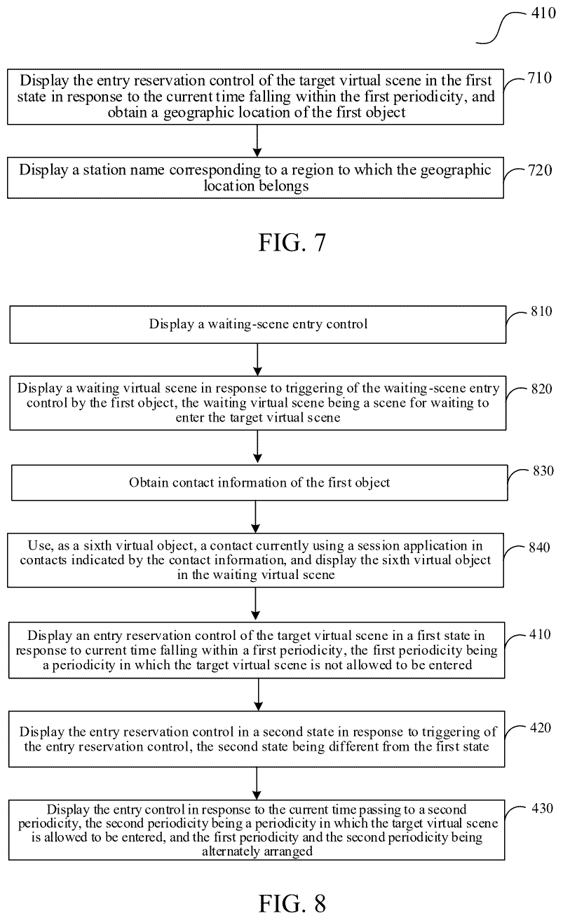

In another embodiment, as shown in FIG. 7, the display an entry reservation control of the target virtual scene in a first state in response to current time falling within a first cycle includes the following operations.

Operation 710: Display the entry reservation control of the target virtual scene in the first state in response to the current time falling within the first cycle, and obtain a geographic location of the first object.

Operation 720: Display a station name corresponding to a region to which the geographic location belongs.

The geographic location of the first object may be an administrative geographic region, such as a city A or a city B, or may be a geographic region obtained through division based on an entity in a map, such as a park XX or a school XX.

The geographic location of the first object may be obtained from positioning information of the object terminal 110 used by the first object. The object terminal 110 used by the first object has a positioning apparatus such as a global positioning system (GPS) or a BeiDou navigation satellite system (BeiDou). The positioning apparatus can constantly obtain the positioning information of the object terminal 110. The current geographic location of the first object may be determined based on the positioning information. For example, the object terminal 110 is mapped to an electronic map based on GPS positioning information obtained by the positioning apparatus, and it is discovered that the object terminal 110 belongs to a city A. In this case, the geographic location of the first object is the city A.

Before the geographic location of the first object is obtained, approval of the first object needs to be obtained in advance, and related laws, regulations, and standards need to be complied with. When the approval of the first object is solicited, individual permission or individual approval of the first object may be obtained in a manner such as a pop-up window or jumping to a confirmation page.

After the geographic location of the first object is obtained, the station name corresponding to the region to which the geographic location belongs is displayed in the messaging application. The station name represents a name of a station at which the first object waits for the train serving as the target virtual scene. For example, when the obtained geographic location of the first object is a park XX, a displayed station name of a waiting virtual scene at which the first object is located is “Station of Park XX”.

An advantage of using the actual geographic location as the station name is that objects whose geographic locations belong to the same region or close regions can be determined based on station names of different objects, and the objects whose geographic locations are the same or close more easily establish an association relationship, to help improve an object interworking rate of the messaging application.

In one embodiment, as shown in FIG. 8, before the entry reservation control of the target virtual scene is displayed in the first state in response to the current time falling within the first cycle, the session processing method further includes the following operations.

Operation 810: Display a waiting-scene entry control.

Operation 820: Display a waiting virtual scene in response to triggering the waiting-scene entry control by the first object, the waiting virtual scene being a scene for waiting to enter the target virtual scene.

Operation 830: Obtain contact information of the first object.

Operation 840: Use, as a sixth virtual object, a contact currently using the messaging application in contacts indicated by the contact information, and display the sixth virtual object in the waiting virtual scene.

The waiting-scene entry control is a control configured for entering the waiting virtual scene. The waiting-scene entry control may have a plurality of presentation forms, for example, a button or a sliding window. When the waiting-scene entry control is triggered, the waiting virtual scene may be correspondingly displayed in the messaging application. For example, when the target virtual scene is the train, the waiting virtual scene may be a train waiting square, and a status (whether the trains arrive at the station) of the target virtual scene may further be displayed in the waiting virtual scene. If the target virtual scene arrives at the station, the entry control is displayed. If the target virtual scene does not arrive at the station, the entry reservation control is displayed.

The contact of the first object is an object that has an association relationship with the first object in the messaging application. Approval of the first object needs to be obtained in advance before the contact information of the first object is obtained. This is the same as the foregoing content, and details are not described herein again.

The obtain contact information of the first object includes: determining whether the contact of the first object is currently using the messaging application. A virtual character corresponding to the contact currently using the messaging application in the messaging application is used as the sixth virtual object, and the sixth virtual object is displayed in the waiting virtual scene.

In the messaging application, each object has a corresponding virtual character, and the virtual character is configured for representing a virtual object corresponding to the object in the messaging application. When the object registers with the messaging application, the virtual character may be customized by the messaging application for the object, or may be customized by the object. In the messaging application, the virtual character may be modified.

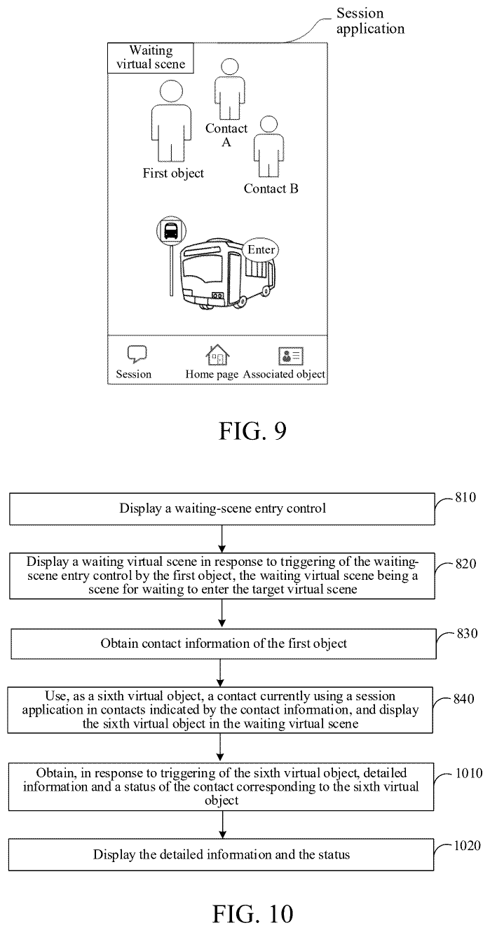

For example, as shown in FIG. 9, in the waiting virtual scene, the target virtual scene and the entry control are presented. It is determined, by obtaining the contact information of the first object, that a contact A and a contact B are currently using the messaging application, and virtual characters respectively corresponding to the first object, the contact A, and the contact B are displayed in the waiting virtual scene.

An advantage of obtaining the contact information and presenting, in the waiting virtual scene, the virtual object corresponding to the contact currently using the messaging application is that the object that can perform a session with the first object is directly presented to the first object, so that session efficiency of the session performed between the first object and the contact is improved.

In one embodiment, as shown in FIG. 10, after the contact currently using the messaging application in the contacts indicated by the contact information is used as the sixth virtual object, and the sixth virtual object is displayed in the waiting virtual scene, the session processing method further includes the following operations.

Operation 1010: Obtain, in response to the sixth virtual object being triggered, detailed information and a status of the contact corresponding to the sixth virtual object.

Operation 1020: Display the detailed information and the status.

The sixth virtual object may be triggered in a manner such as tapping or sliding. The detailed information of the contact includes a name of the contact, a geographic location of the contact, and the like. The status of the contact includes currently waiting for the target virtual scene, having entered the target virtual scene but the target virtual scene being not run, and the target virtual scene having been run.

The detailed information of the contact may be obtained in a manner such as obtaining registration information of the contact in the messaging application and obtaining geographic location information of an object terminal 110 of the contact.

The status of the contact may be obtained by obtaining data that is stored in the server 130 and that corresponds to a status field of the object. The data of the status field changes based on an operation of the object in the messaging application. For example, when the object triggers the entry reservation control, the data of the status field is “Currently waiting for the target virtual scene”. When the first cycle ends and the second cycle starts, the data of the status field is “Having entered the target virtual scene but the target virtual scene being not run”. When the second cycle ends, the data of the status field changes to “The target virtual scene having been run”.

Approval of the content needs to be obtained in advance before the detailed information and the status of the content are obtained. This is the same as the foregoing content, and details are not described herein again.

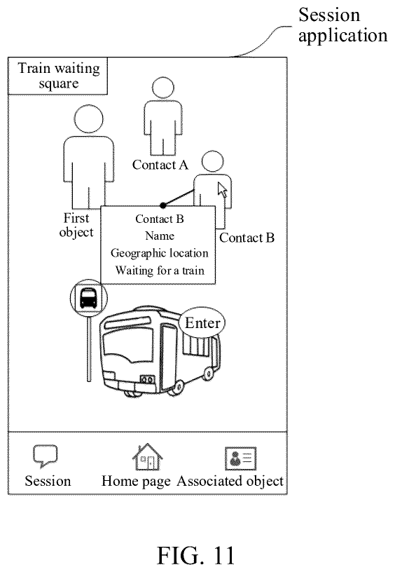

As shown in FIG. 11, the detailed information and the status of the content are displayed, so that the first object can intuitively learn the current condition of the contact.

An advantage of triggering to display the detailed information and the status of the content corresponding to the sixth virtual object is that the first object can quickly learn the current condition of the contact, to help the first object determine whether current time is an appropriate occasion for the session with the contact, thereby improving the session efficiency between the first object and the contact.

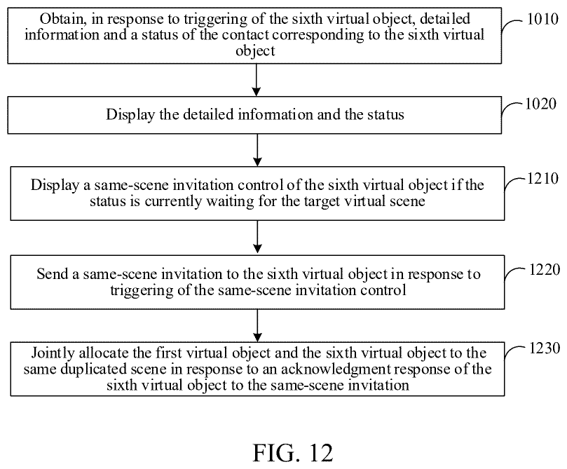

In one embodiment, the target virtual scene includes a plurality of duplicated scenes of the target virtual scene, in other words, there are a plurality of target virtual scenes at the same time, and one of the target virtual scenes is the target virtual scene that the first object is to enter. Based on this, as shown in FIG. 12, after the detailed information and the status are displayed, the session processing method further includes the following operations.

Operation 1210: Display a same-scene invitation control of the sixth virtual object if the status is currently waiting for the target virtual scene.

Operation 1220: Send a same-scene invitation to the sixth virtual object in response to the same-scene invitation control being triggered.

Operation 1230: Jointly allocate the first virtual object and the sixth virtual object to the same duplicated scene in response to an acknowledgment response of the sixth virtual object to the same-scene invitation.

If the status of the sixth virtual object is currently waiting for the target virtual scene, it indicates that neither has the sixth virtual object entered the target virtual scene. The sixth virtual object may be allocated to one of the plurality of duplicated scenes, and may not be in the same duplicated scene as the first virtual object corresponding to the first object. However, if the sixth virtual object agrees to be in the same scene as the first virtual object, the sixth virtual object and the first virtual object appear in the same duplicated scene.

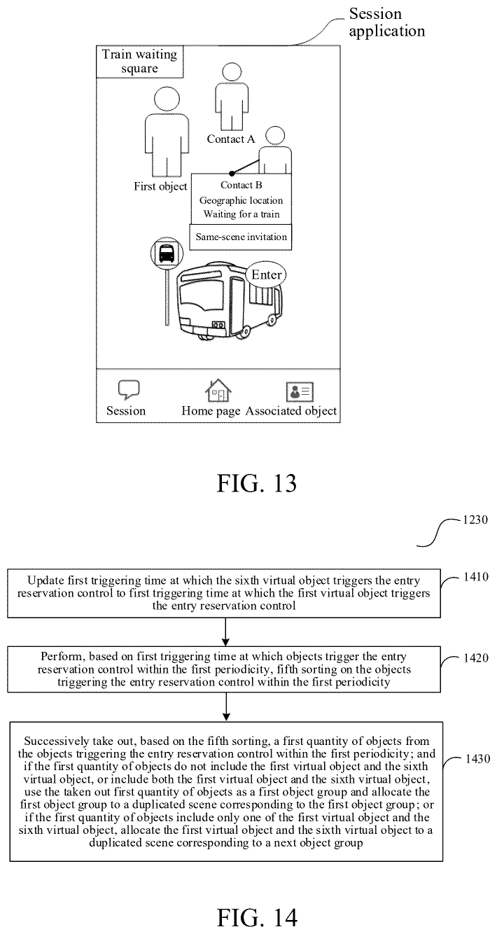

For example, as shown in FIG. 13, a status of the contact B that is viewed by the first object is currently waiting for the target virtual scene. Therefore, a button “Same-scene invitation” is automatically displayed on an interface. If the first object triggers the same-scene invitation, the contact B receives a same-scenario request from the first object. If the contact B receives the same-scenario request, after the train serving as the target virtual scene arrives at the station, the first virtual object and the sixth virtual object of the contact B are allocated to the same target virtual scene. If the contact B does not receive the same-scenario request, the first virtual object and the sixth virtual object that corresponds to the contact B may be in the same duplicated scene, or may be in different duplicated scenes.

In one embodiment, as shown in FIG. 14, the jointly allocate the first virtual object and the sixth virtual object to the same duplicated scene includes the following operations.

Operation 1410: Update first triggering time at which the sixth virtual object triggers the entry reservation control to first triggering time at which the first virtual object triggers the entry reservation control.

Operation 1420: Perform, based on first triggering time at which objects trigger the entry reservation control within the first cycle, fifth sorting on the objects triggering the entry reservation control within the first cycle.

Operation 1430: Successively take out, based on the fifth sorting, a first quantity of objects from the objects triggering the entry reservation control within the first cycle; and if the first quantity of objects do not include the first virtual object and the sixth virtual object, or include both the first virtual object and the sixth virtual object, use the taken out first quantity of objects as a first object group and allocate the first object group to a duplicated scene corresponding to the first object group; or if the first quantity of objects include only one of the first virtual object and the sixth virtual object, allocate the first virtual object and the sixth virtual object to a duplicated scene corresponding to a next object group.

In operation 1410, the sixth virtual object has triggered the entry reservation control before the first virtual object initiates the same-scene invitation. The first triggering time refers to time at which an object triggers the entry reservation control. The first triggering time of triggering the entry reservation control is separately recorded for the first virtual object and the sixth virtual object. When the sixth virtual object agrees with the same-scene invitation of the first object, to enable the first virtual object and the sixth virtual object to enter the same duplicated scene, the first triggering time for the sixth virtual object may be updated to the first triggering time for the first virtual object. In this case, the first triggering time for the first virtual object and the first triggering time for the sixth virtual object are the same. For example, the first triggering time for the first virtual object is 10:20:20, and first triggering time for a sixth virtual object A is 10:20:35. After the sixth virtual object accepts the same-scenario request, the first triggering time for the sixth virtual object A is also updated to 10:20:20.

In operation 1420, the fifth sorting is performed, based on a chronological sequence of the respective corresponding first triggering time, on the objects triggering the entry reservation control within the first cycle. For example, Table 1 shows a result obtained after the fifth sorting is performed on the first triggering time at which the objects trigger the entry reservation control within the first cycle.

TABLE 1

| Object | First triggering time |
|---|---|
| Object A | 10:20:14 |
| Object B | 10:20:18 |
| Object C (First virtual object) | 10:20:20 |
| Object D (Sixth virtual object A) | 10:20:20 |
| Object E | 10:20:29 |
| Object F | 10:20:37 |

In operation 1430, the first quantity of objects are successively taken out based on the result of the fifth sorting, the first quantity of objects are used as the first object group, and the objects in the first object group are allocated to the duplicated scene. The first quantity is a preset quantity of objects accommodated in one duplicated scene. For example, the first quantity is 4, indicating that at most four objects can enter one duplicated scene. If a first object group includes both the first virtual object and the sixth virtual object, or includes neither of the first virtual object and the sixth virtual object, the first object group is directly allocated to the duplicated scene.

For example, based on Table 1, if the first quantity is 4, four objects are successively taken out and added to one first object group. In this case, a first object group A includes the object A, the object B, the object C (the first virtual object), and the object D (the sixth virtual object A), and a first object group B includes the object E and the object F. The first object group A and the first object group B are respectively allocated to corresponding duplicated scenes.

If an object group includes only one of the first virtual object and the sixth virtual object, the included first virtual object or sixth virtual object is allocated to a next first object group. For example, based on Table 1, if the first quantity is 3, three objects are successively taken out and added to one first object group. A first object group A includes the object A, the object B, and the object C (the first virtual objects). Because the first object group A includes only the first virtual object and does not include the sixth virtual object A, the first virtual object is taken out and added to a next first object group. Therefore, the first object group A includes the object A and the object B, and a first object group B includes the object C (the first virtual object), the object D (the sixth virtual object A), and the object E. A first object group C includes the object F. The first object group A, the first object group B, and the first object group C are respectively allocated to corresponding duplicated scenes.

In this embodiment, it is ensured that the first virtual object and the sixth virtual object can be certainly allocated to the same duplicated scene, and an order at which another object enters the duplicated scene is not affected, so that allocation efficiency of allocating two objects to the same duplicated scene is improved.

An advantage of the embodiment of operations 1210 to 1230 is that two objects having an association relationship can be allocated to the same target virtual scene, so that the two objects can enter the target virtual scene to perform a session. The session is performed in combination with the target virtual scene, thereby improving session efficiency and session enjoyment.

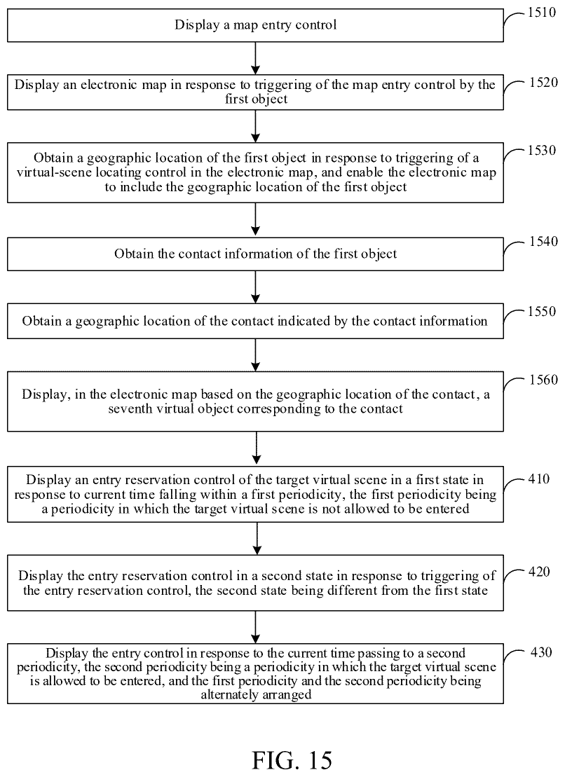

In another embodiment, as shown in FIG. 15, before the entry reservation control of the target virtual scene is displayed in the first state in response to the current time falling within the first cycle, the session processing method further includes the following operations.

Operation 1510: Display a map entry control.

Operation 1520: Display an electronic map in response to the map entry control being triggered by the first object.

Operation 1530: Obtain a geographic location of the first object in response to a virtual-scene locating control being triggered in the electronic map, and enable the electronic map to include the geographic location of the first object.

Operation 1540: Obtain the contact information of the first object.

Operation 1550: Obtain a geographic location of the contact indicated by the contact information.

Operation 1560: Display, in the electronic map based on the geographic location of the contact, a seventh virtual object corresponding to the contact.

In the messaging application, the geographic locations of the first object and the contact may further be viewed by using a map. The map entry control is a control configured for entering the map, and the map entry control may be displayed in a plurality of forms.

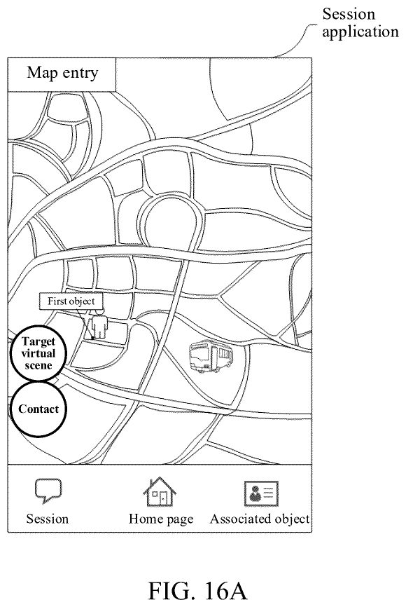

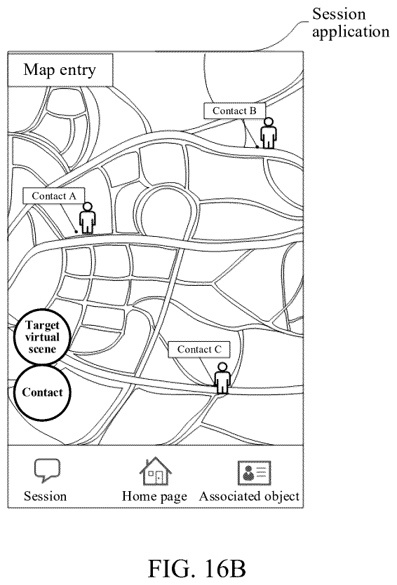

After the map entry control is triggered, the electronic map is opened. The electronic map is a map consistent with geographic regions in reality. In the electronic map, the first object may view the geographic location of the first object. As shown in FIG. 16A, when the virtual-scene locating control in the electronic map is triggered, the geographic location of the first object is obtained, and the geographic location of the first object is displayed in the electronic map. The obtaining the geographic location of the first object is described in detail in the foregoing embodiment, and details are not described herein again.

A location of the target virtual scene, for example, a location of the train serving as the target virtual scene, is further displayed in the electronic map. However, because the target virtual scene is virtual and does not have a real form and location, the location of the target virtual scene may be a random location or a preset location near the first object, to indicate that the virtual scene is to arrive at the station. When the target virtual scene arrives at the geographic location of the first object, a corresponding station name is displayed in the electronic map when the target virtual scene arrives at the geographic location.

In the electronic map, the first object may further view a geographic location of the contact currently using the messaging application. As shown in FIG. 16B, after “Contact” is tapped, the location of the contact currently using the messaging application and a seventh virtual object corresponding to the contact appear in the electronic map. To display the geographic location of the contact and the seventh virtual object, the contact information needs to be obtained. The contact information includes information about the geographic locations of the contacts. The obtaining the contact information is described in detail in the foregoing embodiment, and details are not described herein again.

The display, based on the geographic location of the first object displayed in the electronic map, the entry reservation control of the target virtual scene in the first state in response to the current time falling within the first cycle includes: displaying, at the geographic location of the first object, the entry reservation control of the target virtual scene in the first state in response to the current time falling within the first cycle.

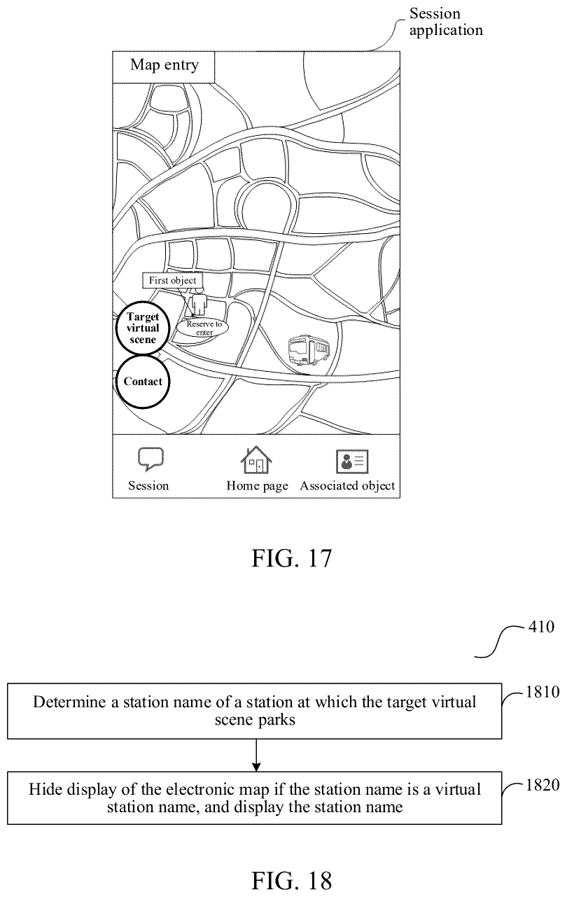

As shown in FIG. 17, in the electronic map, the entry reservation control may alternatively be displayed in the first state at the geographic location of the first object. The entry reservation control is triggered, so that the target virtual scene can be directly reserved to be entered on an interface of the electronic map.

An advantage of this embodiment is that a distance to another contact is intuitively presented to the first object by using the map, so that the first object initiates a session with the contact based on the geographic location, thereby improving session efficiency. The entry reservation control may be directly triggered in the electronic map without returning to an interface of the waiting virtual scene to reserve to enter the target virtual scene, thereby improving operation efficiency of the messaging application.

In one embodiment, as shown in FIG. 18, based on the foregoing embodiment of displaying the entry reservation control of the target virtual scene at the geographic location of the first object in the electronic map, the display an entry reservation control of the target virtual scene in a first state in response to current time falling within a first cycle includes the following operations.

Operation 1810: Determine a station name of a station at which the target virtual scene parks.

Operation 1820: Hide display of the electronic map if the station name is a virtual station name, and display the station name.

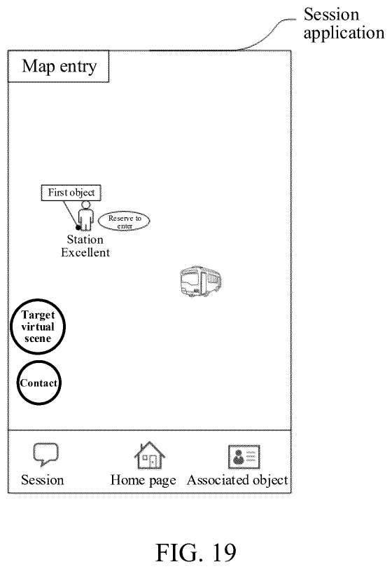

The station name of the station at which the target virtual scene parks may be a virtual station name, in other words, the station does not correspond to a geographic region in the electronic map, and the station cannot be found in the electronic map. If the virtual station is presented in the electronic map, an object is easily confused about whether the station name of the station is a real station name or a virtual station name. Therefore, when it is determined that the station name of the station at which the target virtual scene parks is the virtual station name, the display of the electronic map is hidden, and the station name is displayed only at a location of the station. For example, as shown in FIG. 19, a station name of a station at which the target virtual scene parks is “Station Excellent”, which is a virtual station name. Therefore, the electronic map is hidden, and only the first object, the entry reservation control displayed in the first state, the target virtual scene not arriving at the station, and the virtual station name of the station are displayed.

A reason for setting the virtual station name is to provide an unreal session topic for objects using the messaging application, to help objects with no association relationship be familiar as soon as possible, thereby establishing the association relationship. For example, when the set virtual station name is related to a movie, an object entering the target virtual scene from the station may start a session by using a topic related to the movie as a starting point. Therefore, the object interworking rate of the messaging application can be improved by setting the virtual station name.

In this embodiment, the virtual station name and the real station name are differently displayed, to help the first object clearly know an attribute of the station name, so as to perform corresponding session operations for different stations. For example, if a station name is a real station name, geographic locations of objects entering the target virtual scene from the station are close, and the objects may perform a session by using the geographic locations as a topic. If a station name is a virtual station name, objects may perform a session by using the station name as a topic. Therefore, in this embodiment, a problem that a session topic between objects is unclear because the objects are unclear about an attribute of a station name is avoided, and session efficiency between the objects is further improved.

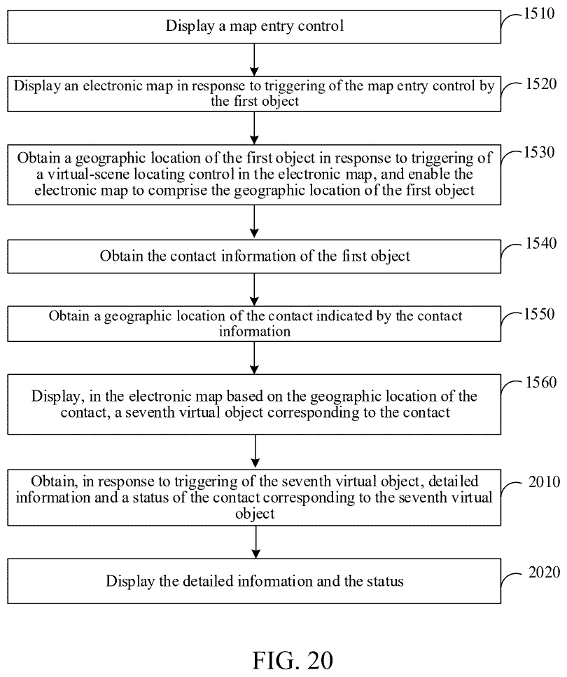

In one embodiment, as shown in FIG. 20, after operation 1560 of displaying, in the electronic map based on the geographic location of the contact, a seventh virtual object corresponding to the contact, the session processing method further includes:

Operation 2010: Obtain, in response to the seventh virtual object being triggered, detailed information and a status of the contact corresponding to the seventh virtual object.

Operation 2020: Display the detailed information and the status.

The geographic location of the contact and the corresponding seventh virtual character may be displayed in the electronic map. The detailed information and the status of the corresponding contact may be viewed by triggering the seventh virtual object.

This embodiment is the same as the foregoing embodiment of viewing the detailed information and the status of the contact by triggering the sixth virtual object corresponding to the contact, and details are not described herein again.

In operation 420, the entry reservation control is displayed in the second state after the entry reservation control is triggered. The second state is different from the first state.

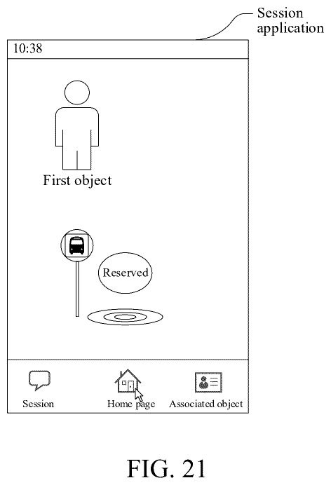

For example, when the entry reservation control in FIG. 5 is tapped, the entry reservation control changes to the second state. As shown in FIG. 21, “Reserve to enter the scene” changes to “Reserved”. “Reserved” may be a fixed key that cannot trigger any response, or may be a control that can cancel reservation after being tapped.

The second state may have a plurality of presentation forms, for example, static text presentation or animation presentation (for example, a virtual scene in the form of a running train).

In one embodiment, the display the entry reservation control in a second state in response to the entry reservation control being triggered includes: displaying the entry reservation control in the second state in response to the entry reservation control being triggered, and displaying prompt information of a station-arriving reminder.

The prompt information of the station-arriving reminder is information for prompting the first object that a prompt message is to be sent after the train serving as the target virtual scene arrives at the station.

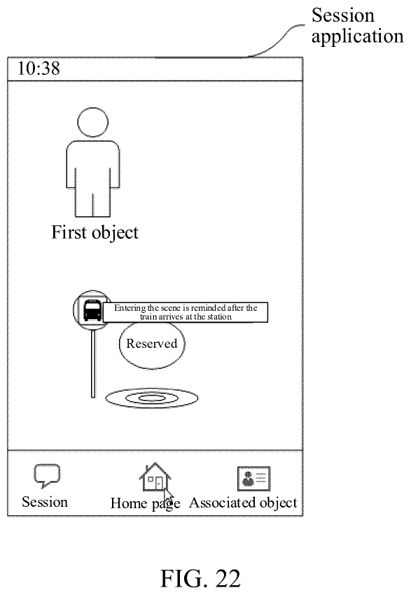

As shown in FIG. 22, on the basis that the entry reservation control is displayed in the second state in FIG. 21, a piece of prompt information “Entering the scene is reminded after the train arrives at the station” is presented to the first object.

When the prompt information of the station-arriving reminder is displayed, a request of “whether to allow the application to send the prompt information” may further be initiated to the first object in a manner such as a pop-up window or jumping to a confirmation page. Only after approval of the first object is obtained, the information for prompting to enter the scene can be sent to the first object when the train serving as the target virtual scene arrives at the station.

In this embodiment, the first object is prompted, by displaying the prompt information of the station-arriving reminder, that the virtual scene arrives at the station. Even if the first object is operating another transaction, time at which the virtual scene arrives at the station is not missed. Therefore, an advantage of this embodiment is that the first object is prevented from missing the time at which the virtual scene arrives at the station, thereby improving information transfer efficiency.

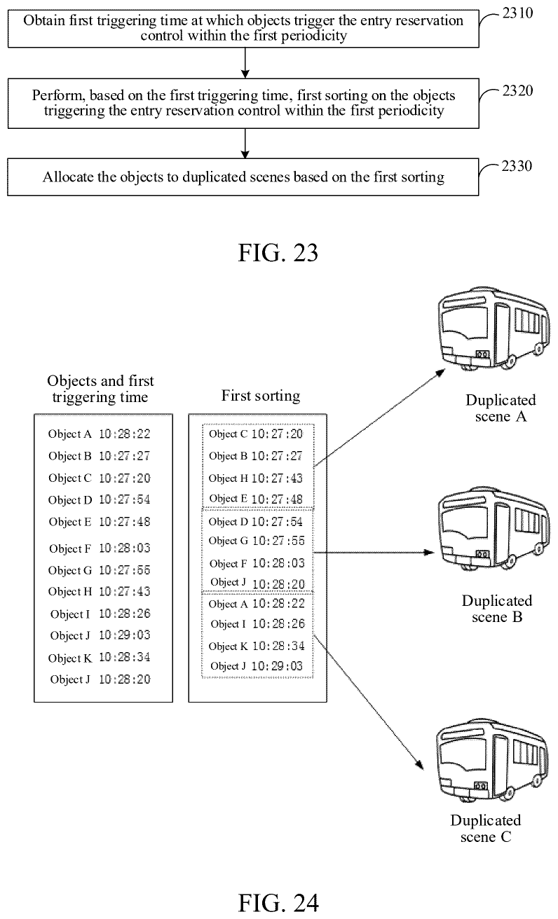

In one embodiment, the target virtual scene includes a plurality of duplicated scenes of the target virtual scene. As shown in FIG. 23, this embodiment further includes the following operations.

Operation 2310: Obtain first triggering time at which objects trigger the entry reservation control within the first cycle.

Operation 2320: Perform, based on the first triggering time, first sorting on the objects triggering the entry reservation control within the first cycle.

Operation 2330: Allocate the objects to the duplicated scenes based on the first sorting.

The first triggering time is described in detail in the foregoing embodiment, and details are not described herein again.

First sorting is performed, based on a chronological sequence of the first triggering time, on the objects triggering the entry reservation control within the first cycle. Different objects are allocated to one duplicated scene based on a sorting order. For example, a result of performing, based on the first triggering time, the first sorting on the objects triggering the entry reservation control within the first cycle is shown in FIG. 24. Based on the sorting order, the 1^{st} to the 4^{th} in the sorting are allocated to a duplicated scene A, the 5^{th} to the 8^{th} are allocated to a duplicated scene B, and the 9^{th} to the 12^{th} are allocated to a duplicated scene C.

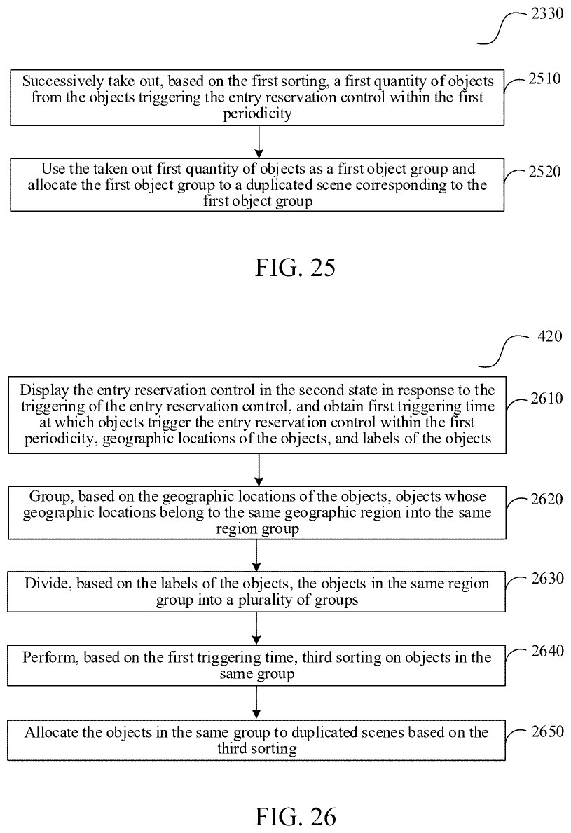

In one embodiment, a maximum capacity of virtual objects in a duplicated scene is a first quantity. As shown in FIG. 25, the allocate the objects to the duplicated scenes based on the first sorting includes the following operations.

Operation 2510: Successively take out, based on the first sorting, a first quantity of objects from the objects triggering the entry reservation control within the first cycle.

Operation 2520: Use the taken out first quantity of objects as a first object group and allocate the first object group to a duplicated scene corresponding to the first object group.

The first quantity is a maximum capacity of virtual objects that can be accommodated in a duplicated scene, and may be understood as a maximum passenger capacity of a virtual scene. The first quantity of objects are successively taken out, based on a time sequence as one first object group, from the first sorting. For example, in FIG. 24, the first quantity is 4. In this case, an object C, an object B, an object H, and an object E are one first object group, and need to be allocated to one duplicated scene.

When an object already exists in a duplicated scene, but there is still a remaining quantity short of the first quantity, a remaining quantity of objects are successively taken out based on the first sorting and allocated to the corresponding duplicated scene, so that a quantity of objects in the duplicated scene reaches the first quantity.

For example, in FIG. 24, the first quantity is 4, and it is assumed that there are two objects in the duplicated scene A and one object in the duplicated scene B before the target virtual scene arrives at the station. In this case, a remaining quantity in the duplicated scene A is 2, and a remaining quantity in the duplicated scene B is 3. Quantities of objects in the duplicated scenes are successively supplemented based on the first sorting. The object C and the object B are allocated to the duplicated scene A, and the object H, the object E, and the object D are allocated to the duplicated scene B. Because there is no object in the duplicated scene C, a first quantity of objects are taken out, which are respectively an object G, an object F, an object J, and the object A. A duplicated scene D including no object further exists. An object I, an object K, and the object J are allocated to the duplicated scene D.

An advantage of this embodiment is that it is ensured that a quantity of objects in each duplicated scene reaches a maximum capacity, so that the first object can have conversations with as many second objects as possible, thereby improving the object interworking rate of the messaging application.

In the embodiment of operations 2310 to 2330, the objects are allocated to different duplicated scenes based on the time sequence, so that objects reserving to enter the scene at close time are in the same duplicated scene. The objects reserving to enter the scene at the close time may more easily start a session due to an event happening at the time, which is beneficial to facilitating establishing an association relationship between the objects, and improving the object interworking rate of the messaging application.

In one embodiment, the target virtual scene includes a plurality of duplicated scenes of the target virtual scene in the same geographic region. As shown in FIG. 26, the display the entry reservation control in a second state in response to the entry reservation control being triggered includes the following operations.

Operation 2610: Display the entry reservation control in the second state in response to the entry reservation control being triggered, and obtain first triggering time at which objects trigger the entry reservation control within the first cycle, geographic locations of the objects, and labels of the objects.

Operation 2620: Group, based on the geographic locations of the objects, objects whose geographic locations belong to the same geographic region into the same region group.

Operation 2630: Divide, based on the labels of the objects, the objects in the same region group into a plurality of groups.

Operation 2640: Perform, based on the first triggering time, third sorting on objects in the same group.

Operation 2650: Allocate the objects in the same group to duplicated scenes based on the third sorting.

The plurality of duplicated scenes of the target virtual scene exist in each geographic region. After an object triggers the entry reservation control, first triggering time of triggering the entry reservation control, a current geographic location of the object, and a label of the object are obtained. The obtaining the first triggering time and the geographic location is described in detail in the foregoing embodiment, and details are not described herein again.

The label of the object refers to a feature related to the object. The feature of the object is a feature of the first object, for example, a feature such as a profession or an education level of the object. The objects are grouped based on the labels of the objects, so that objects with the same feature or similar features can have a chance to perform a session. The objects with the same feature or the similar features can more easily launch a topic when performing the session, to help establish an association relationship between the objects. For example, two objects in the same profession may discuss a topic related to the profession.

Approval of the object needs to be obtained in advance before the object label of the object is obtained. In addition, collection, use, processing, and the like of the labels of the objects comply with related laws, regulations, and standards.

After the first triggering time, the geographic locations, and the object labels of the objects are obtained, division of the 1^{st} time is first performed on the objects based on the geographic locations. For example, the geographic locations of the objects triggering the entry reservation control within the first cycle are as follows: object A-city B, object B-city A, object C-city B, object D-city A, object E-city A, object F-city B, object G-city A, object H-city A, object I-city B, object J-city A, and object K-object B. Region groups obtained through division based on the geographic locations are respectively as follows: city A: (object B, object D, object E, object G, object H, and object J), and city B: (object A, object C, object F, object I, and object K).

After the region groups are obtained through division, the objects in each region group are grouped based on the labels of the objects. There may be a plurality of labels of the objects, and grouping cannot be performed based on one label. Therefore, the objects in the same region group are divided into the plurality of groups based on the labels of the objects. The object features of the plurality of objects in the same region group may be inputted into an object grouping model, and the object grouping model divides the plurality of objects into the plurality of groups based on the object features. An advantage of using the object grouping model to group the objects in the same region group into the plurality of groups is that grouping accuracy is high.

After the plurality of groups are obtained through division based on the labels of the object, the third sorting is performed on objects in one group based on a chronological sequence of the first triggering time. The objects in the group are allocated to different duplicated scenes based on the sorting.

A process of allocating the objects in the same group to the duplicated scenes based on the third sorting is similar to the manner of allocating the objects to the duplicated scenes based on the first sorting in the foregoing embodiment, and is described in detail in the foregoing embodiment. Details are not described herein again.

In the embodiment of operations 2610 to 2650, grouping of the 1^{st} time is first performed based on the geographic locations of the objects, then grouping of the 2^{nd} time is performed based on the labels of the objects, and finally the objects in the same group are sorted based on the first triggering time and allocated to the duplicated scenes, to enable the objects in the same duplicated scene to be in the same geographic region and have similar features, so that the session is more easily started. Therefore, an advantage of this embodiment is that a matching degree of the objects in the same duplicated scene is improved, and the object interworking rate of the messaging application is further improved.

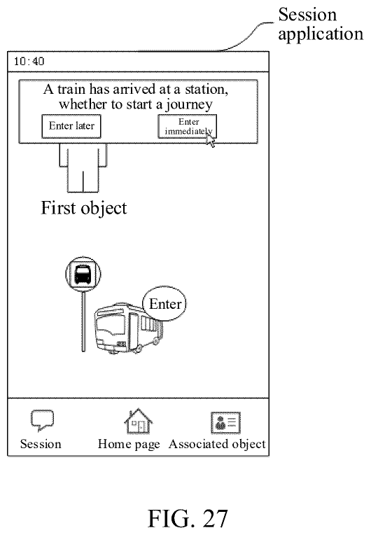

In operation 430, if the first cycle ends and the second cycle starts, it indicates that the target virtual scene is allowed to be entered. In the second cycle, the entry control is always displayed on the interface, and the first object can enter the target virtual scene at any time. As shown in FIG. 27, the train serving as the target virtual scene arriving at the station and the entry control are displayed on the interface of the messaging application. The entry control may be displayed in the target virtual scene in a form of a button, or may be displayed on the interface in a form of a pop-up window.

The second cycle and the first cycle are alternately arranged The second cycle directly starts after the first cycle ends, and the first cycle starts again after the second cycle ends.

In one embodiment, the display the entry control in response to the current time passing to a second cycle includes: displaying the entry control in response to the current time passing to the second cycle, and displaying second remaining duration to an end of the second cycle.

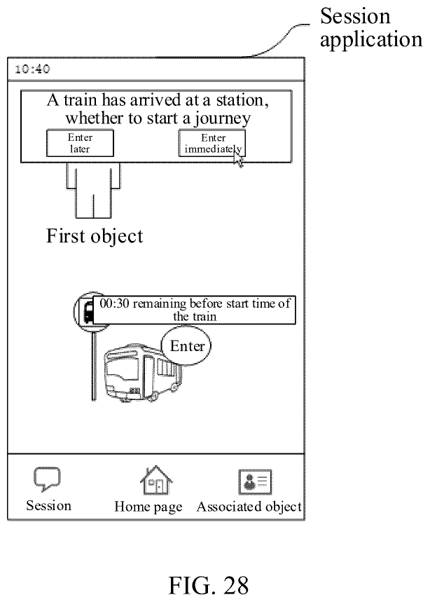

The second remaining duration is duration to the end of the second cycle, and may be understood as running duration of the target virtual scene. For example, as shown in FIG. 28, “00:30 remaining before start time of the train” is displayed on the interface, indicating that 30 seconds remain before the end of the second cycle.

An advantage of displaying the second remaining duration is that the first object can clearly see the remaining duration to the end of the second cycle, to avoid a case in which the first object misses time of entering the target virtual scene because the first object does not know the time, thereby improving accuracy of an operation of the first object in the messaging application.

In the embodiment of operations 410 to 430, when the first object enters the messaging application at different time, different entry controls are displayed, so that the first object intuitively determines a current status of the target virtual scene based on a display status of the control, thereby improving the information transfer efficiency.

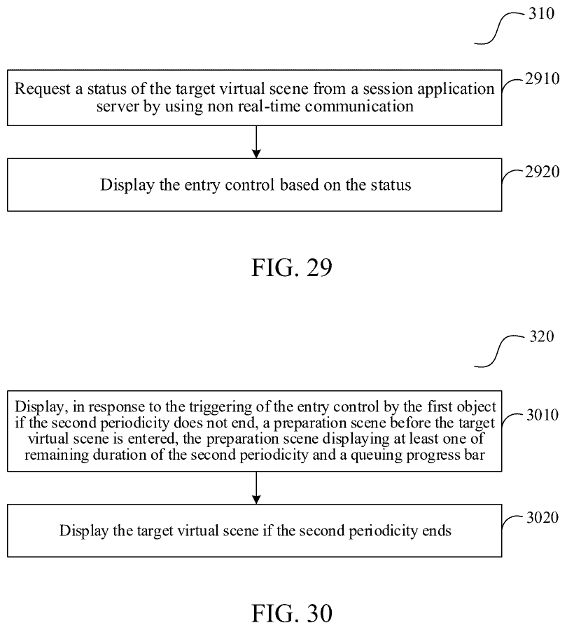

In one embodiment, as shown in FIG. 29, the display an entry control of a target virtual scene includes the following operations.

Operation 2910: Request a status of the target virtual scene from a messaging application server by using non real-time communication.

Operation 2920: Display the entry control based on the status.

When the first object enters the messaging application, the terminal sends, to the server 130, a request for a status of the target virtual scene. After receiving the request for the status of the target virtual scene, the server 130 obtains the status (whether the train serving as the target virtual scene arrives at the station) of the target virtual scene, and sends the status of the target virtual scene to the terminal. The terminal displays the entry control based on different statuses of the target virtual scene.

For example, if the status of the target virtual scene is “Having not arrived at the station”, the target virtual scene is not displayed on the interface, and the entry reservation control is displayed. If the status of the target virtual scene is “Having arrived at the station”, the target virtual scene is displayed on the interface, and the enter control is displayed.

An advantage of requesting the status of the target virtual scene by using the non real-time communication is that information transmission security of obtaining the status of the target virtual scene is improved.

### Detailed Descriptions of Operation 320

In operation 320, the first object enters the target virtual scene after triggering the entry control, and the target virtual scene is displayed on the interface. In the target virtual scene, the first object sees the first virtual object of the first object in the messaging application and the second virtual object of the second object. The second object is an object that is in the messaging application and that has no association relationship with the first object. The first virtual object and the second virtual object may start a session in the target virtual scene.

In the embodiment of operations 410 to 430, the first object may trigger the entry control at any time in the second cycle. Therefore, in one embodiment, as shown in FIG. 30, the display the target virtual scene in the target virtual scene in response to the entry control being triggered by a first object includes the following operations.

Operation 3010: Display, in response to the entry control being triggered by the first object if the second cycle does not end, a preparation scene before the target virtual scene is entered, the preparation scene displaying at least one of remaining duration of the second cycle and a queuing progress bar.

Operation 3020: Display the target virtual scene if the second cycle ends.

If the first object triggers the enter control when the second cycle does not end, the preparation scene is displayed. The preparation scene shows a scene before the target virtual scene is entered, and may be understood as that the object is queuing up to enter the target virtual scene. In the preparation scene, at least one of the remaining duration of the second cycle and the queuing progress bar is further displayed, and the queuing progress bar indicates a ratio of elapsed duration in the second cycle. For example, a length of the second cycle is 30 seconds. When 18 seconds elapses in the second cycle, the ratio on the queuing progress bar is displayed as 60%.

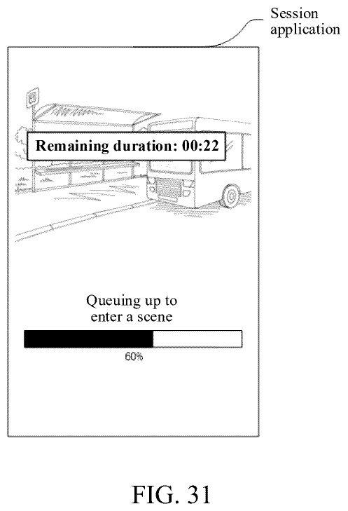

FIG. 31 shows the preparation scene before the target virtual scene is entered. In the preparation scene, 22 seconds remaining before the end of the second cycle and a progress bar of “Queue up to enter the scene” are presented, indicating that 60% of the duration of the second cycle elapses.

An advantage of this embodiment is to intuitively display waiting duration before the target virtual scene is entered, thereby improving the information transfer efficiency.

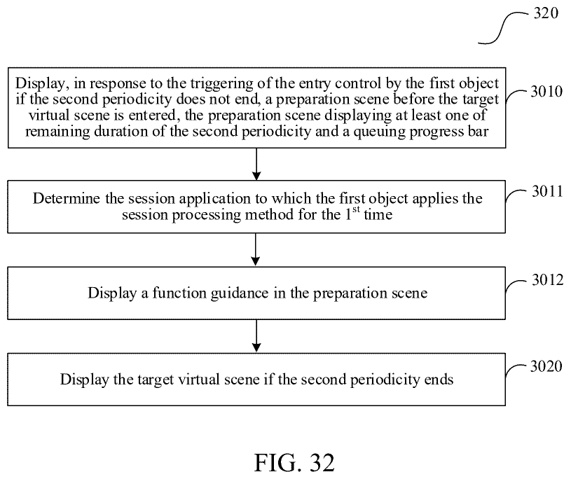

In one embodiment, as shown in FIG. 32, after operation 3010, the session processing method further includes the following operations.

Operation 3011: Determine the messaging application to which the first object applies the session processing method for the 1^{st} time.

Operation 3012: Display a function guidance in the preparation scene.

If the first object uses the messaging application for the 1^{st} time, the first object is unclear about functions that can be provided by the messaging application. Therefore, after it is determined that the first object uses the messaging application for the 1^{st} time, the function guidance is displayed in the preparation scene. The function guidance describes, to the first object using the messaging application for the 1^{st} time, the functions and use rules of the messaging application.

The first object closes the function guidance after viewing the function guidance, and enters the target virtual scene after the remaining duration of the second cycle ends. The function guidance may further be set to be automatically closed. In other words, if the first object does not trigger closing the function guidance within preset duration, the function guidance may be automatically closed. An objective of setting automatic closing is that, if the function guidance is not closed when the remaining duration of the second cycle ends, the first object may be affected in entering the target virtual scene to perform a session with another object.

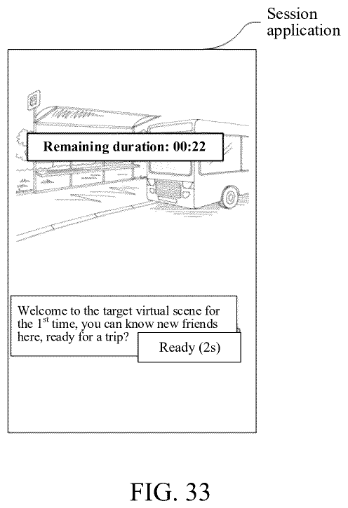

For example, as shown in FIG. 33, the first object uses the messaging application for the 1^{st} time, and a function guidance of “Welcome to the target virtual scene for the 1^{st} time, you can know new friends here, ready for a trip?” is displayed on the interface. Through the function guidance, the first object learns that the first object can perform a session and make a friend with another object after entering the target virtual scene. A button “Ready” is displayed at a lower right corner of the function guidance. When the first object taps “Ready”, the function guidance may be closed, and the first object waits for the end of the second cycle to enter the target virtual scene. After the preset duration is set, the function guidance is automatically closed, and the function guidance presents that two seconds remain before the function guidance is automatically closed.

An advantage of this embodiment is that the functions of the messaging application are introduced, by using the function guidance, to the first object using the messaging application for the 1^{st} time, thereby improving accuracy and operation efficiency of using the messaging application by the object.

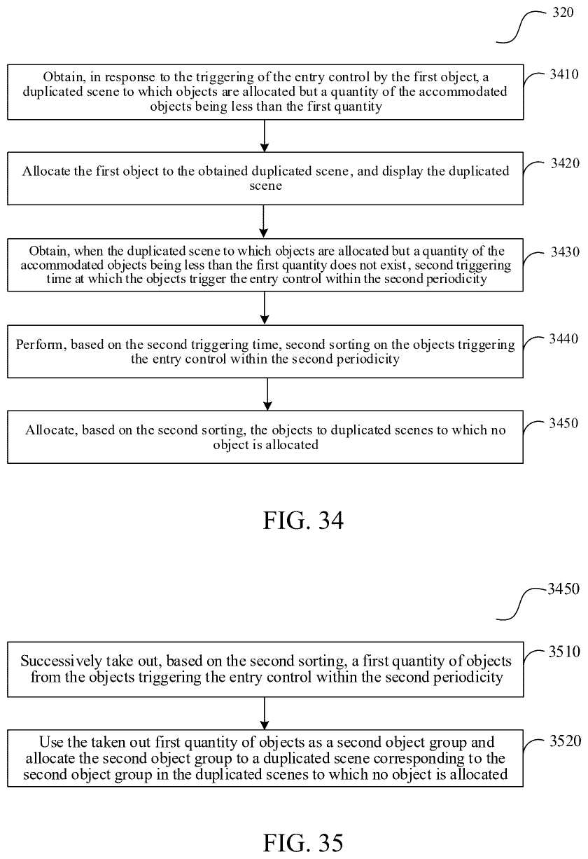

In the embodiment of operations 2510 and 2520, the first quantity of objects are allocated to one duplicated scene. Therefore, in one embodiment, as shown in FIG. 34, the display the target virtual scene in response to the entry control being triggered by a first object includes the following operations.

Operation 3410: Obtain, in response to the entry control being triggered by the first object, a duplicated scene to which objects are allocated but a quantity of the accommodated objects being less than the first quantity.

Operation 3420: Allocate the first object to the obtained duplicated scene, and display the duplicated scene.

Operation 3430: Obtain, when the duplicated scene to which objects are allocated but a quantity of the accommodated objects being less than the first quantity does not exist, second triggering time at which the objects trigger the entry control within the second cycle.

Operation 3440: Perform, based on the second triggering time, second sorting on the objects triggering the entry control within the second cycle.

Operation 3450: Allocate, based on the second sorting, the objects to duplicated scenes to which no object is allocated.

When the time at which the first object enters the messaging application falls within the first cycle, the first object may trigger the entry reservation control. Within the first cycle, the first sorting is performed on the plurality of objects based on the first triggering times at which the plurality of objects trigger the entry reservation control, and the first quantity of objects are successively allocated to one duplicated scene based on the first sorting. However, when allocation is performed based on the objects triggering the entry reservation control within the first cycle, it cannot be ensured that a maximum capacity is reached in each duplicated scene. For example, within the first cycle, 20 objects in total queue up to enter the scene, and the first quantity of each duplicated scene is 6. In this case, quantities of objects in the first three duplicated scenes can reach the first quantity, and only two objects can be allocated to the 4^{th} duplicated scene.

When the first object triggers the entry control within the second cycle, whether the duplicated scene to which objects are allocated but a quantity of the objects not reaching the first quantity exists in the duplicated scenes allocated within the first cycle is determined. If the duplicated scene exists, the first object is allocated to the duplicated scene. If the duplicated scene does not exist, the first object is allocated to a new duplicated scene.

When the objects are allocated to new duplicated scenes, the second triggering time at which the objects trigger the entry control is obtained. The second triggering time refers to time at which an object triggers the entry control. The second sorting is performed, based on a chronological sequence of the second triggering time, on the objects triggering the entry control within the second cycle, and the objects are allocated to different duplicated scenes based on the second sorting.

In one embodiment, as shown in FIG. 35, the allocate, based on the second sorting, the objects to duplicated scenes to which no object is allocated includes the following operations.

Operation 3510: Successively take out, based on the second sorting, a first quantity of objects from the objects triggering the entry control within the second cycle.

Operation 3520: Use the taken out first quantity of objects as a second object group and allocate the second object group to a duplicated scene corresponding to the second object group in the duplicated scenes to which no object is allocated.

A specific process is the same as the process of allocating, based on the first triggering time, the objects to the duplicated scenes to which no object is allocated in the foregoing process, and details are not described herein again.

In the embodiment of operations 3410 to 3450, a duplicated scene with vacancy is first filled up, and then the objects are allocated to the duplicated scenes to which no object is allocated. Therefore, an advantage of this embodiment is that a quantity of objects in a duplicated scene can be remained at the first quantity, to ensure that the first object can have conversations with a plurality of second objects, so that interworking relationships are established, and the object interworking rate of the messaging application is improved.

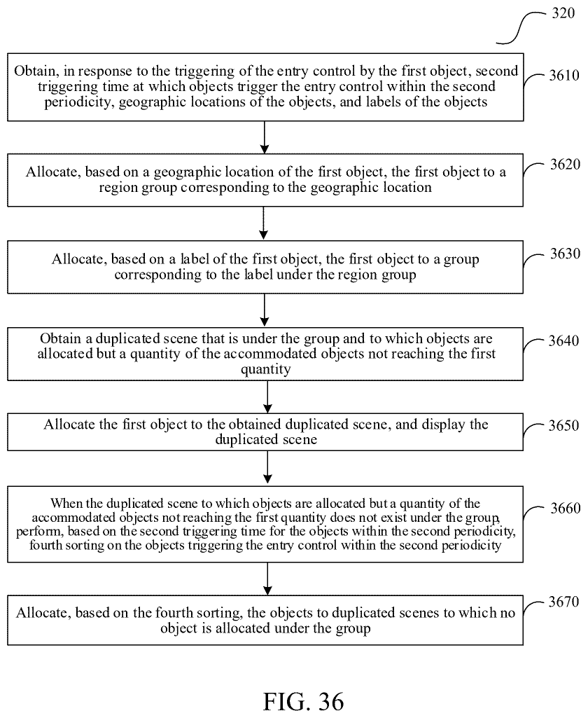

In the embodiment of operations 2610 to 2650, the objects whose geographic locations belong to the same geographic region are grouped into one region group, then the objects in the same region group are divided into the plurality of groups based on the labels of the objects, and the objects in the same group are allocated to the duplicated scenes based on the first triggering time. Therefore, in one embodiment, as shown in FIG. 36, the display the target virtual scene in response to the entry control being triggered by a first object includes the following operations.

Operation 3610: Obtain, in response to the entry control being triggered by the first object, second triggering time at which objects trigger the entry control within the second cycle, geographic locations of the objects, and labels of the objects.

Operation 3620: Allocate, based on a geographic location of the first object, the first object to a region group corresponding to the geographic location.

Operation 3630: Allocate, based on a label of the first object, the first object to a group corresponding to the label under the region group.

Operation 3640: Obtain a duplicated scene that is under the group and to which objects are allocated but a quantity of the accommodated objects not reaching the first quantity.

Operation 3650: Allocate the first object to the obtained duplicated scene, and display the duplicated scene.

Operation 3660: When the duplicated scene to which objects are allocated but a quantity of the accommodated objects not reaching the first quantity does not exist under the group, perform, based on the second triggering time for the objects within the second cycle, fourth sorting on the objects triggering the entry control within the second cycle.

Operation 3670: Allocate, based on the fourth sorting, the objects to duplicated scenes to which no object is allocated under the group.

In this embodiment, in operation 3610, the second triggering time of triggering the entry control, the geographic locations of the objects, and the labels of the objects are obtained. In operation 3620, the objects are divided into the plurality of region groups based on the geographic locations of the objects. In operation 3630, the objects in the same region group are further grouped based on the labels of the objects. Operations 3610 to 3630 are the same as the process of operations 2610 to 2610 in the foregoing embodiment, and details are not described herein again.

In operation 3640, the duplicated scene in which the quantity of objects does not reach a maximum capacity and the objects in the scene are in the same group with the first object. In operation 3650, the first object is allocated to the duplicated scene, and the duplicated scene is displayed for the first object. In operation 3660, if the duplicated scene in which the quantity of objects does not reach the maximum capacity and the objects in the scene are in the same group with the first object does not exist, the fourth sorting is performed on the objects based on a chronological sequence of the second triggering time. In operation 3670, the objects in the same group are allocated to the plurality of duplicated scenes based on the fourth sorting. Operations 3640 to 3670 are similar to operations 3410 to 3450 in the foregoing embodiment, and are described in detail in the foregoing embodiment. Details are not described herein again.

The target virtual scene presents a case in which the first virtual object and the second virtual object simultaneously appear. The target virtual scene is similar to a real scene of a display form of a target virtual train. For example, the display form of the target virtual scene is a train. In this case, after the target virtual scene is entered, the target virtual scene may present a scene in the train, and may include many seats. The first virtual object and the second virtual object may be presented in the target virtual scene in a plurality of presentation states, and may sit on the seats or stand on a vacant ground.

In one embodiment, the display the target virtual scene in response to the entry control being triggered by a first object includes: displaying the first virtual object and the second virtual objects as sitting spaced away in the target virtual scene.

That the first virtual object and the second virtual objects sit at intervals refers to that seats of the first virtual object and the second virtual objects in the target virtual scene in the virtual scene are spaced away. For example, there are four adjacent seats A, B, C, and D in the same row. Two objects separately sit at the seat A and the seat D, and the seat A and the seat D are spaced away by the seat B and the seat C in the middle.

An objective of enabling the objects to sit spaced away is to facilitate adjusting seats when the first virtual object and the second virtual object perform a session in a subsequent process. For example, if the second objects sit at both the seat A and the seat D, the first virtual object may sit at the seat B when performing a session with the second virtual object sitting at the seat A, or may sit at the seat C when performing a session with the second virtual object sitting at the seat D. When two objects are displayed as sitting next to each other in the target virtual scene, it indicates that the two objects are in a session.

Therefore, an advantage of this embodiment is that the first object can intuitively determine, based on a seat condition of the objects in the target virtual scene, whether an object is in a session with another object, to avoid interrupting the session with the another object, thereby improving a real-time property of information transfer on the interface. The first object can further directly select an object whose adjacent seat is empty to perform a session, thereby improving the session efficiency.

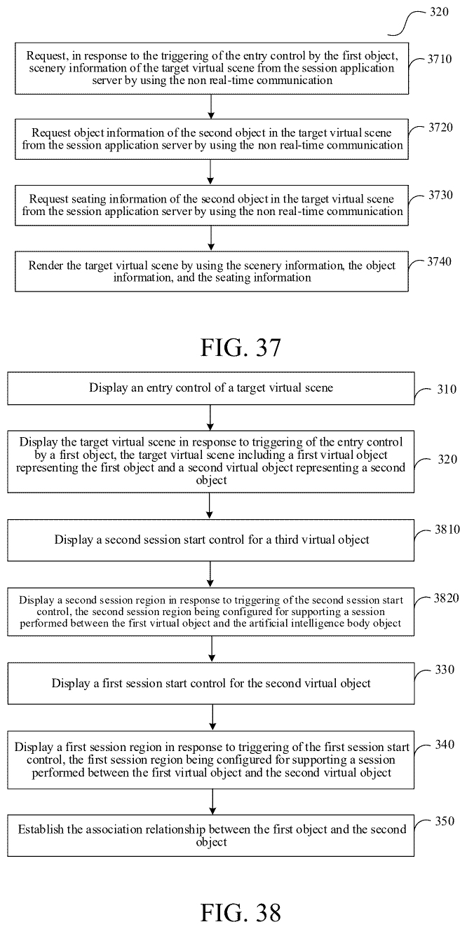

In one embodiment, as shown in FIG. 37, the display the target virtual scene in response to the entry control being triggered by a first object includes the following operations.

Operation 3710: Request, in response to the entry control being triggered by the first object, scenery information of the target virtual scene from the messaging application server by using the non real-time communication.

Operation 3720: Request object information of the second object in the target virtual scene from the messaging application server by using the non real-time communication.

Operation 3730: Request seating information of the second object in the target virtual scene from the messaging application server by using the non real-time communication.

Operation 3740: Render the target virtual scene by using the scenery information, the object information, and the seating information.

A process of generating the target virtual scene is described in detail in this embodiment.

In operation 3710, when the first object triggers the entry control, the object terminal 110 sends a scenery-information request to the server 130. After obtaining data related to the scenery information of the target virtual scene, the server 130 returns the data to the object terminal 110.

In operations 3720 and 3730, after entering the target virtual scene, the first object sends, to the server 130, an establishment request for a real-time communication channel. After the real-time communication channel is established, the first object can see changes of the object information and the seating information in the target virtual scene. For example, when a second object enters the target virtual scene, the second object may be displayed in the target virtual scene in real time through the real-time communication channel. Alternatively, when a seat of an object in the virtual scene changes, the target virtual scene also changes in real time.

In operation 3740, the target virtual scene is rendered after the scenery information, the object information, and the seating information are obtained. Because the object information and the seating information change, when the object information and the seating information are updated through the real-time communication channel, the target virtual scene needs to be rendered again based on updated parts.

An advantage of this embodiment is that different information is obtained in different manners, thereby improving security and efficiency of obtaining the information, and improving accuracy of rendering the target virtual scene.

In one embodiment, the target virtual scene further includes a third virtual object representing an artificial intelligence body object. The third virtual object does not correspond to a real object, and is a virtual object stored in the server 130. Therefore, as shown in FIG. 38, after the target virtual scene is displayed in response to the entry control being triggered by the first object, the session processing method further includes the following operations.

Operation 3810: Display a second session start control for the third virtual object.

Operation 3820: Display a second session region in response to the second session start control being triggered, the second session region being configured for supporting a session performed between the first virtual object and the artificial intelligence body object.

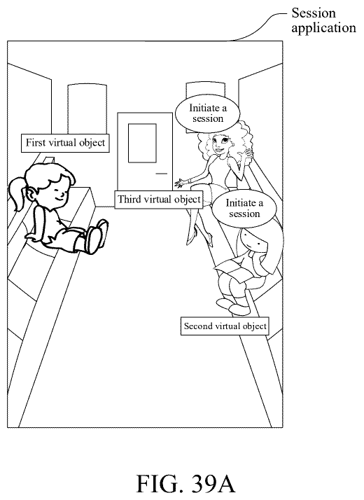

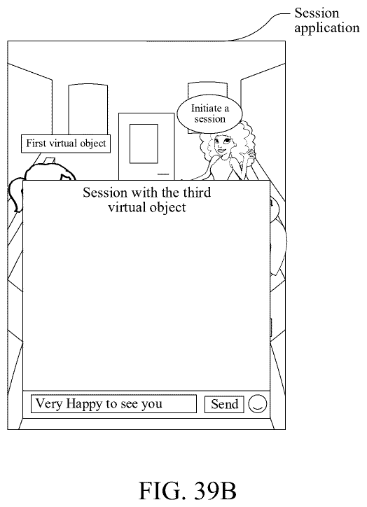

When the target virtual scene includes the third virtual object, the first virtual object may also perform a session with the third virtual object. A second session control that can perform a session with the third virtual object is displayed near the third virtual object. As shown in FIG. 39A, an object that sits in an upper right corner of the virtual scene is the third virtual object, and the second session region supporting a session with the third virtual object may be triggered by tapping “Initiate a session” above the third virtual object.

The second session region with the third virtual object is shown in FIG. 39B, and a session window pops up on the interface. The first object may input a text, an emoticon, or the like in a chat box below, to communicate with the third virtual object.

Because there is no interworking relationship between objects in the target virtual scene, session content between the objects may be tedious, and the objects cannot be attracted to establish an interworking relationship. The third virtual object is usually a well-known hot character, for example, a character in a popular movie. Therefore, joining of the third virtual object may create a session topic for the objects in the target virtual scene, and the third virtual object may be used as a communication bridge to the objects to establish the interworking relationship. Therefore, the object interworking rate of the messaging application can be improved by setting the third virtual object in the target virtual scene.

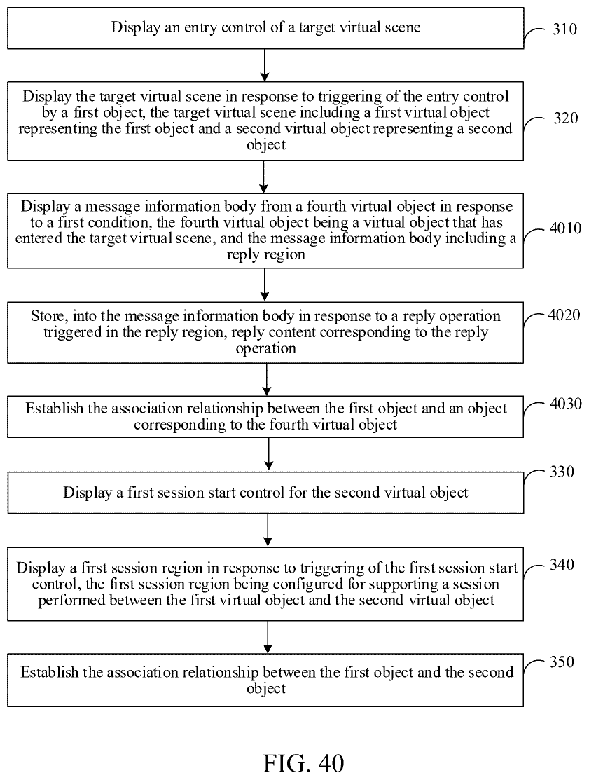

In one embodiment, as shown in FIG. 40, after the target virtual scene is displayed in response to the entry control being triggered by the first object, the session processing method further includes the following operations.

Operation 4010: Display a message information body from a fourth virtual object in response to a first condition, the fourth virtual object being a virtual object that has entered the target virtual scene, and the message information body including a reply region.

Operation 4020: Store, into the message information body in response to a reply operation triggered in the reply region, reply content corresponding to the reply operation.

Operation 4030: Establish the association relationship between the first object and an object corresponding to the fourth virtual object.

In this embodiment, the first condition is a condition of triggering display of the message information body. The fourth virtual object is the virtual object that has entered the target virtual scene before the current time. The message information body is a message left by the fourth virtual object in the target virtual scene. After the message is left, the message information body is generated based on content of the message, to be viewed by a virtual object subsequently entering the target virtual scene. The message information body may have a plurality of presentation forms, for example, a form of a sticky note. In the target virtual scene, an effect that a sticky note is blown down by the wind may be presented, to present content of the sticky note on the interface. For another example, the message information body is in a form of a message book. The message book is expanded in front of the first virtual object, to present content of one page of the message book on the interface.

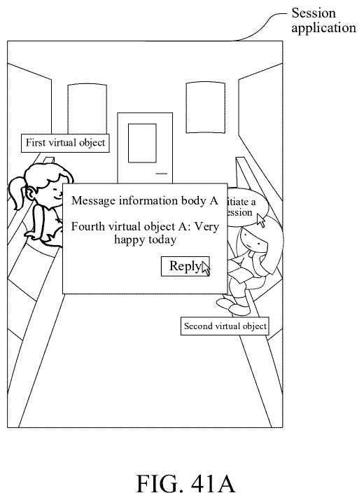

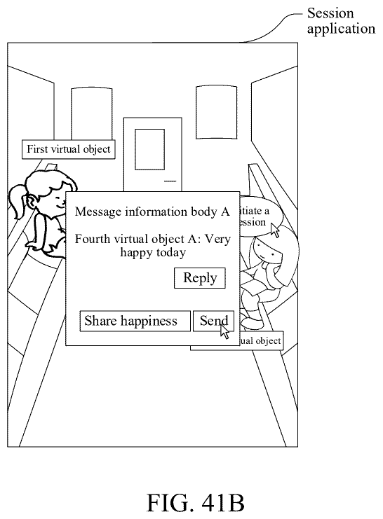

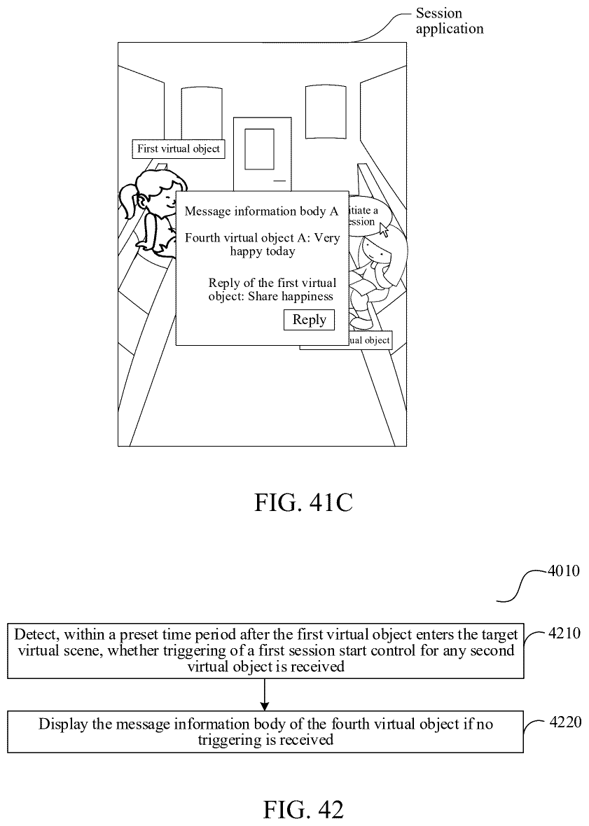

As shown in FIG. 41A, a message information body A is presented on the interface of the messaging application. The message information body is from a fourth virtual object A, and content of the message information body is “Very happy today”. The first virtual object may reply to the message information body. After Reply is tapped, the reply region is displayed in the message information body. As shown in FIG. 41B, a reply box is presented below the message information body. The first object may input reply content in the reply box, and reply to the message after tapping Send.

After the reply is sent, the reply content is reserved and displayed in the message information body. As shown in FIG. 41C, after the reply content is received, the object to which the reply is sent and the reply content are displayed in the message information body. When seeing the message information body, another object may also see the reply content of the first virtual object.

Accordingly, in the foregoing manner, an interaction function of replying to a message is provided for the first virtual object, so that the first virtual object can interact, in a cross-time manner, with the fourth virtual object that has previously entered the target virtual scene. Therefore, objects with which the first virtual object can interact are enriched, and session interaction forms of the first virtual object are enriched.

In one embodiment, as shown in FIG. 42, the display a message information body from a fourth virtual object in response to a first condition includes the following operations.

Operation 4210: Detect, within a preset time period after the first virtual object enters the target virtual scene, whether triggering of a first session start control for any second virtual object is received.

Operation 4220: Display the message information body of the fourth virtual object if no triggering is received.

The preset time period in operation 4210 is duration after the first virtual object enters the target virtual scene. For example, the preset time period is three minutes. In this case, the preset time period ends three minutes after the first virtual object enters the target virtual scene.

In operation 4210, that the first virtual object does not trigger a first session start control for any second virtual object refers to that the first virtual object does not perform a session with any second virtual object, including not actively triggering the first session control, and not passively receiving a session request from the second virtual object.

In this embodiment, the first condition is that the first virtual object does not perform a session with any second virtual object within the preset time period. When it is determined that the preset time period ends, and the first virtual object does not trigger the first session start control for any second virtual object, the first condition is satisfied, and the message information body is displayed to the first virtual object.

Accordingly, in the foregoing manner, when the first virtual object does not perform a session with another second virtual object in the target virtual scene, the message information body previously reserved by the fourth virtual object is presented to the first virtual object, to support the first virtual object in replying to the presented message information body, so that activities of the first virtual object in the target virtual scene can be enriched, and the first virtual object is enabled to obtain better interaction experience in the target virtual scene.

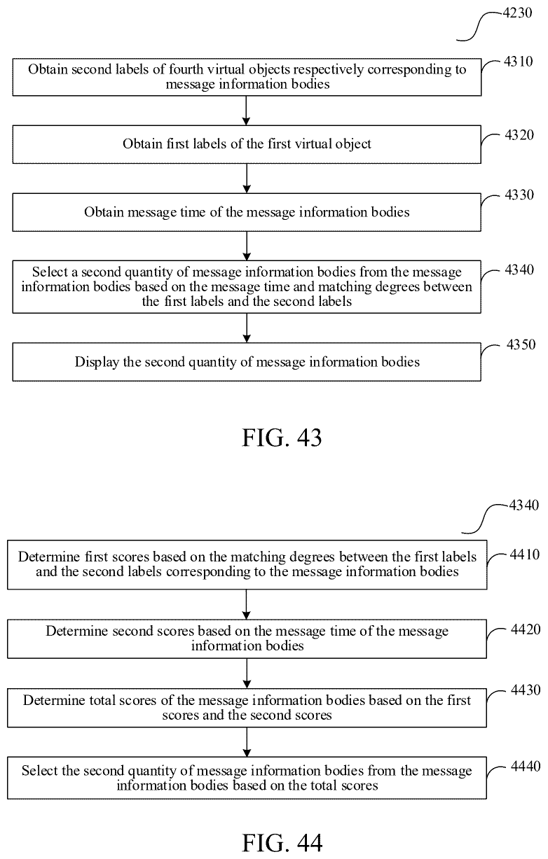

In one embodiment, as shown in FIG. 43, the display a message information body from a fourth virtual object includes the following operations.

Operation 4310: Obtain second labels of fourth virtual objects respectively corresponding to message information bodies.

Operation 4320: Obtain first labels of the first virtual object.

Operation 4330: Obtain message time of the message information bodies.

Operation 4340: Select a second quantity of message information bodies from the message information bodies based on the message time and matching degrees between the first labels and the second labels.

Operation 4350: Display the second quantity of message information bodies.

A quantity of message information bodies displayed to the first virtual object is limited, but a total quantity of message information bodies is very large. Therefore, a preset quantity of message information bodies need to be selected from the large quantity of message information bodies, and displayed to the first virtual object. A process of determining the message information bodies displayed to the first virtual object is described in this embodiment.

The second label of the fourth virtual object is configured for describing a feature of an object corresponding to the fourth virtual object, and the object corresponding to the fourth virtual object is a real object controlling the fourth virtual object. The second label is similar to the first label of the first virtual object in the foregoing embodiment.

Approval of the object corresponding to the fourth virtual object needs to be obtained in advance before the second label of the fourth virtual object is obtained.

The process of obtaining the first label of the first virtual object is described in detail in the foregoing embodiment. A process of obtaining the second label of the fourth virtual object is the same as the process of obtaining the first label of the first virtual object, and details are not described herein again.

The message time of the message information bodies is obtained. The second quantity of message information bodies displayed to the first object are selected based on the message time and the matching degrees between the first labels and the second labels.

In one embodiment, as shown in FIG. 44, the select a second quantity of message information bodies from the message information bodies based on the message time and matching degrees between the first labels and the second labels includes the following operations.

Operation 4410: Determine first scores based on the matching degrees between the first labels and the second labels corresponding to the message information bodies.

Operation 4420: Determine second scores based on the message time of the message information bodies.

Operation 4430: Determine total scores of the message information bodies based on the first scores and the second scores.

Operation 4440: Select the second quantity of message information bodies from the message information bodies based on the total scores.

Because there are a plurality of first labels and a plurality of second labels, the first score may be determined based on a ratio of a quantity of matches between the second labels corresponding to the message information bodies (to be specific, the second labels corresponding to the fourth virtual objects making the message information bodies) and the first labels to a total quantity of first labels.

For example, the second labels corresponding to the message information bodies include “pet”, “student”, “sport”, “workout”, and “game”, and the first labels of the first object include “student”, “cooking”, “sport”, “job seeking”, and “write”. Matching labels between the second labels and the first labels are “student” and “sport”, a quantity of matches is 2, and a quantity of the first labels is 5. Therefore, a ratio of the quantity of matches to the quantity of the first labels is 0.4. A higher ratio indicates a higher matching degree with the first object and a higher first score.

The first score may be determined by using a first-score comparison table based on the ratio of the matches between the second labels and the first labels. Table 2 is an example of the first-score comparison table.

TABLE 2

| Ratio of a quantity of matches | |
|---|---|
| to a quantity of first labels | First score |
| 0.9 to 1 | 100 |
| 0.8 to 0.89 | 90 |
| 0.7 to 0.79 | 80 |
| . . . | |
| 0 to 0.09 | 10 |

Based on Table 2, when the ratio of the quantity of the matches to the quantity of the first labels is 0.4, the first score is 50.

An advantage of determining the first score based on the comparison table is high searching efficiency.

When message time of a message information body is closer to the current time, the first virtual object and the fourth virtual object more easily discuss content of a message in the message information body, and the second score is higher. For example, a message information body generated one hour before the current time more easily attracts the attention of the first object than a message information body generated one week ago. This is because the message information body generated one hour ago may be related to a recently occurred hot event, the message information body generated one week ago may be related to a hot event occurred at that time, and the first object is more easily interested in the recently occurred event.

The second score is determined by using a second-score comparison table based on duration between the message time of the message information bodies and the current time. Table 3 is an example of the second-score comparison table.

TABLE 3

| Duration between message | |
|---|---|
| time and current time | Second score |
| Less than one hour | 100 |
| 1 to 3 hours | 90 |
| 3 to 6 hours | 80 |
| 6 to 10 hours | 70 |
| 10 to 15 hours | 60 |
| 15 to 24 hours | 50 |
| 1 to 2 days | 40 |
| 2 to 4 days | 30 |
| 4 to 7 days | 20 |
| Longer than 7 days | 10 |

Based on Table 3, when the duration between the message time of the message information body and the current time is 5 hours, the second score is 80.

The total score of the message information body may be determined based on the first score and the second score by calculating an average value of the first score and the second score. For example, the first score is 60, and the second score is 70. In this case, the total score of the message information body is (60+70)/2=65. An advantage of determining the total score by using the average value is to ensure that impact of the first score and impact of the second score on calculation of the total score of the message information body is the same, thereby improving fairness of determining the total score.

The total score of the message information body may alternatively be determined based on the first score and the second score by calculating a weighted average of the first score and the second score. In this embodiment, weights need to be respectively set for the first score and the second score, and the weighted average is calculated by using the weights. For example, the weight of the first score is 0.6, the weight of the second score is 0.4, the first score is 60, and the second score is 70. In this case, the total score of the message information body is 0.6*60+0.4*70=64. An advantage of determining the total score by using the weighted average is that the different weights may be assigned to the first score and the second score based on an specific application condition, thereby improving flexibility of determining the total score.

After the total scores of the message information bodies are determined, the message information bodies are ranked in descending order of the total scores of all the message information bodies, and the first second quantity of message information bodies are extracted from the ranking and displayed to the first object.

An advantage of the embodiment of operations 4410 to 4440 is that matching between the first labels and the second labels and the message time are scored, to finally obtain the final scores of the message information bodies, so that calculation efficiency is improved, and it is ensured that the message information bodies presented to the first virtual object are messages in which the first virtual object may be interested, thereby improving an interaction possibility.

After the second quantity of message information bodies are selected, the message information bodies are displayed to the first object.

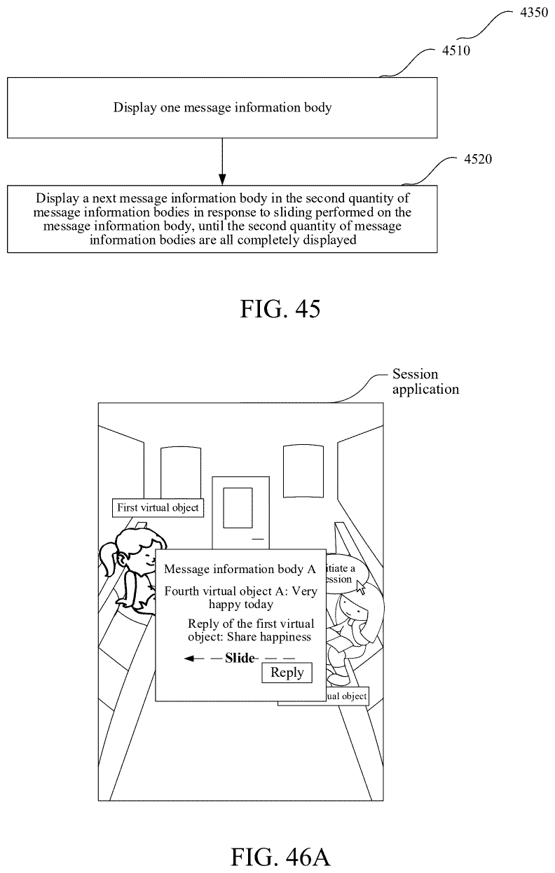

In one embodiment, as shown in FIG. 45, the display the second quantity of message information bodies includes the following operations.

Operation 4510: Display one message information body.

Operation 4520: Display a next message information body in the second quantity of message information bodies in response to sliding performed on the message information body, until the second quantity of message information bodies are all completely displayed.

If the second quantity of message information bodies are simultaneously displayed on the interface, content displayed in each of the message information bodies may be excessively small, affecting viewing by the first object. Therefore, in this embodiment, only one message information body is displayed on the interface. The first object may view content of the message information body and reply.

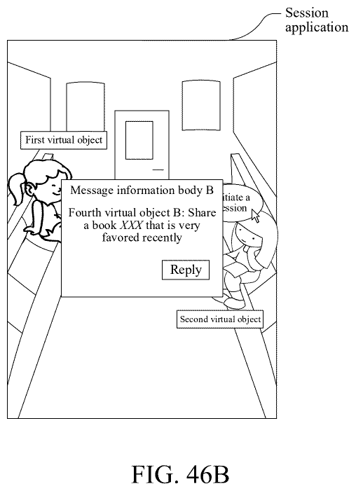

When the first object wants to view the next message information body, the first object may directly slide a window of the message information body, to display the next message information body. A slide direction of sliding the message information body may be any direction. For example, as shown in FIG. 46A, a message information body A is displayed in a current window. After replying to the message information body A, the first object may slide the message information body A to the left. As shown in FIG. 46B, a message information body B is displayed in the window. Similarly, the first object may continue to slide until the second quantity of message information bodies are all completely viewed.

In the foregoing embodiment, the second quantity of message information bodies are determined based on the total scores of the message information bodies. Therefore, a sequence of displaying the second quantity of message information bodies may be based on sorting performed on the total scores, and a message information body with a highest total score is preferentially displayed.

An advantage of successively viewing the message information bodies by using a slide operation is that each of the message information bodies may be successively viewed and replied, thereby avoiding a problem that viewed content is unclear because the plurality of message information bodies are simultaneously arranged and displayed, so that visualization efficiency is improved.

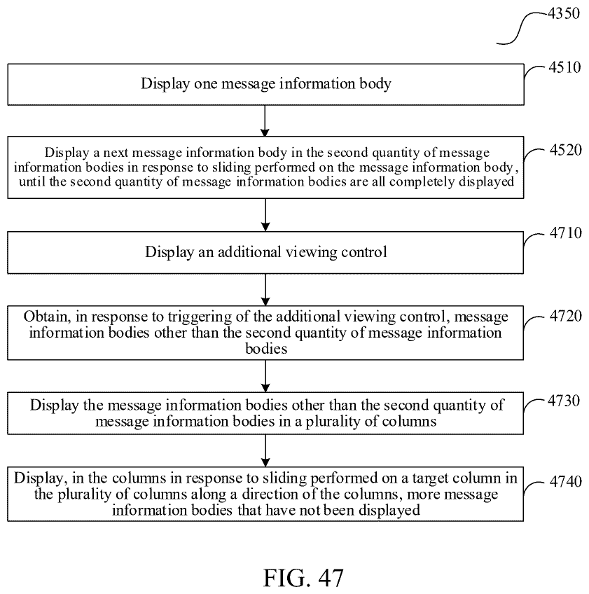

In one embodiment, as shown in FIG. 47, after the display a next message information body in the second quantity of message information bodies in response to sliding performed on the message information body, until the second quantity of message information bodies are all completely displayed, the session processing method further includes the following operations.

Operation 4710: Display an additional viewing control.

Operation 4720: Obtain, in response to the additional viewing control being triggered, message information bodies other than the second quantity of message information bodies.

Operation 4730: Display the message information bodies other than the second quantity of message information bodies in a plurality of columns.

Operation 4740: Display, in the columns in response to sliding performed on a target column in the plurality of columns along a direction of the columns, more message information bodies that have not been displayed.

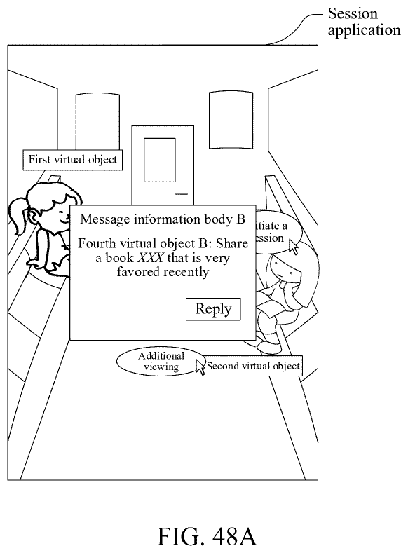

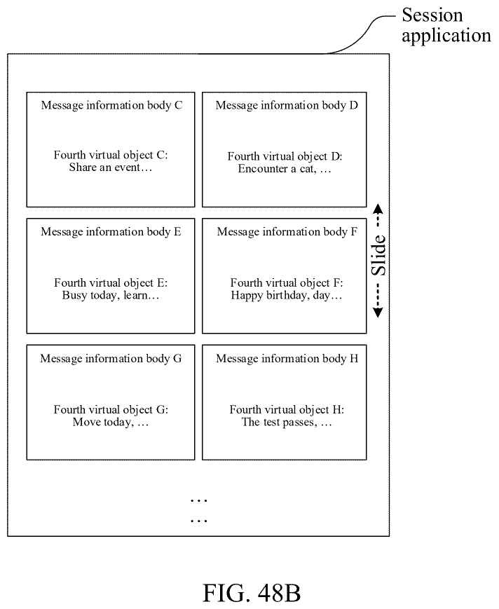

When the first object wants to view more message information bodies, the first object may trigger the additional viewing control. The additional viewing control is configured for displaying more message information bodies. For example, as shown in FIG. 48A, a button “Additional view” is displayed below the message information body.

The message information bodies displayed after the additional viewing control is triggered include all message information bodies generated before the current time except the second quantity of message information bodies displayed to the first object.

The message information bodies other than the second quantity of message information bodies are displayed on the interface in a form of the plurality of columns. For example, as shown in FIG. 48B, the plurality of message information bodies are presented in two columns. Because a quantity of message information bodies that can be presented on the interface is limited, more message information bodies can be displayed by sliding the interface up and down. Because the message information bodies are presented in the plurality of columns, sliding may alternatively be performed on one column along a direction of the column, to display more message information bodies in the column. Another column that is not slid does not move.

Each message information body on an additional viewing interface presents only first preset quantity of words in detailed content of a message, and the remaining of the content is replaced with an ellipsis. An objective of such displaying is to enable each message information body to occupy the same space, so that overall layout is neat, and information search efficiency is improved.

After the first object taps a message information body, a new interface is jumped to and detailed content of the message information body is displayed.

The message information body may further display an avatar of the object corresponding to the fourth virtual object, sending time, and an amount of likes. The first object may perform a like/cancel-like operation on the message information body. Interaction between the first object and the fourth virtual object may be increased through the like operation performed on the message information body, to help establish an association relationship between objects, and improve the object interworking rate.

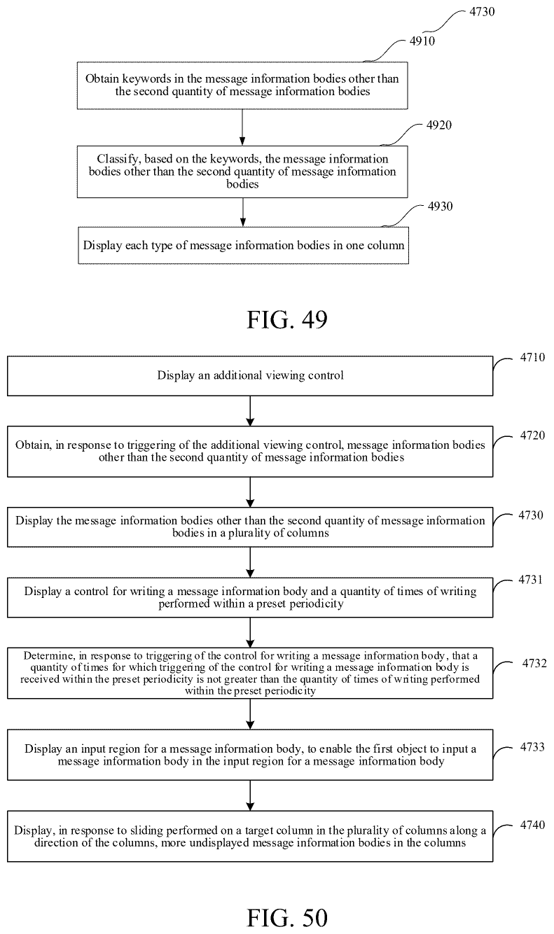

In one embodiment, as shown in FIG. 49, the display the message information bodies other than the second quantity of message information bodies in a plurality of columns includes the following operations.

Operation 4910: Obtain keywords in the message information bodies other than the second quantity of message information bodies.

Operation 4920: Classify, based on the keywords, the message information bodies other than the second quantity of message information bodies.

Operation 4930: Display each type of message information bodies in one column.

The keywords of the message information bodies may be obtained by using a keyword extraction model. The message information bodies are inputted into the keyword extraction model, and the keyword extraction model outputs the keywords of the message information bodies. An advantage of obtaining the keywords by using the keyword extraction model is that accuracy and efficiency of obtaining the keywords are improved.

After the keywords of all the message information bodies are obtained, the keywords of all the message information bodies are input into a lexicon classification model, to classify the keywords. For example, a keyword of a message information body A is “test”, a keyword of a message information body B is “self-study”, and a keyword of a message information body C is “school”. Even though the keywords of the three message information bodies are different, the three message information bodies are related to “study”, and therefore may be classified into one type. An advantage of classifying the message information bodies by using the lexicon classification model is that, even if keywords have different literal meanings, the lexicon classification model can classify message information bodies of the same category into one type, thereby improving accuracy of classifying the message information bodies.

When the message information bodies are displayed, the message information bodies of the same type are displayed in one column, so that the first object can view the message information bodies based on the type.

An advantage of this embodiment is that the message information bodies are classified, so that the first object can quickly see content of a message of a type in which the first object is interested, thereby improving presentation efficiency of the message information bodies.

In one embodiment, as shown in FIG. 50, after the message information bodies other than the second quantity of message information bodies are displayed in the plurality of columns, the session processing method further includes the following operations.

Operation 4731: Display a control for writing a message information body and a quantity of times of writing performed within a preset cycle.

Operation 4732: Determine, in response to the control for writing a message information body being triggered, that a quantity of times for which the control for writing a message information body being triggered is received within the preset cycle is not greater than the quantity of times of writing performed within the preset cycle.

Operation 4733: Display an input region for a message information body, to enable the first object to input a message information body in the input region for a message information body.

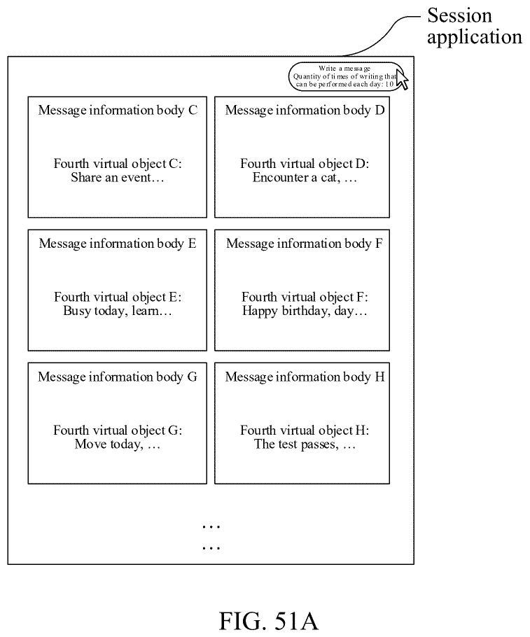

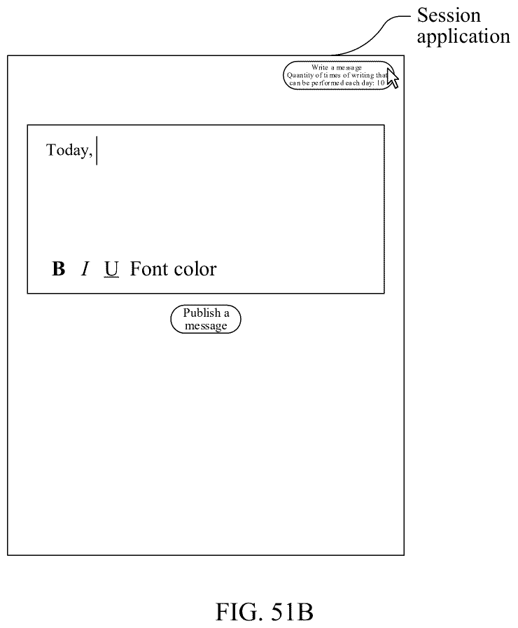

The first object not only can view a message information body published by another object, but also can publish a message information body. The first object may enter an input interface for a message information body by triggering the control for writing a message information body. The quantity of times of writing performed within the preset cycle is a quantity of times for which the first object can write a message information body within the preset cycle. The preset cycle may be one day, one week, one month, or the like. The quantity of times of writing performed within the preset cycle is set in the preset cycle. For example, as shown in FIG. 51A, the control for writing a message information body and the quantity of times of writing performed within the preset cycle are displayed at an upper right corner of the interface. “Write a message” is displayed on the control, and the quantity of times of writing performed within the preset cycle is displayed as “Quantity of times of writing that can be performed each day: 10”, indicating that the preset cycle is one day, and a maximum of ten message information bodies can be written within one day.

Each time the first object triggers the control for writing a message information body once, and completes an operation of writing a message information body once, the server 130 first increases a quantity of triggering times by 1, and then determines whether the quantity of triggering times is greater than the quantity of times of writing performed within the preset cycle. If the quantity of triggering times is greater than the quantity of times of writing performed within the preset cycle, it indicates that the first object has reached a maximum quantity of times of writing a message information body within the preset cycle, and cannot write again. For example, the preset cycle is one day, and the quantity of times of writing performed within the preset cycle is 10. When the first object triggers the control for writing a message information body, a result obtained by increasing the quantity of triggering times by 1 is 11. In this case, the quantity of triggering time is greater than the quantity of times of writing performed within the preset cycle, and the first object cannot write a new message information body again.

If the quantity of triggering times is not greater than the quantity of times of writing performed within the preset cycle, it indicates that there is still a remaining time for the first object to write a new message. The input region for a message information body is displayed on the interface, and the first object can input a message information body in the input region for a message information body. As shown in FIG. 51B, the input region for a message information body further provides controls that can be used by the first object to adjust a format of presenting content of a message, such as a bold font, an oblique font, an underscore, and a font color.

In this embodiment, an objective to set the quantity of times of writing performed within the preset cycle is to increase a quantity of valid message information bodies. Because if a quantity of message information bodies that can be written within the preset cycle is not limited, some objects may create many message information bodies including invalid content, affecting efficiency of performing information transfer by using the message information bodies. Therefore, an advantage of this embodiment is that efficiency of performing information transfer between objects by using a message information body is improved.

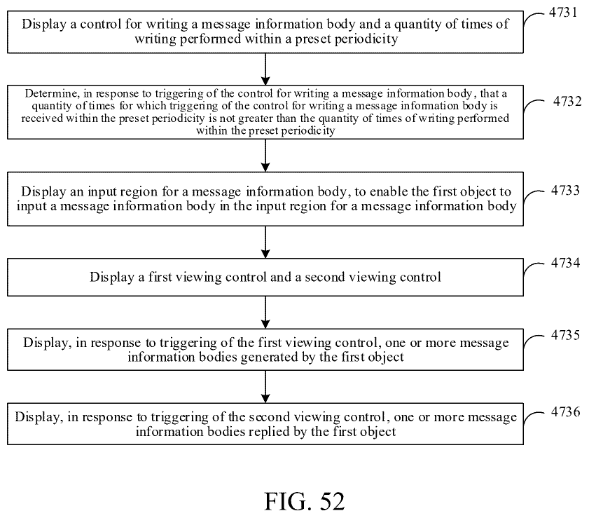

In one embodiment, as shown in FIG. 52, after the display an input region for a message information body, to enable the first object to input a message information body in the input region for a message information body, the session processing method further includes the following operations.

Operation 4734: Display a first viewing control and a second viewing control.

Operation 4735: Display, in response to the first viewing control being triggered, one or more message information bodies generated by the first object.

Operation 4736: Display, in response to the second viewing control being triggered, one or more message information bodies replied by the first object.

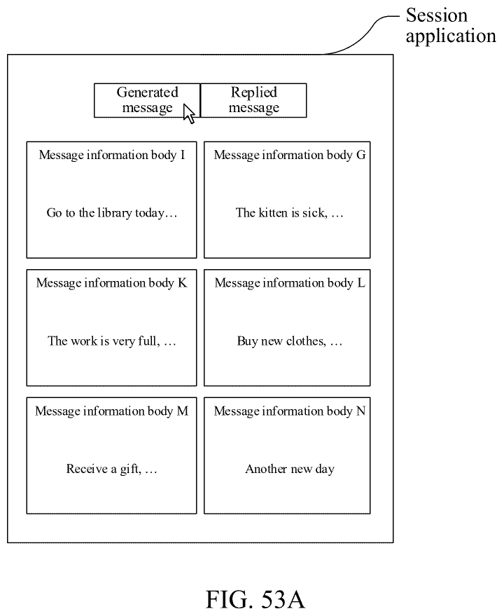

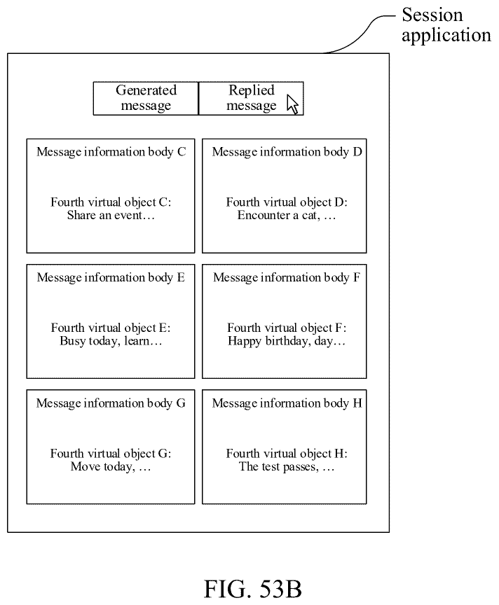

The first viewing control is configured for viewing the one or more message information bodies generated by the first object, and the second viewing control is configured for viewing the one or more message information bodies replied by the first object. As shown in FIG. 53A and FIG. 53B, the first viewing control (“Generated message”) and the second viewing control (“Replied message”) are displayed on an upper part of the interface. After the first viewing control (“Generated message”) is tapped, the one or more message information bodies generated by the first object are displayed. The one or more message information bodies generated by the first object may be displayed in a plurality of columns, and only brief content of each message information body is displayed. When the first object taps a message information body, detailed content of the message information body may be viewed. The one or more message information bodies generated by the first object may be arranged and presented based on generating time. When a generating time of a message information body is closer to the current time, the message information body is displayed at a more front position.

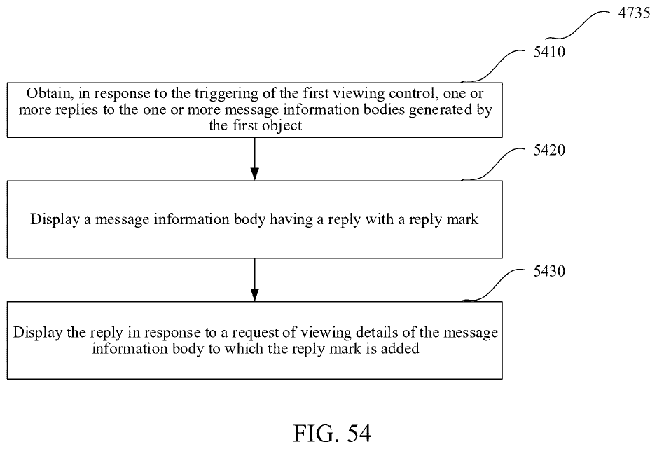

In one embodiment, as shown in FIG. 54, the display, in response to the first viewing control being triggered, one or more message information bodies generated by the first object includes the following operations.

Operation 5410: Obtain, in response to the first viewing control being triggered, one or more replies to the one or more message information bodies generated by the first object.

Operation 5420: Display a message information body having a reply with a reply mark.

Operation 5430: Display the reply in response to a request of viewing details of the message information body to which the reply mark is added.

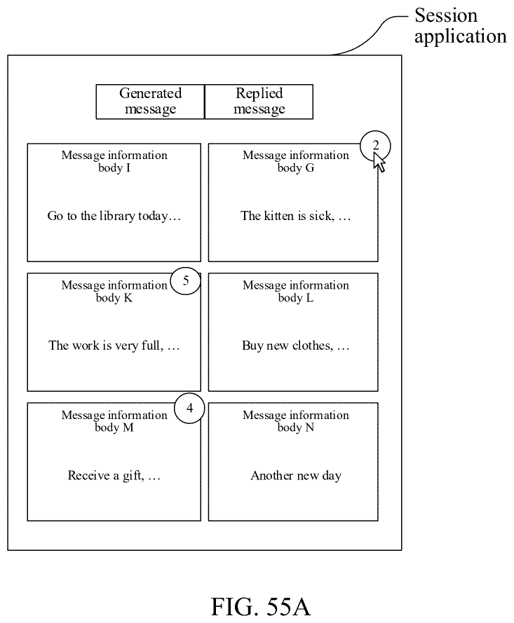

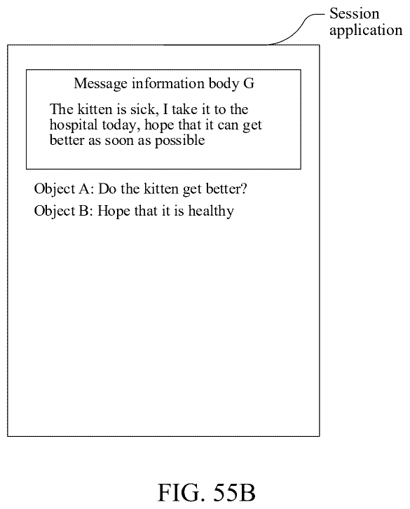

In this embodiment, when viewing the one or more message information bodies generated by the first object, the first object may further see one or more replies of other objects to the one or more message information bodies. If a message information body receives a reply from another object, a reply mark is displayed on the message information body. The reply mark may be a fixed symbol, or may be a numerical mark indicating a quantity of replies to the message information body. For example, as shown in FIG. 55A, a reply mark is displayed at an upper right corner of a message information body having a reply. A message information body G receives two replies, a message information body K receives five replies, and a message information body M receives four replies. The first object can intuitively see the quantity of replies to the message information body based on the numerical mark, so that an amount of information displayed on the interface is increased.

When the first object taps the message information body having the reply mark, detailed content of the message information body and received reply content can be viewed. As shown in FIG. 55B, detailed content of the message information body G is displayed on the interface, and replies of other objects are displayed below the detailed content. The replies of the objects are displayed top-to-bottom in a time sequence of the replies.

An advantage of this embodiment is that the reply mark is displayed for the message information body, so that the message information body for which the reply from the another object is received is intuitively presented. Therefore, the first object can directly view the message information body, thereby improving information processing efficiency of the first object.

After the second viewing control (“Replied message”) is tapped, as shown in FIG. 53B, the one or more message information bodies replied by the first object are displayed. Similar to the one or more message information bodies generated by the first object, the one or more message information bodies replied by the first object may also be presented in a plurality of columns, and brief content is displayed for each message information body. The one or more message information bodies replied by the first object may be arranged and presented based on reply events. When reply time of a message information body is closer to the current event, the message information body is displayed at a more front position.

An advantage of this embodiment is that the one or more message information bodies generated by the first object and the one or more message information bodies replied by the first object are arranged and displayed, so that it is convenient for the first object to view content of performing interaction with other objects by using the message information bodies, to help the first object establish association relationships with the other objects by using the message information bodies, and improve the object interworking rate of the messaging application.

An advantage of the embodiment of operations 4710 to 4730 is that, in addition to the second quantity of message information bodies, more message information bodies can be viewed, thereby improving a quantity of presented message information bodies. Therefore, the first object can establish association relationships with more fourth virtual objects by using the message information bodies, thereby improving the object interworking rate of the messaging application.

An advantage of the embodiment of operations 4310 to 4350 is that a message information body pushed to the first object is selected based on the matching degree between each message information body and the first object and the message time, so that a reply rate of the first object for the message information bodies is improved, to help the first object establish an association relationship with the fourth virtual object, and improve the object interworking rate of the messaging application.

In the embodiment of operations 4210 to 4230, when the first object does not perform a session with another object within duration after entering the scene, a message information body is pushed to the first object, in other words, a means of establishing association relationships with more objects is provided for the first object. Therefore, an advantage of this embodiment is that the first object is promoted to communicate with another object, to establish the association relationship, thereby improving the object interworking rate of the messaging application.

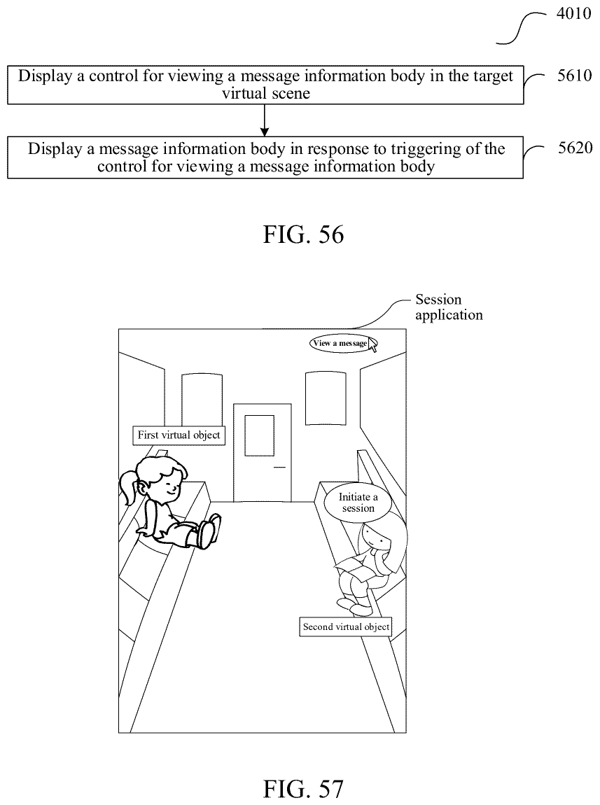

In another embodiment, as shown in FIG. 56, the display, in response to a first condition, a message information body from a fourth virtual object that has entered the target virtual scene includes the following operations.

Operation 5610: Display a control for viewing a message information body in the target virtual scene.

Operation 5620: Display a message information body in response to the control for viewing a message information body being triggered.

In the foregoing embodiment, the message information body may be viewed after the first condition is satisfied. However, in this embodiment, the control for viewing a message information body is displayed in the target virtual scene. As shown in FIG. 57, “View a message” is displayed at an upper right corner of the target virtual scene. The first object can view a message information body in the target virtual scene at any time by triggering the control for viewing a message information body.

After the first object triggers the control for viewing a message information body, the displayed message information body may be selected by the server 130 from all message information bodies for the first object, or may be all the message information bodies. A process of displaying the message information body is described in detail in the foregoing embodiment, and details are not described herein again.

An advantage of this embodiment is that the first object can view the message information body at any time, thereby improving flexibility that the first object selects to establish an association relationship with another object.

When the first virtual object replies to the message information body published by the fourth virtual object, an association relationship may be established between the first virtual object and the fourth virtual object. A specific process of establishing the association relationship is described in detail in subsequent operations.

An advantage of the embodiment of operations 4010 to 4030 is that objects not in the same target virtual scene can also communicate by using the message information body, so that a session range is expanded, and the object interworking rate of the messaging application is improved.

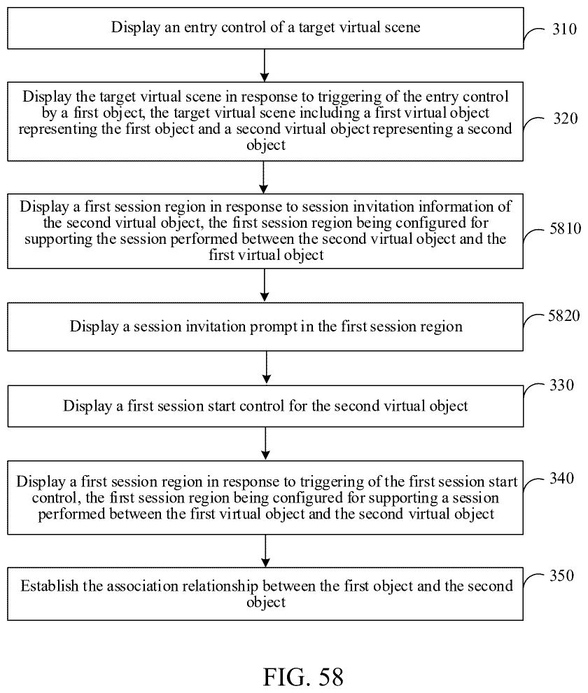

In one embodiment, as shown in FIG. 58, after the target virtual scene is displayed in response to the entry control being triggered by the first object, the session processing method further includes the following operations.

Operation 5810: Display a first session region in response to session invitation information of the second virtual object, the first session region being configured for supporting the session performed between the second virtual object and the first virtual object.

Operation 5820: Display a session invitation prompt in the first session region.

In addition to that the first virtual object initiates a session request to the second virtual object, in this embodiment, the first virtual object may alternatively receive a session invitation from the second virtual object. A manner in which the second virtual object initiates the session invitation to the first virtual object may be tapping a session initiation control, tapping a seat near the first virtual object (indicating that the second virtual object sits adjacently to the first virtual object), or the like.

After the second virtual object initiates the session invitation to the first virtual object, the first session region with the second virtual object is displayed in the target virtual scene viewed by the first virtual object. The first session region is configured for supporting the session performed between the second virtual object and the first virtual object. In the first session region, a piece of prompt information also pops up, configured for indicating the second virtual object initiating the session request.

An advantage of this embodiment is that, when receiving the session request from the second virtual object, the first virtual object can quickly view session content of the second virtual object, thereby improving the session efficiency.

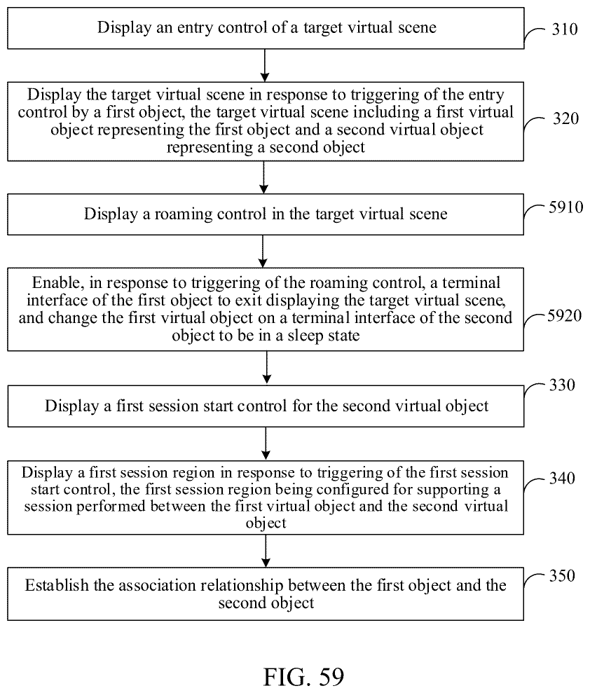

In one embodiment, as shown in FIG. 59, after the target virtual scene is displayed in response to the entry control being triggered by the first object, the session processing method further includes the following operations.

Operation 5910: Display a roaming control in the target virtual scene.

Operation 5920: Enable, in response to the roaming control being triggered, a terminal interface of the first object to exit displaying the target virtual scene, and change the first virtual object on a terminal interface of the second object to be in a sleep state.

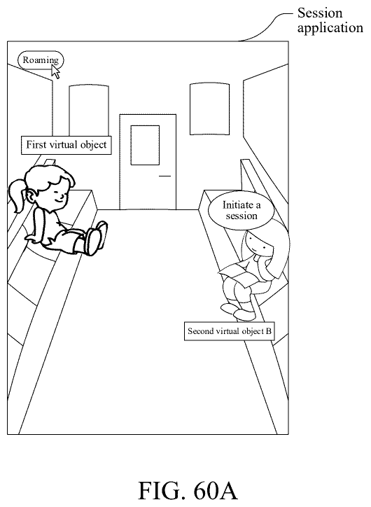

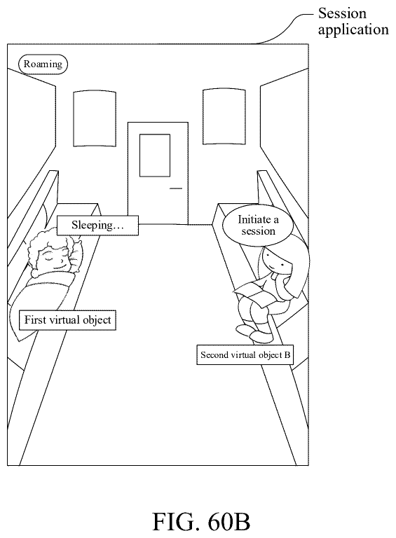

An objective of triggering the roaming control by the first object is that the first object does not want to exit the target virtual scene, but further needs to open another interface. The another interface may be in the messaging application, or may be an interface of another application on the object terminal 110. As shown in FIG. 60A, the roaming control is displayed at an upper left corner of the target virtual scene.

After the first object triggers the roaming control, the terminal interface of the first object exits displaying the target virtual scene, and displays another interface. The first virtual object is displayed in the sleep state on the terminal interface of the second object corresponding to the second virtual object in the target virtual scene. As shown in FIG. 60B, the second virtual object sees that a presentation status of the first virtual object changes to lying down, and a current status of the first virtual object is prompted as “Sleeping . . . ”.

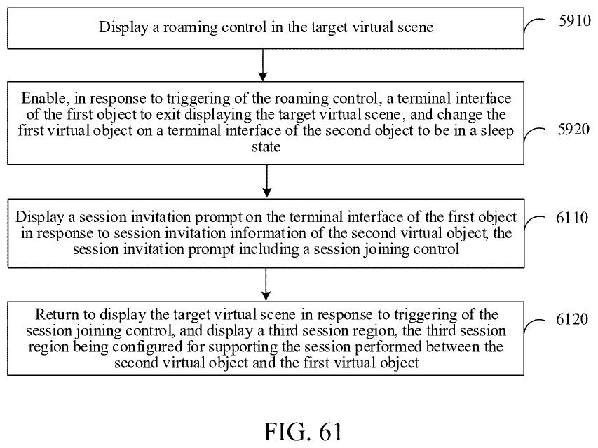

In one embodiment, as shown in FIG. 61, after the terminal interface of the first object is enabled, in response to the roaming control being triggered, to exit displaying the target virtual scene, and the first virtual object on the terminal interface of the second object is changed to be in the sleep state, the session processing method further includes the following operations.

Operation 6110: Display a session invitation prompt on the terminal interface of the first object in response to session invitation information of the second virtual object, the session invitation prompt including a session joining control.

Operation 6120: Return to display the target virtual scene in response to the session joining control being triggered, and display a third session region, the third session region being configured for supporting the session performed between the second virtual object and the first virtual object.

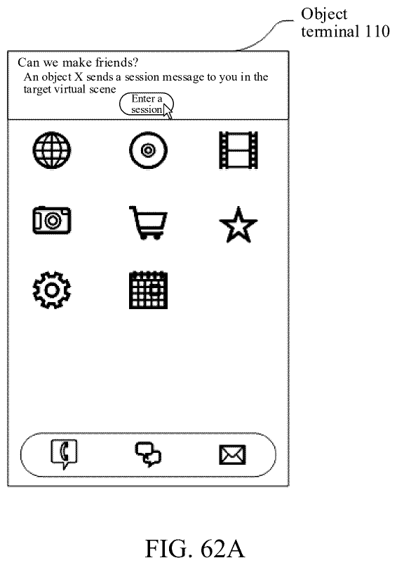

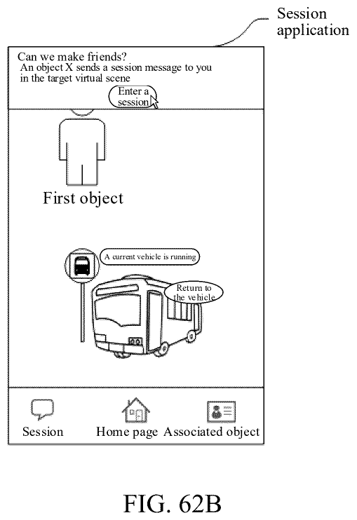

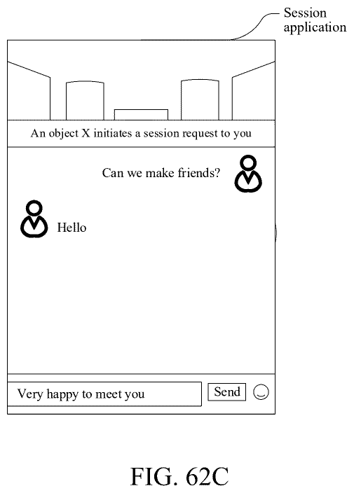

After a roaming mode is entered, the first virtual object is still displayed in the target virtual scene. Therefore, the second virtual object in the target virtual scene may further initiate a session invitation to the first virtual object. The first virtual object can also see, on another interface, the session invitation prompt from the second virtual object. For example, as shown in FIG. 62A, the session invitation prompt indicating that the second virtual object initiates the session invitation information to the first virtual object pops up on the interface of the object terminal 110. For another example, as shown in FIG. 62B, when the first object is on another interface of the messaging application, the session invitation prompt also pops up. Message content, an identifier of the second virtual object initiating the session invitation, and the session joining control are displayed in the session invitation prompt.

As shown in FIG. 62C, when the first object taps the session joining control, the first object may directly return to the target virtual scene, and the third session region including the second virtual object initiating the session invitation and the first virtual object is displayed. When the first object returns to the target virtual scene, the first virtual object exits the sleep state.

An advantage of this embodiment is that, when viewing another interface, the first object can also receive he session invitation prompt from the second object, and can also quickly return to the target virtual scene by using the session invitation prompt, thereby improving the session efficiency of the messaging application.

An advantage of the embodiment of operation 5910 and operation 5920 is that, even if the first object is in the target virtual scene, the first object can also process an event on another interface, so that flexibility of the messaging application is improved. When the first object exits the target virtual scene, the sleep state of the first object can be intuitively displayed on the terminal interface of the second object, so that the information transfer efficiency of the messaging application is improved, and it is convenient for the second object to quickly know a current status of the first object, and determine, based on the status, whether to initiate a session to the first object.

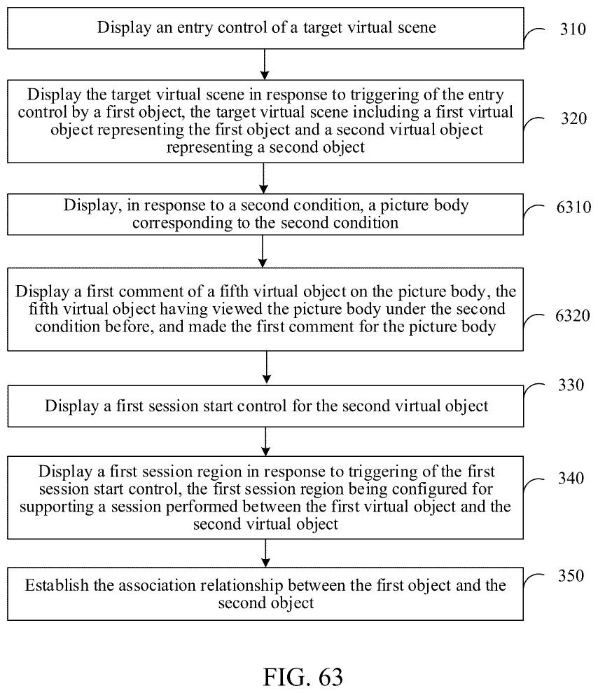

In one embodiment, as shown in FIG. 63, after the target virtual scene is displayed in response to the entry control being triggered by the first object, the session processing method further includes the following operations.

Operation 6310: Display, in response to a second condition, a picture body corresponding to the second condition.

Operation 6320: Display a first comment of a fifth virtual object on the picture body, the fifth virtual object having viewed the picture body under the second condition before, and made the first comment for the picture body.

In a running process of the target virtual scene, if the second condition is triggered, the picture body corresponding to the second condition may be displayed on the interface of the target virtual scene. The second condition may be:
the train serving as the target virtual scene arriving at a preset station;
a virtual environment in which the train serving as the target virtual scene is located changing; or
preset content occurring in the session content between the first virtual object and the second virtual object.

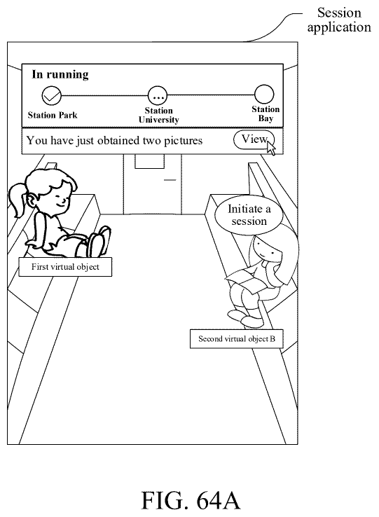

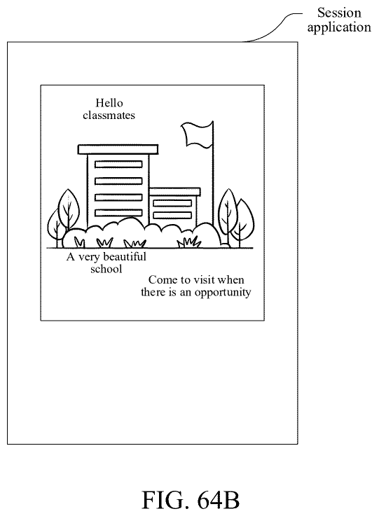

For example, as shown in FIG. 64A, the train serving as the target virtual scene is running, and train content displays a running route of the train. It can be learned from the running route that a next station of the train is a “Station university”. If the second condition is “Be to reach the Station university”, the first object receives two pictures. The first object may tap “View”, to display the picture body corresponding to the second condition. As shown in FIG. 64B, a picture body corresponding to “Station university” is displayed. A first comment made by the fifth virtual object that has viewed the picture body after triggering the second condition is further displayed on the picture body, for example, “A very beautiful school” or “Come to visit when there is an opportunity”.

When a plurality of picture bodies are displayed, the plurality of picture bodies may be simultaneously displayed on the interface. Alternatively, the picture bodies may be successively presented. After the first object views a picture body, a next picture body may be displayed by sliding the picture or triggering a control for viewing a next picture.

A manner of displaying the first comment may be displaying the first comment on the picture body though scrolling in a preset direction, or successively displaying the first comment layer by layer below the picture body based on publishing time.

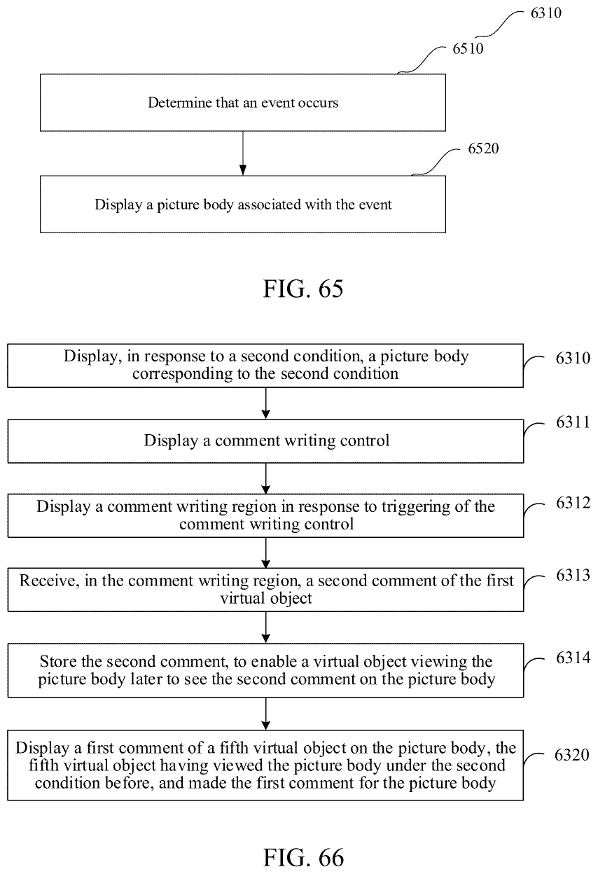

In one embodiment, the picture body is associated with an event during running of the target virtual scene. As shown in FIG. 65, the display, in response to a second condition, a picture body corresponding to the second condition includes the following operations.

Operation 6510: Determine that an event occurs.

Operation 6520: Display a picture body associated with the event.

In this embodiment, when an event occurs during running of the target virtual scene, a picture body associated with the event is displayed. For example, when the train serving as the target virtual scene arrives at a station Yangtze River, a picture of a scenery of the Yangtze River is displayed. When snowing starts outside the train serving as the target virtual scene, a snowing picture or the like is displayed.

An advantage of this embodiment is that both the first object and the second object in the target virtual scene can see the picture body associated with the occurred event, to provide a topic for the session between the objects, improve the session efficiency between the objects, and facilitate establishing the association relationship between the objects, thereby improving the object interworking rate of the messaging application.

In one embodiment, as shown in FIG. 66, after the picture body corresponding to the second condition is displayed in response to the second condition, the session processing method further includes the following operations.

Operation 6311: Display a comment writing control.

Operation 6312: Display a comment writing region in response to the comment writing control being triggered.

Operation 6313: Receive, in the comment writing region, a second comment of the first virtual object.

Operation 6314: Store the second comment, to enable a virtual object viewing the picture body later to see the second comment on the picture body.

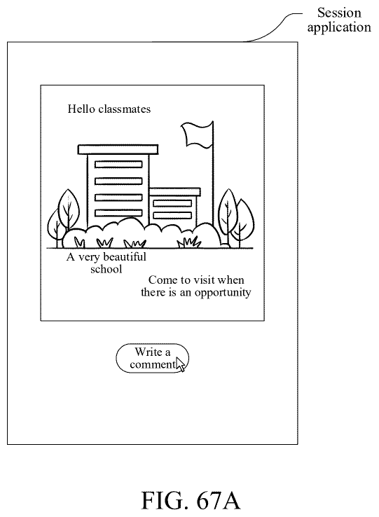

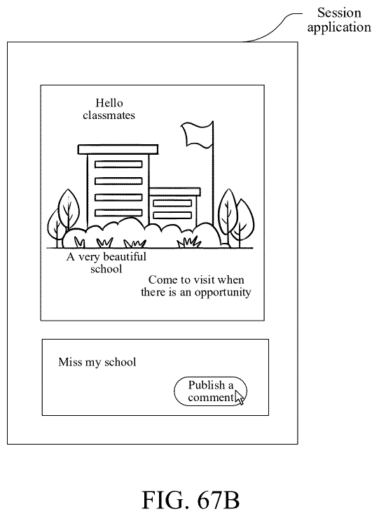

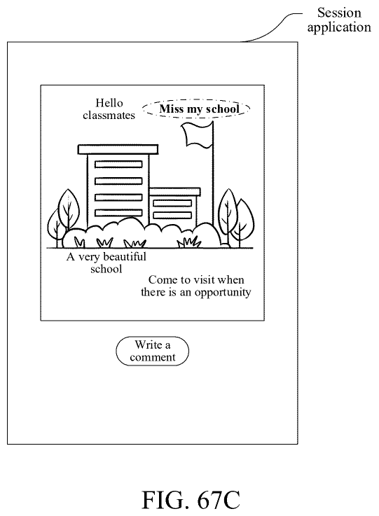

When the picture body is displayed, the comment writing control is further displayed on the interface. As shown in FIG. 67A, “Write a comment” is displayed below the picture body. The comment writing region is displayed after the comment writing control is triggered. As shown in FIG. 67B, an input box is displayed. The first object may input, in the input box, the second comment for the picture body. After completing inputting the second comment, the first object taps “Publish a comment”. The second comment inputted by the first object is stored. When viewing the picture body, the first object or another object can see the second comment published by the first object. As shown in FIG. 67C, a second comment “Miss my school” is displayed on the picture body.

An advantage of this embodiment is that the first object can asynchronously communicate with the fifth virtual object by using the comment, thereby improving flexibility of establishing an association relationship between object in the messaging application.

An advantage of the embodiment of operations 6310 and 6320 is that the first object may know more other objects by using the picture body, thereby improving universality of establishing an association relationship between objects.

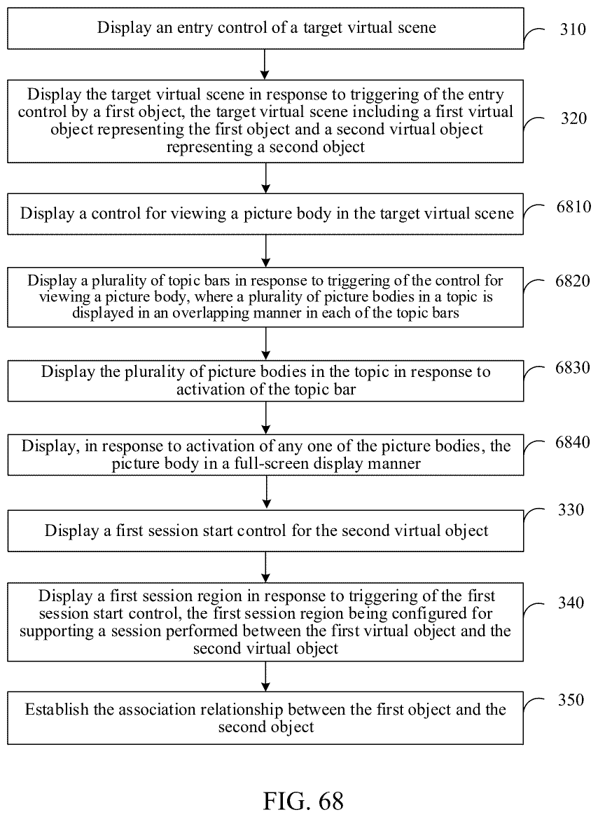

Based on the embodiment of displaying the picture body to the first object, in one embodiment, as shown in FIG. 68, after the target virtual scene is displayed in response to the entry control being triggered by the first object, the session processing method further includes the following operations.

Operation 6810: Display a control for viewing a picture body in the target virtual scene.

Operation 6820: Display a plurality of topic bars in response to the control for viewing a picture body being triggered, where a plurality of picture bodies in a topic is displayed in an overlapping manner in each of the topic bars.

Operation 6830: Display the plurality of picture bodies in the topic in response to activation of the topic bar.

Operation 6840: Display, in response to activation of any one of the picture bodies, the picture body in a full-screen display manner.

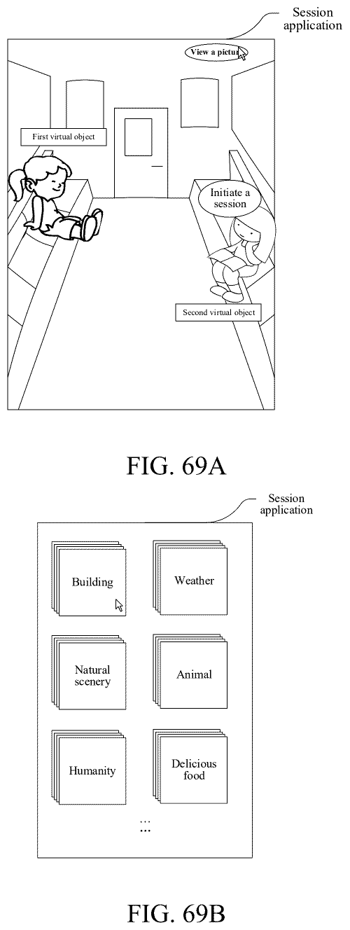

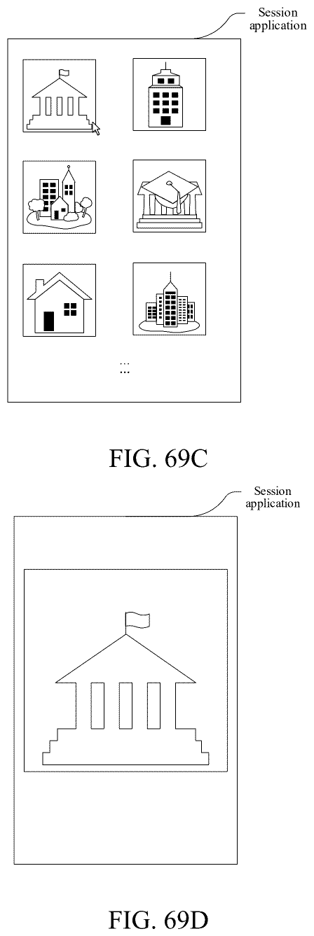

In the foregoing embodiment, the first object can see the picture body after satisfying the second condition. However, in this embodiment, the first object may see, in the target virtual scene by triggering the control for viewing a picture body, picture bodies corresponding to all second conditions that have been satisfied by the first object. As shown in FIG. 69A, the control for viewing a picture body is displayed at an upper right corner of the target virtual scene.

After the control for viewing a picture body is triggered, the plurality of topic bars are displayed, each of the topic bars including the plurality of picture bodies related to the topic. For example, as shown in FIG. 69B, a plurality of topic bars are presented on the interface, including: Building, Weather, Natural scenery, Animal, and the like. Picture bodies in the topic Building are all related to buildings, and the rest can be deduced by analogy. The picture bodies in each of the topic bars are displayed in the overlapping manner.

After one of the topic bars is selected, thumbnails of all picture bodies included in the topic bar are displayed on the interface. For example, as shown in FIG. 69C, after the topic bar “Building” is opened, a plurality of picture bodies related to buildings are presented on the interface.

If the first object is interested in any one of the picture bodies, the first object may activate the picture body. After the picture body is activated, the picture body is displayed on the interface in full screen. In other words, the interface presents only one picture body in detail. For example, as shown in FIG. 69D, after one picture body is selected, only this picture body is presented on the interface. When the picture body is presented in full screen, a comment received for the picture body may also be displayed.

An advantage of this embodiment is that the first object can view, in the target virtual scene, a picture body that has been displayed, so that the first object views content interacting with another object through the picture body, thereby improving an amount of information displayed in the messaging application and efficiency of obtaining information by an object.

### Detailed Descriptions of Operation 330 and Operation 340

In operation 330, the first session start control for the second virtual object is displayed. The first session start control is configured for initiating a session invitation to the second virtual object.

A display form of the first session start control may be a button of “Initiate a session”, a button for prompting the first virtual object to sit near the second virtual object, or the like.

After the first session start control is triggered, the first session region is displayed on a first scene interface. The first virtual object may perform an instant session with the second virtual object in the first session region.

In the foregoing embodiment, the first virtual object and the second virtual objects sit spaced away in the target virtual scene. Therefore, in one embodiment, the display a first session region in response to the first session start control being triggered for the second virtual object includes: displaying the first session region in response to the first session start control being triggered for the second virtual object, and controlling the first virtual object to sit in a seat adjacent to the second virtual object.

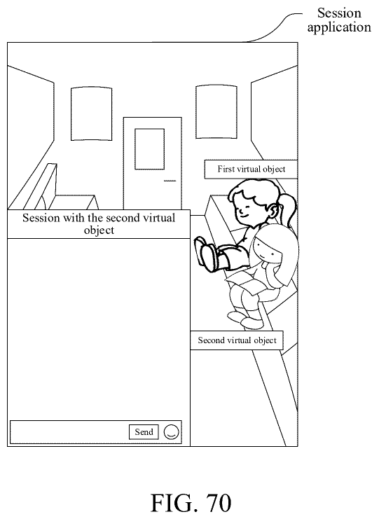

In this embodiment, as shown in FIG. 70, when the first session start control is triggered, that the first virtual object sits in the seat adjacent to the second virtual object, and the first session region are displayed in the target virtual scene. The first virtual object and the second virtual object are displayed as adjacently sitting on a terminal interface of another object, indicating that the two objects are in a session.

An advantage of this embodiment is the same as the advantage of the foregoing embodiment, and details are not described herein again.

In one embodiment, rendering code respectively corresponding to the entry control, the first session start control, and the first session region is generated by using a terminal local code tool of the first object, and rendering code of the target virtual scene is generated by using an online code tool.

The terminal local code tool of the first object can enable a rendering result to match the object terminal 110, so that when the first object triggers the entry control, the first session start control, and the first session region, triggering efficiency is improved. A result of rendering performed by using the terminal local code tool of the first object can only be used in the messaging application of the first object.

The online code tool refers to a universal tool whose rendering result is applicable to messaging applications of a plurality of objects. A part that does not need the first object to perform an operation, for example, the target virtual scene or a map, may be rendered by using the online code tool.

Therefore, the display an entry control of a target virtual scene includes: invoking the rendering code of the entry control by using the terminal local code tool of the first object, to render the entry control.

The display the target virtual scene includes: invoking the rendering code of the target virtual scene by using the online code tool, to render the target virtual scene.

The display a first session start control for the second virtual object includes: invoking the rendering code of the first session start control by using the terminal local code tool of the first object, to render the first session start control.

The display a first session region includes: invoking the rendering code of the first session region by using the terminal local code tool of the first object, to render the first session region.

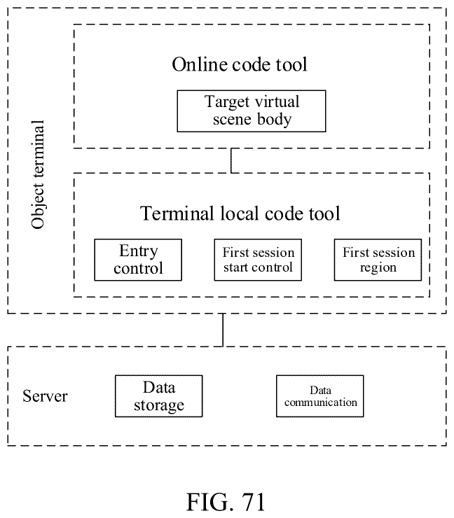

As shown in FIG. 71, for content displayed in the object terminal 110, the target virtual scene is displayed after the online code tool invokes the rendering code of the target virtual scene and performs rendering, and the entry control, the first session start control, and the first session region are displayed after the terminal local code tool invokes the rendering code of the corresponding parts and performs rendering. The rendering code of the entry control, the rendering code of the target virtual scene, the rendering code of the first session start control, and the rendering code of the first session region are stored in the server 130, and code of a corresponding part is invoked through a data communication channel between the server 130 and the object terminal 110.

An advantage of this embodiment is that rendering is performed for different display content by using different tools, the terminal local code tool is used to improve operation efficiency of using the messaging application by the first object, and the online code tool is used to reduce an amount of code stored in the server 130, thereby saving code storage space, and improving invoking efficiency.

### Detailed Descriptions of Operation 350

In operation 350, the association relationship is established between the first object and the second object corresponding to the second virtual object that has performed a session with the first object.

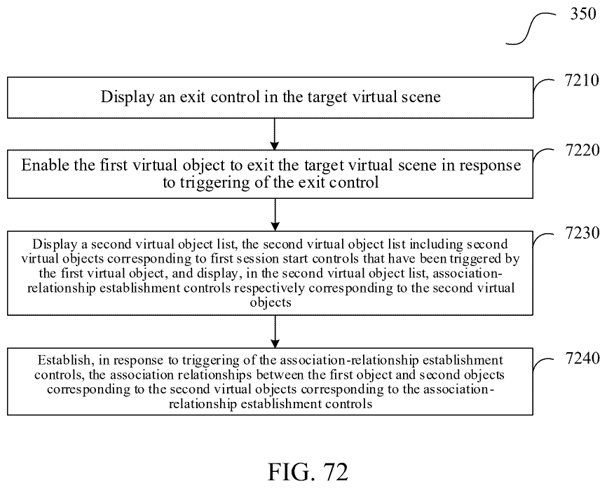

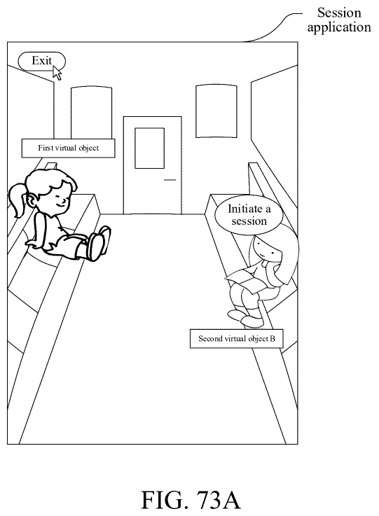

In one embodiment, as shown in FIG. 72, the establish the association relationship between the first object and the second object includes the following operations.

Operation 7210: Display an exit control in the target virtual scene.

Operation 7220: Enable the first virtual object to exit the target virtual scene in response to the exit control being triggered.

Operation 7230: Display a second virtual object list, the second virtual object list including second virtual objects corresponding to first session start controls that have been triggered by the first virtual object, and display, in the second virtual object list, association-relationship establishment controls respectively corresponding to the second virtual objects.

Operation 7240: Establish, in response to the association-relationship establishment controls being triggered, the association relationships between the first object and second objects corresponding to the second virtual objects corresponding to the association-relationship establishment controls.

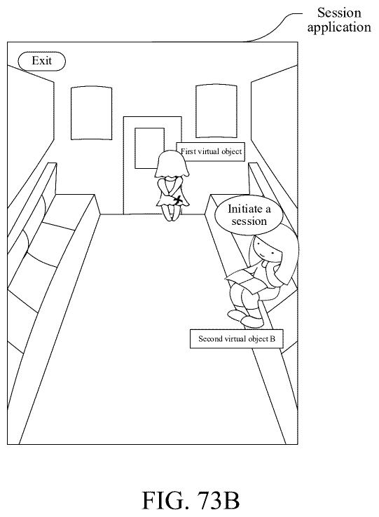

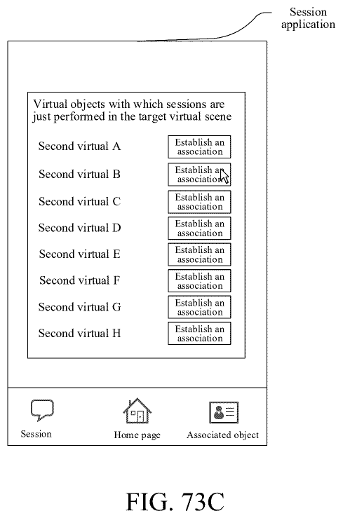

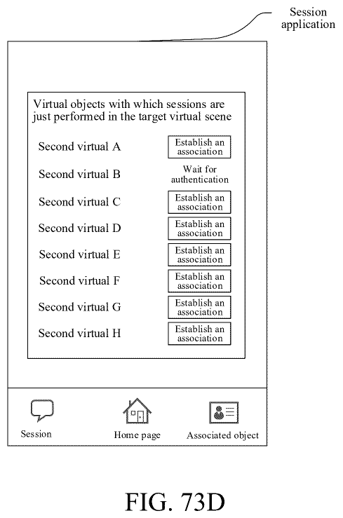

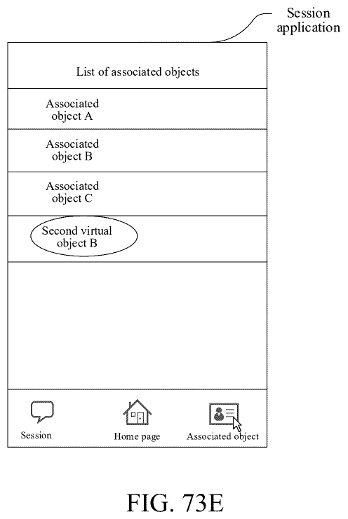

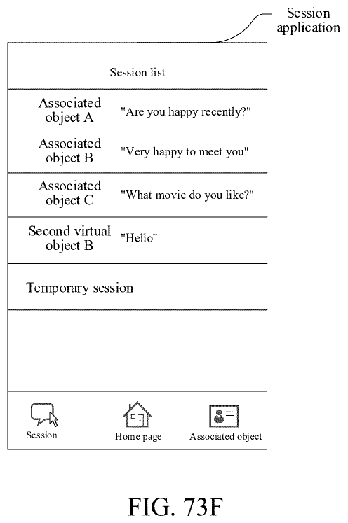

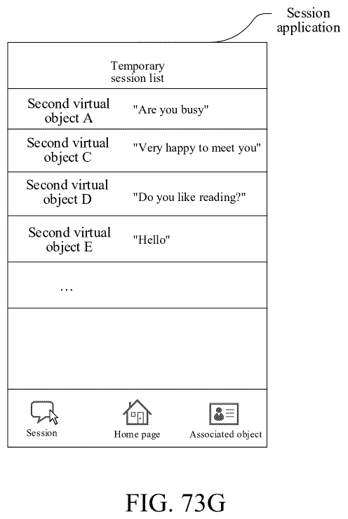

When the first object wants to leave the target virtual scene, the first object may trigger the exit control. As shown in FIG. 73A, a button “Exit” is displayed at an upper left corner of the interface of the target virtual scene.

After the first object triggers the exit control, on the interface viewed by the first object, the first virtual object directly exits the target virtual scene. If the train serving as the target virtual scene arrives at a station when the exit control is triggered, the first virtual object directly disappears from the target virtual scene on the interface viewed by the second object. However, if the train serving as the target virtual scene does not arrive at a station when the exit control is triggered, on the interface viewed by the second object, the first virtual object is displayed in the target virtual scene in a state of waiting to leave the scene until the train serving as the target virtual scene arrives at the station, and the first virtual object disappears from the target virtual scene. As shown in FIG. 73B, the target virtual scene does not arrive at a station, and the first virtual object stands at a door of the virtual scene and waits to leave the scene. When the second object sees that the first virtual object is in the state of waiting to leave the scene, it indicates that the first object has left the target virtual scene. In this case, the second object cannot perform a session with the first virtual object.

After the first virtual object exits the target virtual scene, the list of the second virtual objects that has performed sessions with the first virtual object in the target virtual scene is displayed on the interface. The first object may trigger the association-relationship establishment controls corresponding to the second virtual objects, to send association-relationship establishment requests to the corresponding second objects. The second objects receiving the association-relationship establishment requests may determine whether to establish association relationships with the first object. As shown in FIG. 73C, each of the second virtual objects in the list has a corresponding association-relationship establishment control. After the first object triggers an association-relationship establishment control corresponding to a second virtual object B, the list is displayed as shown in FIG. 73D, and the association-relationship establishment control changes to “Wait for authentication”.

In the foregoing embodiment, the first virtual object may further establish the association relationship with the fourth virtual object corresponding to the message information body that has been replied by the first virtual object. Based on this embodiment, after the first virtual object exits the target virtual scene, the fourth virtual object corresponding to the message information body that has been replied by the first virtual object further appears in the list. The first virtual object may select to initiate an association-relationship establishment request to the fourth virtual object.

After the second object passes the association-relationship establishment request, the association relationship is established between the first object corresponding to the first virtual object and the second object corresponding to the second virtual object. As shown in FIG. 73E, the second virtual object B (configured for representing a corresponding second object) appears in the list of the associated objects of the first object. In this case, even if not in the target virtual scene, the first object and the second object corresponding to the second virtual object B can perform an instant session. As shown in FIG. 73F, brief content of the session performed between the first object and the second object corresponding to the second virtual object B is displayed in a session list. After the first object taps the brief content, a session region with the second object corresponding to the second virtual object B may be displayed. The session list further includes a temporary session list. The temporary session list records session content between the first virtual object and a second virtual object that has performed a session with the first virtual object in the target virtual scene. As shown in FIG. 73G, even if the first object exits the target virtual scene, the first object can view, by using a temporary session, session content with a second virtual object to which an association relationship is not established. After the association relationship is established between the first virtual object and the second virtual object, the content of the temporary session with the second virtual object is moved out of the temporary session list and is added to the session list.

In this embodiment, after exiting the target virtual scene, the first virtual object initiates the association-relationship establishment request to the second object corresponding to the second virtual object. The association relationship between the first object corresponding to the first virtual object and the second object corresponding to the second virtual object is established only after the second object agrees with the association-relationship establishment request, thereby improving security of establishing the association relationship between the objects.

Diagram of Implementation Details of the Session Processing Method of the Embodiments of this Application

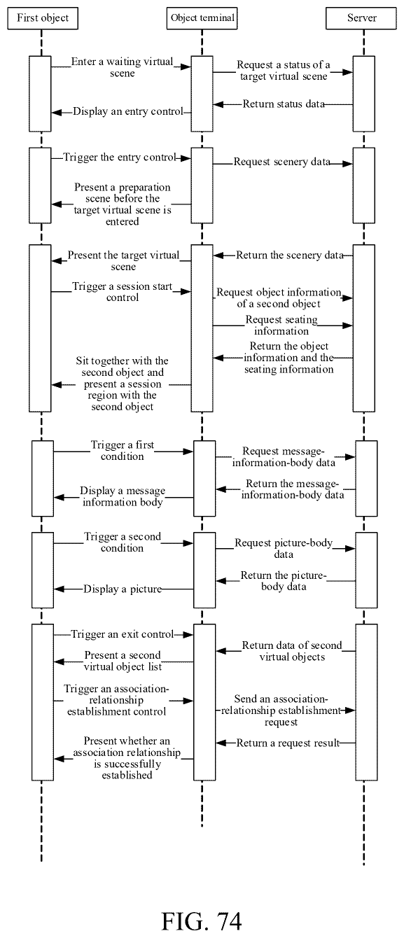

The implementation details of the session processing method of the embodiments of this application are described in detail by using an example with reference to FIG. 74 below.

After the first object enters the waiting virtual scene, the object terminal 110 sends, to the server 130, a request for a status of the target virtual scene. The server 130 invokes the status of the target virtual scene and then returns status data to the object terminal 110. The object terminal 110 renders the scene based on the status data, and displays the scene to the first object.

The first object triggers the entry control, the object terminal 110 sends, to the server 130, a request for scenery data of the virtual scene, and the object terminal 110 displays, to the first object, the preparation scene before the target virtual scene is entered. The server 130 invokes the scenery data, and returns the scenery data to the object terminal 110. After rendering a scenery of the virtual scene, the object terminal 110 displays the target virtual scene to the first object.

The first object triggers the session start control for the second virtual object corresponding to the second object. The object terminal 110 sends, to the server 130, an instruction of obtaining the object information and the seating information of the second object. After invoking the object information and the seating information of the second object, the server 130 returns the object information and the seating information to the object terminal 110. The object terminal 110 displays, to the first object, a scene in which the first object and second object sit next to each other and the session region.

The object terminal 110 requests message-information-body data from the server 130 when the first virtual object satisfies the first condition. After screening the message information bodies, the server 130 returns the message information body to the object terminal 110. The object terminal 110 displays the message information body to the first object.

The object terminal 110 requests picture-body data from the server 130 when the first virtual object satisfies the second condition. After invoking the picture-body data corresponding to the second condition, the server 130 returns the picture body to the object terminal 110. The object terminal 110 displays the picture body to the first object.

When the first object triggers the exit control, the server 130 returns, to the object terminal 110, data of the second virtual object that has performed a session with the first object in the target virtual scene. The object terminal 110 displays a second virtual object list. The first object triggers the association-relationship establishment control for the second object corresponding to the second virtual object. The object terminal 110 sends the association-relationship establishment request to the server 130. The server 130 sends the association-relationship establishment request to the object terminal 110 of the second virtual object, and returns, after receiving a request result, the request result to the object terminal 110. The object terminal 110 presents, to the first object, whether the association relationship is successfully established.

Descriptions of an Apparatus and a Device of the Embodiments of this Application

Although the steps in the flowchart are sequentially shown according to indication of an arrow, the steps are not necessarily sequentially performed according to a sequence indicated by the arrow. Unless explicitly specified in this embodiment, a sequence of performing the operations is not strictly limited, and the operations may be performed in another sequence. In addition, at least a part of the operations in the flowcharts may include a plurality of operations or a plurality of stages. These operations or stages are not necessarily performed simultaneously, but may be performed at different time. These operations or stages are not necessarily performed sequentially, but may be performed in turn or alternately with other operations or at least a part of operations or stages in the other operations.

In each specific implementation of this application, when related processing needs to be performed based on data related to a characteristic of task content, such as attribute information of the task content or an attribute information set, permission or approval on the task content is first obtained, and use, processing, and the like of the data comply with related laws, regulations, and standards. In addition, in this embodiment of this application, when the attribute information of the task content needs to be obtained, independent permission or independent approval of the task content may be obtained in a manner such as a pop-up window or jumping to a confirmation page. After the independent permission or independent approval of the task content is clearly obtained, necessary data related to the task content for enabling this embodiment of this application to run normally is obtained.

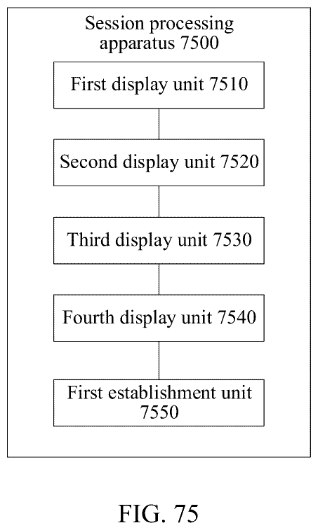

FIG. 75 is a schematic diagram of a structure of a session processing apparatus 7500 according to an embodiment of this application. The session processing apparatus 7500 includes:
a first display unit 7510, configured to display an entry control of a target virtual scene;
a second display unit 7520, configured to display the target virtual scene in response to the entry control being triggered by a first object, the target virtual scene including a first virtual object representing the first object and a second virtual object representing a second object, and there being no association relationship between the second object and the first object;
a third display unit 7530, configured to display a first session start control for the second virtual object;
a fourth display unit 7540, configured to display a first session region in response to the first session start control being triggered, the first session region being configured for supporting a session performed between the first virtual object and the second virtual object; and
a first establishment unit 7550, configured to establish the association relationship between the first object and the second object.

In one embodiment, the target virtual scene further includes a third virtual object representing an artificial intelligence body object.

The session processing apparatus 7500 further includes:
a fifth display unit (not shown), configured to display a second session start control for the third virtual object; and
a sixth display unit (not shown), configured to display a second session region in response to the second session start control being triggered, the second session region being configured for supporting a session performed between the first virtual object and the artificial intelligence body object.

In one embodiment, the session processing apparatus 7500 further includes:
a seventh display unit (not shown), configured to display a message information body from a fourth virtual object in response to a first condition, the fourth virtual object being a virtual object that has entered the target virtual scene, and the message information body including a reply region;
a storage unit (not shown), configured to store, into the message information body in response to a reply operation triggered in the reply region, reply content corresponding to the reply operation; and
a second establishment unit (not shown), configured to establish the association relationship between the first object and an object corresponding to the fourth virtual object.

In one embodiment, the seventh display unit (not shown) is specifically configured to:
display the message information body of the fourth virtual object if no triggering of a first session start control for any second virtual object is received within a preset time period after the first virtual object enters the target virtual scene.

In one embodiment, the seventh display unit (not shown) is specifically configured to:
obtain second labels of fourth virtual objects respectively corresponding to message information bodies;
obtain first labels of the first virtual object;
obtain message time of the message information bodies;
select a second quantity of message information bodies from the message information bodies based on the message time and matching degrees between the first labels and the second labels; and
display the second quantity of message information bodies.

In one embodiment, the first display unit 7510 is specifically configured to:
display an entry reservation control of the target virtual scene in a first state in response to current time falling within a first cycle, the first cycle being a cycle in which the target virtual scene is not allowed to be entered;
display the entry reservation control in a second state in response to the entry reservation control being triggered, the second state being different from the first state; and
display the entry control in response to the current time passing to a second cycle, the second cycle being a cycle in which the target virtual scene is allowed to be entered, and the first cycle and the second cycle being alternately arranged.

In one embodiment, the target virtual scene includes a plurality of duplicated scenes of the target virtual scene.

The first display unit 7510 is further configured to:
obtain first triggering time at which objects trigger the entry reservation control within the first cycle, the objects including the first object and the second object;
perform, based on the first triggering time, first sorting on the objects triggering the entry reservation control within the first cycle; and
allocate the objects to the duplicated scenes based on the first sorting.

In one embodiment, the session processing apparatus 7500 further includes:
an eighth display unit (not shown), configured to display a waiting-scene entry control;
a ninth display unit (not shown), configured to display a waiting virtual scene in response to the waiting-scene entry control being triggered by the first object, the waiting virtual scene being a scene for waiting to enter the target virtual scene;
a first obtaining unit (not shown), configured to obtain contact information of the first object; and
a tenth display unit (not shown), configured to use, as a sixth virtual object, a contact currently using a messaging application in contacts indicated by the contact information, and display the sixth virtual object in the waiting virtual scene, the session processing method being applied to the messaging application.

In one embodiment, the session processing apparatus 7500 further includes:
an eleventh display unit (not shown), configured to display a map entry control;
a twelfth display unit (not shown), configured to display an electronic map in response to the map entry control being triggered by the first object;
a second obtaining unit (not shown), configured to obtain a geographic location of the first object in response to a virtual-scene locating control being triggered in the electronic map, and enable the electronic map to include the geographic location of the first object;
a third obtaining unit (not shown), configured to obtain the contact information of the first object;
a fourth obtaining unit (not shown), configured to obtain a geographic location of the contact indicated by the contact information; and
a thirteenth display unit (not shown), configured to display, in the electronic map based on the geographic location of the contact, a seventh virtual object corresponding to the contact.

The first display unit 7510 is further configured to display, at the geographic location of the first object, the entry reservation control of the target virtual scene in the first state in response to the current time falling within the first cycle.

In one embodiment, the second display unit 7520 is specifically configured to:
display, in response to the entry control being triggered by the first object if the second cycle does not end, a preparation scene before the target virtual scene is entered, the preparation scene displaying at least one of remaining duration of the second cycle and a queuing progress bar, and the queuing progress bar indicating a ratio of elapsed duration in the second cycle; or
display the target virtual scene if the second cycle ends.

In one embodiment, the first establishment unit 7550 is specifically configured to:
display an exit control in the target virtual scene;
enable the first virtual object to exit the target virtual scene in response to the exit control being triggered;
display a second virtual object list, the second virtual object list including second virtual objects corresponding to first session start controls that have been triggered by the first virtual object, and display, in the second virtual object list, association-relationship establishment controls respectively corresponding to the second virtual objects; and
establish, in response to the association-relationship establishment controls being triggered, the association relationships between the first object and second objects corresponding to the second virtual objects corresponding to the association-relationship establishment controls.

In one embodiment, the session processing apparatus 7500 further includes:
a fourteenth display unit (not shown), configured to display a roaming control in the target virtual scene; and
an exit unit (not shown), configured to enable, in response to the roaming control being triggered, a terminal interface of the first object to exit displaying the target virtual scene, and change the first virtual object on a terminal interface of the second object to be in a sleep state.

In one embodiment, the session processing apparatus 7500 further includes:
a fifteenth display unit (not shown), configured to display a session invitation prompt on the terminal interface of the first object in response to session invitation information of the second virtual object, the session invitation prompt including a session joining control; and
a returning unit (not shown), configured to return to display the target virtual scene in response to the session joining control being triggered, and display a third session region, the third session region being configured for supporting the session performed between the second virtual object and the first virtual object.

In one embodiment, the session processing apparatus 7500 further includes:
a sixteenth display unit (not shown), configured to display, in response to a second condition, a picture body corresponding to the second condition; and
a seventeenth display unit (not shown), configured to display a first comment of a fifth virtual object on the picture body, the fifth virtual object having viewed the picture body under the second condition before, and made the first comment for the picture body.

In one embodiment, rendering code respectively corresponding to the entry control, the first session start control, and the first session region is generated by using a terminal local code tool of the first object, and rendering code of the target virtual scene is generated by using an online code tool.

The first display unit 7510 is specifically configured to invoke the rendering code of the entry control by using the terminal local code tool of the first object, to render the entry control.

The second display unit 7520 is specifically configured to invoke the rendering code of the target virtual scene by using the online code tool, to render the target virtual scene.

The third display unit 7530 is specifically configured to invoke the rendering code of the first session start control by using the terminal local code tool of the first object, to render the first session start control.

The fourth display unit 7540 is specifically configured to invoke the rendering code of the first session region by using the terminal local code tool of the first object, to render the first session region.

In one embodiment, the first display unit 7510 is specifically configured to request a status of the target virtual scene from a messaging application server by using non real-time communication; and display the entry control based on the status.

The second display unit 7520 is specifically configured to request, in response to the entry control being triggered by the first object, scenery information of the target virtual scene from the messaging application server by using the non-real-time communication;
request object information of the second object in the target virtual scene from the messaging application server by using the non-real-time communication;
request seating information of the second object in the target virtual scene from the messaging application server by using the non-real-time communication; and
render the target virtual scene by using the scenery information, the object information, and the seating information.

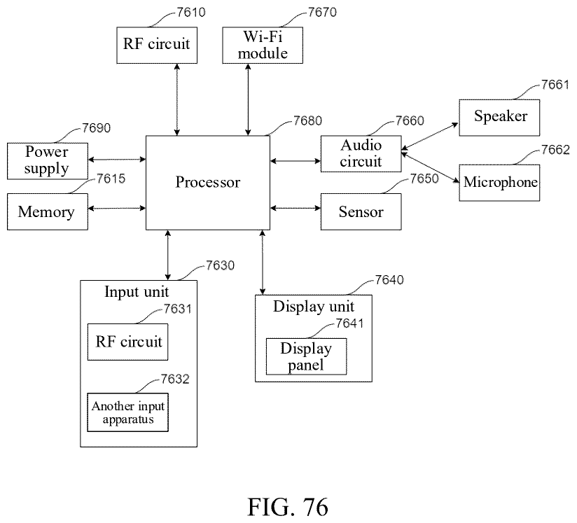

FIG. 76 is a block diagram of a structure of a part of a terminal implementing the session processing method of the embodiments of this application. The terminal includes components such as a radio frequency (RF for short) circuit 7610, a memory 7615, an input unit 7630, a display unit 7640, a sensor 7650, an audio circuit 7660, a wireless fidelity (Wi-Fi for short) module 7670, a processor 7680, and a power supply 7690. A person skilled in the art may understand that the structure of the terminal shown in FIG. 76 does not constitute a limitation to a mobile phone or a computer, and the mobile phone or computer may include more components or fewer components than those shown in the figure, or some components may be combined, or a different component deployment may be used.

The RF circuit 7610 may be configured to receive and send signals during an information receiving and sending process or a call process. Specifically, the RF circuit 7610 receives downlink information from a base station, then delivers the downlink information to the processor 7680 for processing, and sends designed uplink data to the base station.

The memory 7615 may be configured to store a software program and module. The processor 7680 runs the software program and module stored in the memory 7615, to implement various functional applications and data processing of the content terminal.

The input unit 7630 may be configured to receive input digit or character information, and generate key signal input related to the setting and function control of the content terminal. Specifically, the input unit 7630 may include a touch panel 7631 and another input apparatus 7632.

The display unit 7640 may be configured to display inputted information or provided information, and various menus of the content terminal. The display unit 7640 may include a display panel 7641.

The audio circuit 7660, a speaker 7661, and a microphone 7662 may provide audio interfaces.

In this embodiment, the processor 7680 included in the terminal can perform the session processing method in the foregoing embodiments.

The terminal in this embodiment of this application includes, but is not limited to, a mobile phone, a computer, an intelligent speech interaction device, an intelligent home appliance, a vehicle-mounted terminal, an aircraft, and the like. The embodiments of the present disclosure may be applied to various scenarios, including, but not limited to, an instant session, expansion of an object graph, or the like.

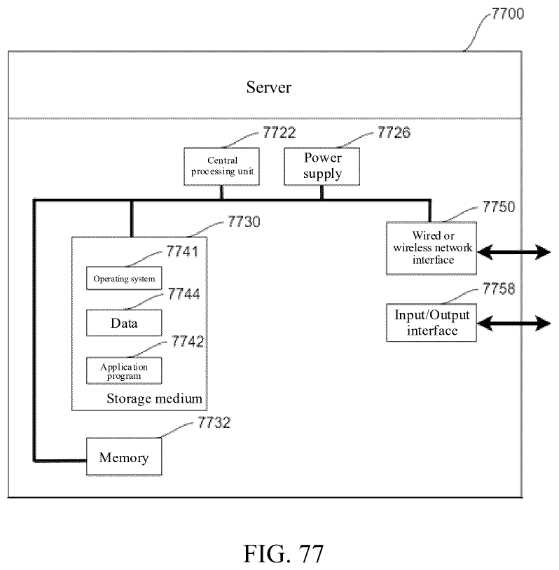

FIG. 77 is a block diagram of a structure of a part of a server implementing the session processing method of the embodiments of this application. The server may differ greatly due to different configurations or performance, and may include one or more central processing units (CPUs for short) 7722 (for example, one or more processors) and memories 7732, and one or more storage media 7730 (for example, one or more mass storage apparatuses) storing an application program 7742 or data 7744. The memories 7732 and the storage media 7730 may perform transient or persistent storage. A program stored in the storage media 7730 may include one or more modules (not shown in the figure), and each of the modules may include a series of instruction operations on the server. Further, the central processing units 7722 may be configured to communicate with the storage media 7730, and execute, on the server, the series of instruction operations in the storage media 7730.

The server may further include one or more power supplies 7726, one or more wired or wireless network interfaces 7750, one or more input/output interfaces 7758, and one or more operating systems 7741, such as Windows Server™, Mac OS X™, Unix™, Linux™ or FreeBSD™.

The central processing units 7722 in the server may be configured to perform the session processing method of the embodiments of this application.

An embodiment of this application further provides a computer-readable storage medium. The computer-readable storage medium is configured to store program code, and the program code is configured for performing the session processing method of the foregoing embodiments.

An embodiment of this application further provides a computer program product. The computer program product includes a computer program. A processor of a computer device reads and executes the computer program, to enable the computer device to perform the session processing method.

The terms “first”, “second”, “third”, “fourth”, and the like (if exists) in the specification of this application and the foregoing accompanying drawings are configured for distinguishing similar content, and do not need to be configured for describing a particular sequence or order. Data used accordingly is interchangeable in a suitable case, so that the embodiments of this application described herein can be implemented in a sequence in addition to the sequence shown or described herein. Moreover, the terms “include”, “have”, and any variants thereof are intended to cover a non-exclusive inclusion. For example, a process, method, system, product, or apparatus that includes a series of steps or elements not only includes such steps or elements that are clearly listed, but also includes other steps or elements that are not clearly listed or that are inherent to the process, method, product, or device.

In this application, “at least one (item)” means one or more, and “a plurality of” means two or more. “And/or” is configured for describing an association relationship between associated content, and indicates that three relationships may exist. For example, “A and/or B” may indicate the following three cases: only A exists, only B exists, and both A and B exist. A and B may be singular or plural. The character “/” usually indicates an “or” relationship between the associated content. “At least one of the following items” or a similar expression means any combination of these items, including a single item or any combination of a plurality of items. For example, at least one item of a, b, or c may indicate a, b, c, “a and b”, “a and c”, “b and c”, or “a, b, and c”, where a, b, and c may be singular or plural.

In the descriptions of the embodiments of this application, a plurality of (or multiple) means two or more. Greater than, less than, exceed, and the like are understood as excluding this number, and above, below, within, and the like are understood as including this number.

In the several embodiments provided in this application, the disclosed system, apparatus, and method may be implemented in other manners. For example, the described apparatus embodiment is merely an example. For example, division into the units is merely logical function division and may be other division in specific implementations. For example, a plurality of units or components may be combined or integrated into another system, or some features may be ignored or not performed. In addition, the displayed or discussed mutual coupling or direct coupling or communication connection may be indirect coupling or a communication connection through some interfaces, apparatuses, or units, and may be in an electronic form, a mechanical form, or another form.

The units described as separate parts may or may not be physically separate, and parts displayed as units may or may not be physical units, may be located in one position, or may be distributed on a plurality of network units. Some or all of the units may be selected based on an actual requirement to achieve the objectives of the solutions of the embodiments.

In addition, the functional units in the embodiments of this application may be integrated into one processing unit, or each of the units may independently exist physically, or two or more units may be integrated into one unit. The integrated unit may be implemented in the form of hardware or in the form of a software functional unit.

When the integrated unit is implemented in the form of a software functional unit and sold or used as an independent product, the integrated unit may be stored in a computer-readable storage medium. Based on this understanding, the technical solutions of this application essentially, a part contributing to the related art, or all or a part of the technical solutions may be implemented in the form of a software product. The computer software product is stored in a storage medium, and includes several instructions to enable a computer apparatus (which may be a personal computer, a server, a network apparatus, or the like) to perform all or a part of the operations of the methods in the embodiments of this application. The foregoing storage medium includes various media capable of storing program code, such as a USB flash drive, a mobile hard disk, a read-only memory (ROM for short), a random access memory (RAM for short), a magnetic disk, or an optical disc.

The implementations provided in the embodiments of this application may be randomly combined to achieve different technical effects.

The foregoing describes the implementations of this application in detail, but this application is not limited to the foregoing implementations. A person skilled in the art may make various equivalent variations or replacements without departing from the spirit of this application. All such equivalent variations or replacements fall within the scope limited by the claims of this application.

What is claimed is:

1. A session processing method, the method being performed by an electronic device, and comprising:
displaying an entry control of a target virtual scene;
displaying the target virtual scene in response to the entry control being triggered by a first object, the target virtual scene comprising a first virtual object representing the first object and a second virtual object representing a second object, and the second object being not associated with the first object;
displaying a first session start control for the second virtual object;
displaying a first session region in response to the first session start control being triggered, the first session region being configured for supporting a session hold by the first virtual object and the second virtual object; and
establishing an association relationship between the first object and the second object.

2. The session processing method according to claim 1, wherein the target virtual scene further comprises a third virtual object representing an artificial intelligence body object; and
after the displaying the target virtual scene in response to the entry control being triggered by a first object, the session processing method further comprises:
displaying a second session start control for the third virtual object; and
displaying a second session region in response to the second session start control being triggered, the second session region being configured for supporting a session conducted by the first virtual object and the artificial intelligence body object.

3. The session processing method according to claim 1, wherein after the displaying the target virtual scene in response to the entry control being triggered by a first object, the session processing method further comprises:
displaying a message information body from a fourth virtual object in response to a first condition, the fourth virtual object being a virtual object that has entered the target virtual scene, and the message information body comprising a reply region;
storing, into the message information body in response to a reply operation triggered in the reply region, reply content corresponding to the reply operation; and
establishing the association relationship between the first object and an object corresponding to the fourth virtual object.

4. The session processing method according to claim 3, wherein the displaying a message information body from a fourth virtual object in response to a first condition comprises:
displaying the message information body of the fourth virtual object if no triggering of a first session start control for any second virtual object is received within a preset time period after the first virtual object enters the target virtual scene.

5. The session processing method according to claim 3, wherein the displaying a message information body from a fourth virtual object comprises:
obtaining second labels of fourth virtual objects respectively corresponding to message information bodies;
obtaining first labels of the first virtual object;
obtaining message time of the message information bodies;
selecting a second quantity of message information bodies from the message information bodies based on the message time and matching degrees between the first labels and the second labels; and
displaying the second quantity of message information bodies.

6. The session processing method according to claim 1, wherein the displaying an entry control of a target virtual scene comprises:
displaying an entry reservation control of the target virtual scene in a first state in response to current time falling within a first cycle, the first cycle being a cycle in which the target virtual scene is not allowed to be entered;
displaying the entry reservation control in a second state in response to the entry reservation control being triggered, the second state being different from the first state; and
displaying the entry control in response to the current time passing to a second cycle, the second cycle being a cycle in which the target virtual scene is allowed to be entered, and the first cycle and the second cycle being alternately arranged.

7. The session processing method according to claim 6, wherein the target virtual scene comprises a plurality of duplicated scenes of the target virtual scene; and the session processing method further comprises:
obtaining first triggering time at which objects trigger the entry reservation control within the first cycle, the objects comprising the first object and the second object;
performing, based on the first triggering time, first sorting on the objects triggering the entry reservation control within the first cycle; and
allocating the objects to the duplicated scenes based on the first sorting.

8. The session processing method according to claim 6, wherein before the displaying an entry reservation control of the target virtual scene in a first state in response to current time falling within a first cycle, the session processing method further comprises:
displaying a waiting-scene entry control;
displaying a waiting virtual scene in response to the waiting-scene entry control being triggered by the first object, the waiting virtual scene being a scene for waiting to enter the target virtual scene;
obtaining contact information of the first object; and
using, as a sixth virtual object, a contact currently using a messaging application in contacts indicated by the contact information, and displaying the sixth virtual object in the waiting virtual scene, the session processing method being applied to the messaging application.

9. The session processing method according to claim 6, wherein before the displaying an entry reservation control of the target virtual scene in a first state in response to current time falling within a first cycle, the session processing method further comprises:
displaying a map entry control;
displaying an electronic map in response to the map entry control being triggered by the first object;
obtaining a geographic location of the first object in response to a virtual scene locating control being triggered in the electronic map, and enabling the electronic map to include the geographic location of the first object;
obtaining the contact information of the first object;
obtaining a geographic location of the contact indicated by the contact information; and
displaying a seventh virtual object corresponding to the contact in the electronic map based on the geographic location of the contact; and
the displaying an entry reservation control of the target virtual scene in a first state in response to current time falling within a first cycle comprises:
displaying the entry reservation control of the target virtual scene in the first state at the geographic location of the first object in response to the current time falling within the first cycle.

10. The session processing method according to claim 6, wherein the displaying the target virtual scene in response to the entry control being triggered by a first object comprises:
displaying, in response to the entry control being triggered by the first object if the second cycle does not end, a preparation scene before the target virtual scene is entered, the preparation scene displaying at least one of remaining duration of the second cycle and a queuing progress bar, and the queuing progress bar indicating a ratio of elapsed duration in the second cycle; or
displaying the target virtual scene if the second cycle ends.

11. The session processing method according to claim 1, wherein the establishing the association relationship between the first object and the second object comprises:
displaying an exit control in the target virtual scene;
enabling the first virtual object to exit the target virtual scene in response to the exit control being triggered;
displaying a second virtual object list, the second virtual object list comprising second virtual objects corresponding to first session start controls that have been triggered by the first virtual object, and displaying, in the second virtual object list, association-relationship establishment controls respectively corresponding to the second virtual objects; and
establishing, in response to the association-relationship establishment controls being triggered, the association relationships between the first object and second objects corresponding to the second virtual objects corresponding to the association-relationship establishment controls.

12. The session processing method according to claim 1, wherein after the displaying the target virtual scene in response to the entry control being triggered by a first object, the session processing method further comprises:
displaying a roaming control in the target virtual scene; and
enabling, in response to the roaming control being triggered, a terminal interface of the first object to exit displaying the target virtual scene, and changing the first virtual object on a terminal interface of the second object to be in a sleep state.

13. The session processing method according to claim 12, wherein after the enabling, in response to the roaming control being triggered, a terminal interface of the first object to exit displaying the target virtual scene, and changing the first virtual object on a terminal interface of the second object to be in a sleep state, the session processing method further comprises:
displaying a session invitation prompt on the terminal interface of the first object in response to session invitation information of the second virtual object, the session invitation prompt comprising a session joining control; and
returning to display the target virtual scene in response to the session joining control being triggered, and displaying a third session region, the third session region being configured for supporting the session performed between the second virtual object and the first virtual object.

14. The session processing method according to claim 1, wherein after the displaying the target virtual scene in response to the entry control being triggered by a first object, the session processing method further comprises:
displaying, in response to a second condition, a picture body corresponding to the second condition; and
displaying a first comment of a fifth virtual object on the picture body, the fifth virtual object having viewed the picture body under the second condition before, and made the first comment for the picture body.

15. The session processing method according claim 1, wherein rendering code respectively corresponding to the entry control, the first session start control, and the first session region is generated by using a terminal local code tool of the first object, and rendering code of the target virtual scene is generated by using an online code tool;
the displaying an entry control of a target virtual scene comprises:
invoking the rendering code of the entry control by using the terminal local code tool of the first object, to render the entry control;
the displaying the target virtual scene comprises:
invoking the rendering code of the target virtual scene by using the online code tool, to render the target virtual scene;
the displaying a first session start control for the second virtual object comprises:
invoking the rendering code of the first session start control by using the terminal local code tool of the first object, to render the first session start control; and
the displaying a first session region comprises:
invoking the rendering code of the first session region by using the terminal local code tool of the first object, to render the first session region.

16. The session processing method according claim 1, wherein the displaying an entry control of a target virtual scene comprises:
requesting a status of the target virtual scene from a messaging application server by using non real-time communication; and displaying the entry control based on the status; and
the displaying the target virtual scene in response to the entry control being triggered by a first object comprises:
requesting, in response to the entry control being triggered by the first object, scenery information of the target virtual scene from the messaging application server by using the non-real-time communication;
requesting object information of the second object in the target virtual scene from the messaging application server by using the non-real-time communication;
requesting seating information of the second object in the target virtual scene from the messaging application server by using the non-real-time communication; and
rendering the target virtual scene by using the scenery information, the object information, and the seating information.

17. An electronic device, comprising a memory and a processor, the memory having a computer program stored therein, and the processor, when executing the computer program, implementing a session processing method, comprising:
displaying an entry control of a target virtual scene;
displaying the target virtual scene in response to the entry control being triggered by a first object, the target virtual scene comprising a first virtual object representing the first object and a second virtual object representing a second object, and the second object being not associated with the first object;
displaying a first session start control for the second virtual object;
displaying a first session region in response to the first session start control being triggered, the first session region being configured for supporting a session hold by the first virtual object and the second virtual object; and
establishing an association relationship between the first object and the second object.

18. The electronic device according to claim 17, wherein the target virtual scene further comprises a third virtual object representing an artificial intelligence body object; and
after the displaying the target virtual scene in response to the entry control being triggered by a first object, the session processing method further comprises:
displaying a second session start control for the third virtual object; and
displaying a second session region in response to the second session start control being triggered, the second session region being configured for supporting a session conducted by the first virtual object and the artificial intelligence body object.

19. The electronic device according to claim 17, wherein after the displaying the target virtual scene in response to the entry control being triggered by a first object, the session processing method further comprises:
displaying a message information body from a fourth virtual object in response to a first condition, the fourth virtual object being a virtual object that has entered the target virtual scene, and the message information body comprising a reply region;
storing, into the message information body in response to a reply operation triggered in the reply region, reply content corresponding to the reply operation; and
establishing the association relationship between the first object and an object corresponding to the fourth virtual object.

20. A non-transitory computer-readable storage medium, the storage medium having a computer program stored therein, and the computer program, when being executed by a processor, implementing a session processing method, comprising:
displaying an entry control of a target virtual scene;
displaying the target virtual scene in response to the entry control being triggered by a first object, the target virtual scene comprising a first virtual object representing the first object and a second virtual object representing a second object, and the second object being not associated with the first object;
displaying a first session start control for the second virtual object;
displaying a first session region in response to the first session start control being triggered, the first session region being configured for supporting a session hold by the first virtual object and the second virtual object; and
establishing an association relationship between the first object and the second object.
